(19) United States
(12) Patent Application Publication
(10) Pub. No.: US 2026/0110411 A1
(43) Pub. Date: Apr. 23, 2026

(54) MODULAR LINEAR LIGHTING SYSTEM AND METHODS FOR ASSEMBLING SAME

(71) Applicant: DMF, Inc., Carson, CA (US)

(72) Inventors: Mason Barker, Alhambra, CA (US); Yaote Huang, Arcardia, CA (US); Amir Lotfi, Redondo Beach, CA (US); Graeme Watt, Altrincham (GB); Ken Czech, Redondo Beach, CA (US); Alejandro Mier-Langner, Providence, RI (US); James Love Hamilton, IV, Simi Valley, CA (US)

(21) Appl. No.: 19/362,315

(22) Filed: Oct. 17, 2025

Related U.S. Application Data
(60) Provisional application No. 63/708,741, filed on Oct. 17, 2024.
(60) Provisional application No. 63/747,077, filed on Jan. 19, 2025.

(51) Int. Cl. F21S 4/28; F21S 2/00; F21S 8/00; F21V 7/00; F21V 19/00; F21V 23/06; F21Y 115/10; H05B 45/10; H05B 45/20; H05B 45/325

(52) U.S. Cl. CPC F21S 4/28; F21S 2/005; F21S 8/038; F21V 7/0066; F21V 19/004; F21V 23/06; H05B 45/10; H05B 45/20; H05B 45/325; F21Y 2115/10

(57) ABSTRACT

A modular linear lighting system includes a mounting track securely coupled to an installation surface of a ceiling or a wall, a run of one or more light bars of various lengths to emit light, an input connector to receive electrical power and, in some instances, control signals to adjust the light output, one or more middle connectors to electrically couple a pair of light bars in a daisy-chain configuration, and an end connector to mechanically couple the last light bar in the run to the mounting track. The light bars and the connectors may be mechanically and electrically coupled to each other in a tool-free manner. In some implementations, the input connector may include an integrated LED controller to provide additional customization of the light output, such as adjusting the color (e.g., the correlated color temperature) of the light output.

### CROSS-REFERENCE TO RELATED APPLICATION(S)

This application claims the priority benefit, under 35 U.S.C. 119(e), of U.S. Application No. 63/708,741, filed Oct. 17, 2024 and entitled, “MODULAR LINEAR LIGHTING SYSTEM AND METHODS FOR ASSEMBLING SAME,” and U.S. Application No. 63/747,077, filed Jan. 19, 2025 and entitled, “MODULAR LINEAR LIGHTING SYSTEM AND METHODS FOR ASSEMBLING SAME.” Each of the aforementioned applications is incorporated herein by reference in its entirety.

### BACKGROUND

A linear lighting system (also referred to as a “linear lighting fixture” or “linear lighting”) is a type of lighting fixture that typically has an elongated geometry (e.g., a rectangle) and provides continuous illumination along a substantial portion of its length. Conventional linear lighting systems traditionally include fluorescent tubes to provide light and are often used to illuminate large spaces, such as an office, a store, or a warehouse. More recently, LED-based linear lighting systems have supplanted fluorescent-based linear lighting systems. Compared to their fluorescent counterparts, LED-based linear lighting systems are typically more compact in size and shape, which has led to its use in more lighting applications including, for example, accent lighting applications. Moreover, LED-based linear lighting systems are generally more energy efficient, provide a longer lifespan, and offer more flexibility over the spectral content of the emitted light (e.g., the correlated color temperature of the light).

### SUMMARY

The Inventors have recognized and appreciated contemporary linear lighting systems are typically constructed using light emitting diode (LED) tape. Compared to rigid linear lighting systems, linear lighting systems with LED tape are generally more cost effective, more compact, and provide greater flexibility during on-site installation (e.g., LED tape may be cut to a desired length). As a result, linear lighting systems with LED tape are used in a wide range of applications, such as flexible tape lighting, cove lighting, under cabinet lighting, toe-kick lighting, and other direct view linear fixtures. The Inventors have recognized, however, these benefits come at a cost.

First, the installation of LED tape is a difficult, complex, and labor-intensive process. For example, highly trained personnel are often required to perform the time-consuming process of cutting LED tape and soldering different strips of LED tape together. In particular, soldering LED tape requires the installer to be especially precise given the relatively small electrical contacts on conventional LED tape. Additionally, the mounting surface supporting the LED tape should be cleaned and an LED strip precisely attached thereto, which is a time-consuming process. The weight of the wire lead can peel and/or strip off from the mounting surface if strain relief is not provided. Also, the LED tape is often handled directly and pressed down forcefully to properly install strips.

Compared to lighting systems with LED tape, factory-built linear lighting systems often provide greater ease of installation. However, pre-built linear lighting systems generally offer less on-site flexibility, have longer lead times, and are more expensive than linear lighting systems that include LED tape. Some conventional linear lighting systems include field connectors to facilitate assembly using relatively smaller, discrete lighting modules. The field connectors provide, in part, a way to share electrical power between the lighting modules. In this manner, linear lighting systems of various lengths may be assembled. However, conventional field connectors are often unreliable and prone to failure.

Second, LED tape is generally used with Class 2 LED drivers as defined by the National Electric Code (NEC). Although the Class 2 nature of LED tape provides greater flexibility (e.g., allows on-site modification of LED tape), this also results in linear lighting systems having a relatively large number of drivers that are challenging to place in the environment and/or linear lighting systems with relatively short run lengths.

Third, conventional linear lighting systems seldom provide lighting that can readily match in color with other lighting fixtures in the environment, such as recessed downlights. As an illustrative example, linear LED lighting systems are often used in combination with recessed LED lighting systems to provide a space with warm-dim lighting. Warm-dim LED lighting is often desired because it mimics lighting from an incandescent light bulb to create a comforting lighting environment. This is typically accomplished by the LED lighting having a correlated color temperature (CCT) that increases (i.e., the lighting becomes warmer) as the LED lighting is dimmed, i.e., the brightness is reduced. In these environments, it is desirable for the linear LED lighting systems and the recessed LED lighting systems to provide matching CCTs as both lighting systems are dimmed.

However, traditional voltage controlled warm-dim LED control schemes typically rely on the forward voltage of the LEDs and the series resistors to control dimming and color according to a warm-dim curve. The warm-dim curve describes the change in CCT as a function of intensity. Under this approach, conventional linear LED lighting systems are generally unable to provide a warm-dim curve that matches the warm-dim curve of a recessed LED lighting system. Additionally, this approach often sacrifices efficacy (i.e., lumen output per watt of applied power) to obtain the dimming curve.

Additionally, drivers configured to implement a warm-dim curve via tunable white LED strips typically require three wires. However, this results in additional wiring complexity and often requires a more complicated LED driver. Furthermore, the addition of drivers and/or other control equipment near the LED strips of a linear lighting system is often problematic since space to conceal these additional devices is generally limited.

Fourth, LED tape generally includes many small parts and pieces, which can make it confusing and time consuming to specify, quote, and order for a particular installation. In many instances, the manufacturer of the LED tape is required to do a take-off and engineer each order, i.e., by determining the quantity of each component in the order needed to complete a particular installation.

In view of the foregoing limitations of conventional linear lighting systems with LED tape, the present disclosure is directed to various inventive implementations of a modular linear lighting system that may be assembled on site without any tools to provide a substantially continuous light source. This may be accomplished, in part, by the lighting system including one or more light bars of varying length (e.g., 1 inch, 2 inches, 12 inches, and so on) electrically coupled together via one or more connectors (e.g., an input connector, a middle connector (also referred to as a “mid connector”), an end connector), which provide and transmit electrical power and/or control signals to the light bars. The linear lighting systems disclosed herein may provide on-site flexibility during installation to customize the length of the lighting system (e.g., by using different combinations of light bars), reliable electrical connections similar to soldered connections used with LED tape, and greater ease of assembly through use of modular connectors that provide mechanical and electrical connections to the light bars. In some implementations, the assembly of the light bars may provide a dot-free and seamless line of light.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A shows a bottom, front, right-side perspective view of an example modular linear lighting system according to some inventive implementations disclosed herein.

FIG. 1B shows a bottom, front, left-side perspective view of the linear lighting system of FIG. 1A.

FIG. 1C shows a top, front, left-side perspective view of the linear lighting system of FIG. 1A.

FIG. 1D shows a bottom view of the linear lighting system of FIG. 1A.

FIG. 1E shows a top view of the linear lighting system of FIG. 1A.

FIG. 1F shows a rear view of the linear lighting system of FIG. 1A.

FIG. 1G shows a right-side view of the linear lighting system of FIG. 1A.

FIG. 1H shows a left-side view of the linear lighting system of FIG. 1A.

FIG. 1I shows a cross-sectional view of the linear lighting system of FIG. 1A corresponding to the plane A-A of FIG. 1D.

FIG. 1J shows a cross-sectional view of a portion of the linear lighting system of FIG. 1A corresponding to the plane B-B of FIG. 1H. The portion shown includes multiple light bars of varying length (see, also, FIG. 1F).

FIG. 1K shows a cross-sectional view of another portion of the linear lighting system of FIG. 1A corresponding to the plane B-B of FIG. 1H. The portion shown includes two light bars coupled to a middle connector (see, also, FIG. 1F).

FIG. 1L shows a cross-sectional view of yet another portion of the linear lighting system of FIG. 1A corresponding to the plane B-B of FIG. 1H. The portion shown includes a bracket for a light bar (see, also, FIG. 1F).

FIG. 1M shows a cross-sectional view of another portion of the linear lighting system of FIG. 1A corresponding to the plane B-B of FIG. 1H. The portion shown includes a light bar connected to an input connector (see, also, FIG. 1F).

FIG. 1N shows an exploded rear view of the linear lighting system of FIG. 1A.

FIG. 1O shows a magnified rear view of a portion of the linear lighting system of FIG. 1N. The portion shown includes multiple light bars of varying length (see, also, FIG. 1N).

FIG. 1P shows a magnified rear view of another portion of the linear lighting system of FIG. 1N. The portion shown includes a light bar and an input connector (see, also, FIG. 1N).

FIG. 1Q shows a magnified bottom, rear, left-side view of a portion of the linear lighting system of FIG. 1N. The portion shown includes multiple light bars of varying length.

FIG. 1R shows a magnified top, rear, left-side view of the linear lighting system of FIG. 1Q.

FIG. 1S shows a magnified bottom, rear, left-side view of another portion of the linear lighting system of FIG. 1N. The portion shown includes two light bars coupled to a middle connector.

FIG. 1T shows a magnified top, rear, left-side view of the linear lighting system of FIG. 1S.

FIG. 1U shows a magnified bottom, rear, left-side view of another portion of the linear lighting system of FIG. 1N. The portion shown includes an input connector.

FIG. 1V shows a magnified top, rear, left-side view of the linear lighting system of FIG. 1U.

FIG. 1W shows a magnified top, rear, left-side view of another portion of the linear lighting system of FIG. 1N.

FIG. 2A shows a bottom, front, right-side perspective view of a subassembly for another example modular linear lighting system according to some inventive implementations disclosed herein.

FIG. 2B shows a bottom, front, left-side perspective view of the subassembly of FIG. 2A.

FIG. 2C shows a top, rear, left-side perspective view of the subassembly of FIG. 2A.

FIG. 2D shows a top, rear, right-side perspective view of the subassembly of FIG. 2A.

FIG. 2E shows a bottom view of the subassembly of FIG. 2A.

FIG. 2F shows a top view of the subassembly of FIG. 2A.

FIG. 2G shows a front view of the subassembly of FIG. 2A.

FIG. 2H shows a right-side view of the subassembly of FIG. 2A.

FIG. 2I shows a left-side view of the subassembly of FIG. 2A.

FIG. 2J shows an exploded top, rear, left-side view of the subassembly of FIG. 2A.

FIG. 2K shows an exploded bottom, rear, right-side view of the subassembly of FIG. 2A.

FIG. 2L shows a cross-sectional view of a portion of the subassembly of FIG. 2A corresponding to the plane A-A of FIG. 2I. The portion shown includes an input connector (see, also, FIG. 2G).

FIG. 2M shows a cross-sectional view of another portion of the subassembly of FIG. 2A corresponding to the plane A-A of FIG. 2I. The portion shown includes a middle connector (see, also, FIG. 2G).

FIG. 3A shows a bottom view of an example light bar in the linear lighting system of FIG. 1A.

FIG. 3B shows a top view of the light bar of FIG. 3A.

FIG. 3C shows a front view of the light bar of FIG. 3A.

FIG. 3D shows a right-side view of the light bar of FIG. 3A.

FIG. 3E shows an exploded bottom, front, right-side perspective view of the light bar of FIG. 3A.

FIG. 3F shows an exploded top, rear, right-side perspective view of the light bar of FIG. 3A.

FIG. 3G shows a magnified bottom, front, left-side perspective view of an end section in the light bar of FIG. 3A.

FIG. 3H shows a magnified top, rear, right-side perspective view of the end section of FIG. 3G.

FIG. 3I shows a magnified bottom, front, right-side perspective view of a housing in the light bar of FIG. 3A.

FIG. 3J shows a magnified bottom, front, right-side perspective view of a bracket in the light bar of FIG. 3A.

FIG. 4A shows a bottom, rear, right-side perspective view of another example light bar in the linear lighting system of FIG. 1A.

FIG. 4B shows a bottom, front, left-side perspective view of the light bar of FIG. 4A.

FIG. 4C shows a top, front, right-side perspective view of the light bar of FIG. 4A.

FIG. 4D shows a top, rear, right-side perspective view of the light bar of FIG. 4A.

FIG. 4E shows a top view of the light bar of FIG. 4A.

FIG. 4F shows a bottom view of the light bar of FIG. 4A.

FIG. 4G shows a rear view of the light bar of FIG. 4A.

FIG. 4H shows a right-side view of the light bar of FIG. 4A.

FIG. 4I shows a left-side view of the light bar of FIG. 4A.

FIG. 4J shows an exploded bottom, front, right-side perspective view of the light bar of FIG. 4A.

FIG. 4K shows an exploded top, front, right-side perspective view of the light bar of FIG. 4A.

FIG. 5A shows a bottom, front, right-side perspective view of another example light bar in the linear lighting system of FIG. 1A.

FIG. 5B shows a top, rear, left-side perspective view of the light bar of FIG. 5A.

FIG. 5C shows a bottom view of the light bar of FIG. 5A.

FIG. 5D shows a top view of the light bar of FIG. 5A.

FIG. 5E shows a front view of the light bar of FIG. 5A.

FIG. 5F shows a right-side view of the light bar of FIG. 5A.

FIG. 5G shows an exploded bottom, front, left-side perspective view of the light bar of FIG. 5A.

FIG. 5H shows an exploded top, rear, right-side perspective view of the light bar of FIG. 5A.

FIG. 6A shows a bottom, front, left-side perspective view of an example input connector in the linear lighting system of FIG. 1A.

FIG. 6B shows a bottom, front, right-side perspective view of the input connector of FIG. 6A.

FIG. 6C shows a top, front, right-side perspective view of the input connector of FIG. 6A.

FIG. 6D shows a bottom view of the input connector of FIG. 6A.

FIG. 6E shows a top view of the input connector of FIG. 6A.

FIG. 6F shows a front view of the input connector of FIG. 6A.

FIG. 6G shows a rear view of the input connector of FIG. 6A.

FIG. 6H shows a left-side view of the input connector of FIG. 6A.

FIG. 6I shows a right-side view of the input connector of FIG. 6A.

FIG. 6J shows an exploded bottom, front, left-side perspective view of the input connector of FIG. 6A.

FIG. 7A shows a bottom, front, left-side perspective view of another example input connector in the linear lighting system of FIG. 2A. The input connector includes an integrated driver/controller.

FIG. 7B shows a bottom, front, right-side perspective view of the input connector of FIG. 7A.

FIG. 7C shows a top, front, right-side perspective view of the input connector of FIG. 7A.

FIG. 7D shows a bottom view of the input connector of FIG. 7A.

FIG. 7E shows a top view of the input connector of FIG. 7A.

FIG. 7F shows a front view of the input connector of FIG. 7A.

FIG. 7G shows a rear view of the input connector of FIG. 7A.

FIG. 7H shows a right-side view of the input connector of FIG. 7A.

FIG. 7I shows a left-side view of the input connector of FIG. 7A.

FIG. 7J shows an exploded bottom, front, left-side perspective view of the input connector of FIG. 7A.

FIG. 8A shows a bottom, front, left-side perspective view of an example middle connector in the linear lighting system of FIG. 1A.

FIG. 8B shows a bottom, rear, left-side perspective view of the middle connector of FIG. 8A.

FIG. 8C shows a top, rear, right-side perspective view of the middle connector of FIG. 8A.

FIG. 8D shows a bottom view of the middle connector of FIG. 8A.

FIG. 8E shows a top view of the middle connector of FIG. 8A.

FIG. 8F shows a front view of the middle connector of FIG. 8A.

FIG. 8G shows a rear view of the middle connector of FIG. 8A.

FIG. 8H shows a left-side view of the middle connector of FIG. 8A.

FIG. 8I shows a right-side view of the middle connector of FIG. 8A.

FIG. 8J shows an exploded bottom, front, right-side perspective view of the middle connector of FIG. 8A.

FIG. 9A shows a bottom, rear, right-side perspective view of an example end connector (also referred to herein as a “end cover”) in the linear lighting system of FIG. 1A.

FIG. 9B shows a top, front, left-side perspective view of the end connector of FIG. 9A.

FIG. 9C shows a bottom view of the end connector of FIG. 9A.

FIG. 9D shows a top view of the end connector of FIG. 9A.

FIG. 9E shows a rear view of the end connector of FIG. 9A.

FIG. 9F shows a front view of the end connector of FIG. 9A.

FIG. 9G shows a right-side view of the end connector of FIG. 9A.

FIG. 9H shows a left-side view of the end connector of FIG. 9A.

FIG. 9I shows an exploded bottom, rear, right-side perspective view of the end connector of FIG. 9A.

FIG. 10A shows a bottom, front, right-side perspective view of an example mounting track in the linear lighting system of FIG. 1A.

FIG. 10B shows a right-side view of the mounting track of FIG. 10A.

FIG. 11A shows a bottom, rear, right-side perspective view of another example mounting track.

FIG. 11B shows a right-side view of the mounting track of FIG. 11A.

FIG. 12A shows a bottom, front, left-side perspective view of another example mounting track.

FIG. 12B shows a top, rear, right-side perspective view of the mounting track of FIG. 12A.

FIG. 12C shows a right-side view of the mounting track of FIG. 12A.

FIG. 13A shows a bottom, rear, right-side perspective view of an example lighting system incorporating the mounting track of FIG. 12A.

FIG. 13B shows a bottom, front, left-side perspective view of the lighting system of FIG. 13A.

FIG. 13C shows a top, front, left-side perspective view of the lighting system of FIG. 13A.

FIG. 13D shows a left-side view of the lighting system of FIG. 13A.

FIG. 13E shows an exploded bottom, front, left-side perspective view of the input connector of FIG. 13A.

FIG. 14A shows a bottom, rear, right-side perspective view of another example mounting rack.

FIG. 14B shows a bottom view of the mounting rack of FIG. 14A.

FIG. 14C shows a top view of the mounting rack of FIG. 14A.

FIG. 14D shows an exploded bottom, rear, right-side perspective view of the mounting rack of FIG. 14A.

FIG. 15A shows a bottom, front, right-side perspective view of another example mounting rack.

FIG. 15B shows a bottom view of the mounting rack of FIG. 15A.

FIG. 15C shows a top view of the mounting rack of FIG. 15A.

FIG. 15D shows an exploded bottom, rear, left-side perspective view of the mounting rack of FIG. 15A.

FIG. 16A shows a bottom, front, right-side perspective view of an example alignment tool.

FIG. 16B shows a bottom, front, left-side perspective view of the alignment tool of FIG. 16A.

FIG. 16C shows a front view of the alignment tool of FIG. 16A.

FIG. 16D shows a left-side view of the alignment tool of FIG. 16A.

FIG. 17A shows an exploded bottom, rear, right-side perspective view of another example modular linear lighting system according to some inventive implementations disclosed herein.

FIG. 17B shows a bottom, rear, right-side perspective view of the linear lighting system of FIG. 17A.

FIG. 17C shows a bottom, rear, right-side perspective view of the linear lighting system of FIG. 17A where a portion of a light bar is removed to show a latch mechanism.

FIG. 18A shows an exploded bottom, rear, right-side perspective view of another example modular linear lighting system according to some inventive implementations disclosed herein.

FIG. 18B shows an exploded top, rear, right-side perspective view of the linear lighting system of FIG. 18A.

FIG. 18C shows an exploded bottom, right-side perspective view of the linear lighting system of FIG. 18A.

FIG. 18D shows a bottom, rear, right-side perspective view of an example input connector for the linear lighting system of FIG. 18A.

FIG. 18E shows examples of the light bar in the linear lighting system of FIG. 18A paired with different input connectors and wires oriented in different directions.

FIG. 19A shows an exploded bottom, rear, right-side perspective view of another example modular linear lighting system according to some inventive implementations disclosed herein.

FIG. 19B shows a right-side view of the linear lighting system of FIG. 19A.

FIG. 19C shows a bottom, rear, left-side perspective view of a pair of lighting systems assembled from the components in the lighting system of FIG. 19A where one lighting system is shown exploded.

FIG. 20A shows an example installation of a mounting track in the linear lighting system of FIG. 19A onto a installation surface.

FIG. 20B shows an example installation of another mounting track adjoining the mounting track of FIG. 20A.

FIG. 20C shows an example alignment tool to facilitate alignment of the mounting tracks of FIG. 20B.

FIG. 20D shows the removal of the alignment tool of FIG. 20C after installation of the mounting tracks is complete.

FIG. 20E shows an example installation of an input connector onto the mounting track of FIG. 20A.

FIG. 20F shows an example connection of wires to the input connector of FIG. 20E.

FIG. 20G shows an example installation of an input connector onto the mounting track of FIG. 20A where the wires originate from an opening in the installation surface adjacent to the mounting track.

FIG. 20H shows the input connector of FIG. 20G mounted to the mounting track and connected to the wires.

FIG. 20I shows an example installation of a middle connector with side feed power connectors onto the mounting track of FIG. 20A.

FIG. 20J shows an example connection of wires to the middle connector of FIG. 20I.

FIG. 20K shows an example installation of two input connectors where respective wires originate from an opening in the installation surface and pass through slots formed in the mounting tracks.

FIG. 20L shows the input connectors of FIG. 20K mounted to the mounting track.

FIG. 20M shows an example installation of a light bar with a middle connector to a mounting track.

FIG. 20N shows an example installation of additional light bars with middle connectors joined to the light bar and the middle connector of FIG. 20M.

FIG. 20O shows an example removal of a middle connector from a light bar at the end of the lighting system.

FIG. 20P shows an example installation of an end connector onto the light bar of FIG. 20O.

FIG. 20Q shows the end connector coupled to the light bar of the FIG. 20P.

FIG. 20R shows an example installation of the light bar of FIG. 20Q onto the light bars of FIG. 20N.

FIG. 20S shows the light bar of FIG. 20P mounted to the mounting track.

FIG. 20T shows an example of a completed linear lighting system.

FIG. 21A shows a block diagram of an example LED controller for the modular linear lighting systems disclosed herein.

FIG. 21B shows a circuit diagram of the LED controller of FIG. 21A.

FIG. 21C shows example waveforms for a single pulse width modulation (PWM) input and two constant voltage PWM outputs obtained from the single PWM input.

FIG. 22A shows an example installation kit for a modular linear lighting system.

FIG. 22B shows another example installation kit for a modular linear lighting system.

FIG. 22C shows another example installation kit for a modular linear lighting system.

FIG. 23A shows an example graphical user interface (GUI) for ordering one or more components of a modular linear lighting system.

FIG. 23B shows an example GUI for ordering a modular linear lighting system according to a desired length.

FIG. 23C shows an example GUI for ordering a modular linear lighting system according to a desired zone of a built environment.

### DETAILED DESCRIPTION

Following below are more detailed descriptions of various concepts related to, and embodiments of, a modular linear lighting system and methods for ordering and/or assembling the linear lighting system using a kit. It should be appreciated that various concepts introduced above and discussed in greater detail below may be implemented in multiple ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of inventive modular linear lighting systems are provided, wherein a given example or set of examples showcases a light bar, an input connector, a middle connector, an end connector, a mounting track, and a LED controller (also referred to herein as a “controller”). It should be appreciated that one or more features discussed in connection with a given example of a linear lighting system may be employed in other respective examples of linear lighting systems according to the present disclosure, such that the various features disclosed herein may be readily combined in a given linear lighting system according to the present disclosure (provided that respective features are not mutually inconsistent).

Certain parameters and dimensions of the linear lighting system are described herein using the terms “approximately,” “about,” “substantially,” and/or “similar.” As used herein, the terms “approximately,” “about,” “substantially,” and/or “similar” indicates that each of the described dimensions or features is not a strict boundary or parameter and does not exclude functionally similar variations therefrom. Unless context or the description indicates otherwise, the use of the terms “approximately,” “about,” “substantially,” and/or “similar” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

### 1. Examples of Modular Linear Lighting Systems

The linear lighting systems disclosed herein may be assembled from modular components. For example, the linear lighting system may include a mounting track, a combination of one or more light bars with the same or different lengths mechanically coupled to the mounting track, and at least one input connector mechanically coupled to the mounting track to supply electrical power and/or control signal(s) to the linear lighting system. The linear lighting system may further include one or more middle connectors to electrically couple one light bar to another light bar, e.g., in a daisy-chain configuration. Thus, the middle connector may transmit electrical power and control signal(s) from one light bar to another light bar. The linear lighting system may further include an end connector, for example, to mechanically couple the last light bar to the mounting track.

The linear lighting systems disclosed herein may provide a standardized mechanical interface to mechanically couple different combinations of light bars together to form a linear lighting system with a desired length. The linear lighting systems disclosed herein may further provide a standardized electrical interface to electrically couple the light bars together (e.g., via a combination of input connectors and middle connectors). Additionally, the various components of the linear lighting systems disclosed herein may be mechanically and electrically coupled together in a tool-free manner. In sum, the modular linear lighting systems disclosed herein may provide reliable electrical connections similar to a soldered electrical connection used in LED tapes, the convenience of a tool-free connector, and the flexibility of a highly customizable run length while also providing the strength and quality of a built fixture.

In some implementations, the linear lighting systems disclosed herein may comprise one or more sub-runs. Generally, the linear lighting system may comprise a run of light bars that spans a total desired length (also referred to herein as the “run length”). However, one driver maybe unable to supply power to all the light bars above a threshold run length due to Class 2 NEC limits and voltage drop limitations. Accordingly, the linear lighting system may comprise multiple sub-runs where each sub-run is supported by a single driver. As an illustrative example, if the linear lighting system has a run length of 100 feet and a single driver is only able to support a run length up to 20 feet, the linear lighting system may be constructed from five 20 feet sub runs that are each supported by a separate driver. The upper limit to the run length supported by a single driver may more generally range from 20 feet to 32 feet, including any values and sub-ranges in between.

The modular linear lighting system may be assembled from one or more light bars where the light bars have lengths of 1 inch, 2 inches, 6 inches, 10 inches, 12 inches, 24 inches, or 48 inches. More generally, the light bars may have a length ranging from 1 inch to 48 inches, including all sub-ranges and values in between. The total length of the linear lighting system may vary depending on the combination of light bars used. In some implementations, the lighting system, as assembled, may leave gaps less than 1 inch at its corners. Additionally, the lighting system may be assembled without requiring any field cutting or custom factory cutting of the light source.

In some implementations, the linear lighting systems disclosed herein may have a substantially uniform or uniform cross-section along the run length (e.g., the length of the light bars). In other words, the various components of the linear lighting system, when assembled, may provide a substantially uniform or uniform cross section. Herein, a substantially uniform cross-section may mean the shape and dimensions of the cross-section are the same across 95% or more of the run length. Additionally, the cross-section of the linear lighting system may include the mounting track. The cross-section of the linear lighting systems disclosed herein may have various shapes including, but not limited to, a square, a rectangle, a circle, a semicircle, an oval, a polygon, and any combinations of the foregoing. The width and/or height of the linear lighting systems disclosed herein may be less than or equal to about 1 inch. For example, the width and/or height of the linear lighting systems disclosed herein may be equal to about 0.5 inches, about 0.6 inches, about 0.7 inches, about 0.8 inches, about 0.9 inches, or about 1 inch. In one non-limiting example, the linear lighting systems disclosed herein may have a square cross section with a side length of 0.5 inches where the cross section includes the mounting track.

The lighting system, as assembled, may provide a dot-free, seamless line of light. In some implementations, each light bar may include an optic (e.g., optics 280a-280c) that functions as a flat, dot free diffuser. The optic may be disposed directly below the light source (e.g., the light sources 270a-270c) of the light bars to provide glare free viewing from the side.

In some implementations, the linear lighting system may emit light (e.g., via the LEDs 272) having a light flux per foot up to about 50 lumens per foot, 100 lumens per foot, 150 lumens per foot, 200 lumens per foot, 250 lumens per foot, 300 lumens per foot, 350 lumens per foot, about 400 lumens per foot, about 450 lumens per foot, or about 500 lumens per foot. It should be appreciated that the foregoing values are an upper limit. The light flux emitted by the light source 270a may vary from 0% to 100% of the upper limit. This may be accomplished by using a LED driver connected to the linear lighting system to facilitate dimming of the light source 270a. The linear lighting systems disclosed herein may be compatible with various types of dimmers including, but not limited to, a Triode for Alternating Current (TRIAC) dimmer, an Electronic Low Voltage (ELV) dimmer, and a 0-10V dimmer.

The linear lighting systems disclosed herein may emit red, green, blue, and white (RGBW) light and any combinations thereof. For example, the linear lighting system may include LEDs (e.g., LEDs 272) that are static white, warm dime, or tunable LEDs. The linear lighting system may further be tunable, e.g., via a LED controller, to adjust, for example, the color temperature (e.g., the LEDs 272 may be a tunable white source). For example, the linear lighting system may emit light having a correlated color temperature (CCT). The CCT of the light output may range from about 1000K to about 10,000K, including all sub-ranges and values in between. For example, the CCT of the light output may be equal to about 1000K, about 1500K, about 2000K, about 2500K, about 3000K, about 3500K, about 4000K, about 4500K, about 5000K, about 5500K, about 6000K, about 6500K, about 7000K, about 7500K, about 8000K, about 8500K, about 9000K, about 9500K, or about 10,000K. In some implementations, the CCT of the light output from the light source 270a may be tunable. For example, the CCT may be adjusted from about 1000K to about 10,000K, including all sub-ranges and values in between. In another example, the CCT may be adjusted from about 1800K to about 3000K, including all sub-ranges and values in between. In yet another example, the CCT may be adjusted from about 1800K to about 4000K, including all sub-ranges and values in between.

In some implementations, the linear lighting systems disclosed herein may provide an efficacy greater than or equal to 100 lumens per watt. In some implementations, the linear lighting systems disclosed herein may provide color rendering index (CRI) greater than or equal to 95. In some implementations, the linear lighting systems disclosed herein may provide a standard deviation of color matching (SDCM) value equal to 3. In some implementations, the linear lighting systems disclosed herein may have a L70 rating equal to 50,000 hours.

The linear lighting systems disclosed herein may not include an integrated LED driver. Rather, a LED driver may be separately installed, e.g., within a ceiling space or a wall space, and electrically connected to the linear lighting system via one or more wires (e.g., wires 373a and 373b). The linear lighting systems disclosed herein may be connected to various types of drivers including, but not limited to, a Digital Multiplex (DMX) driver, and a Digital Addressable Lighting Interface (DALI) driver. In some implementations, the linear lighting systems disclosed herein may receive a direct current (DC) electrical input at 24 VDC. For example, the linear lighting system disclosed herein may be compatible with an off-the-shelf two channel 24 VDC tape light driver (e.g., an eldoLED driver and the like). In some implementations, the linear lighting systems disclosed herein may have a power consumption of 3 Watts per foot.

The linear lighting systems disclosed herein may also receive one or more control signals to adjust the light output, such as the brightness or the color (e.g., the CCT value). The control signals may come from, for example, a LED driver or a LED controller. In implementations where the linear lighting system only receives control signals to adjust the brightness of the light output, the linear lighting system may be connected to a LED driver via two wires to receive a two-signal input. In implementations where the linear lighting system receives control signals to adjust both the brightness and the color of the light output, the linear lighting system may be connected to a LED controller. In some implementations, the LED controller may be installed separate from the linear lighting fixture. Thus, the linear lighting fixture may be connected to the LED controller via three wires to receive a three-signal input. In some implementations, the linear lighting system may include an integrated LED controller (see, for example, the input connector 300b). The linear lighting fixture may be connected to a LED driver via two wires to receive a two-signal input, but via the integrated LED controller, may generate a three-signal output for the light bars (e.g., to provide electrical power and control signals affecting the brightness and the color of the light output). Herein, the linear lighting system may be electrically coupled to an external electrical system, which may include a LED driver and/or a LED controller.

The linear lighting systems disclosed herein may satisfy the requirements of various industry standards set by various standards setting bodies including, but not limited to, the Underwriters Laboratories (UL), the Canadian Underwriters Laboratories (cUL), and standards set by various state governments (e.g., California). For example, the linear lighting systems disclosed herein may satisfy standards set forth under California JA8. In another example, the linear lighting systems disclosed herein may be rated for damp environments. In yet another example, the linear lighting systems disclosed herein may be clothes closet rated.

Following below are several non-limiting examples of linear lighting systems that showcase the modular nature of the inventive linear lighting systems disclosed herein.

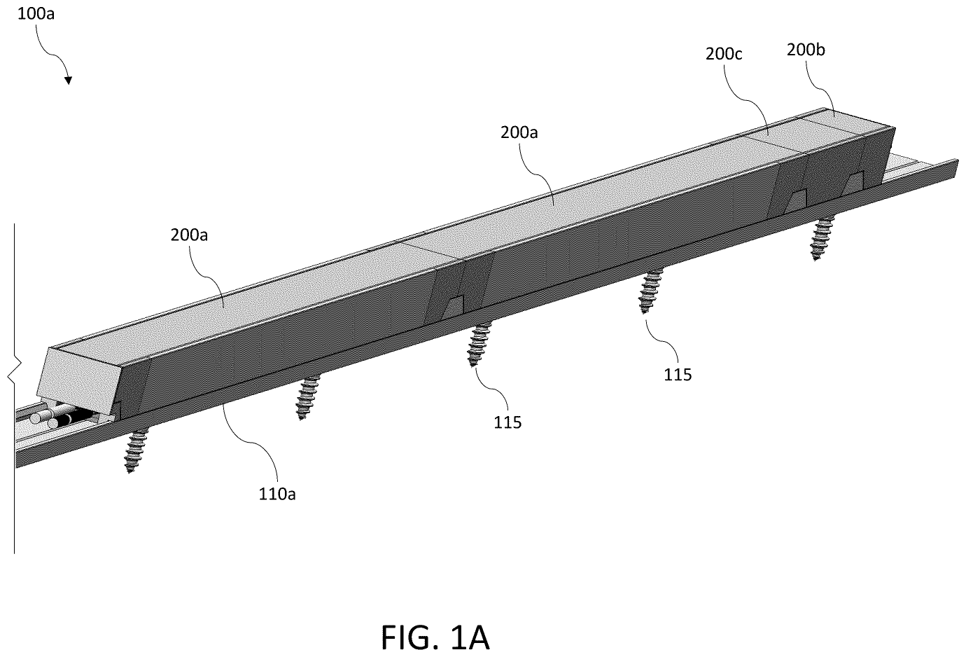

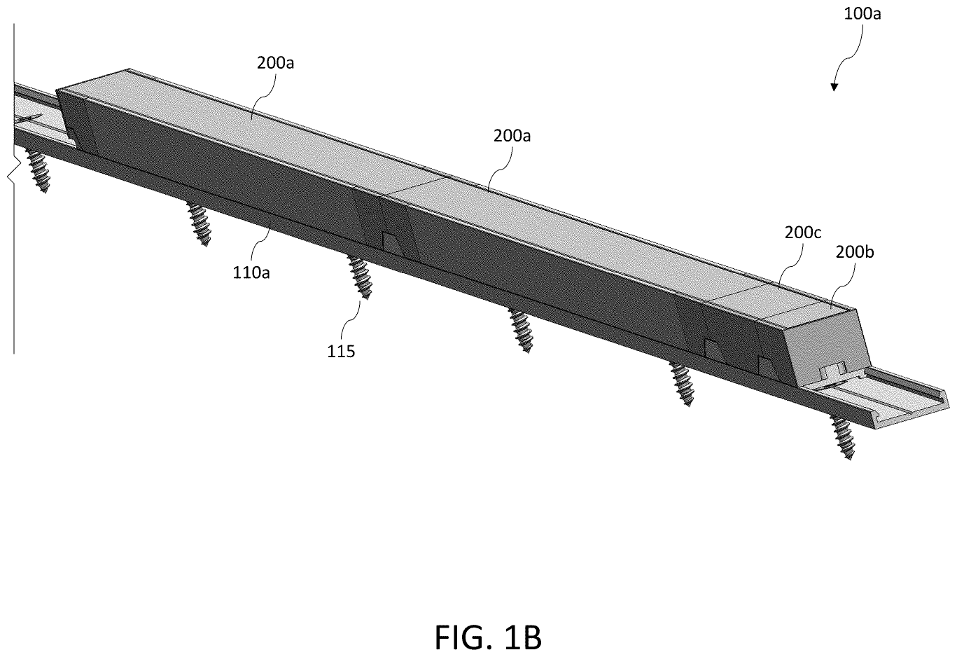

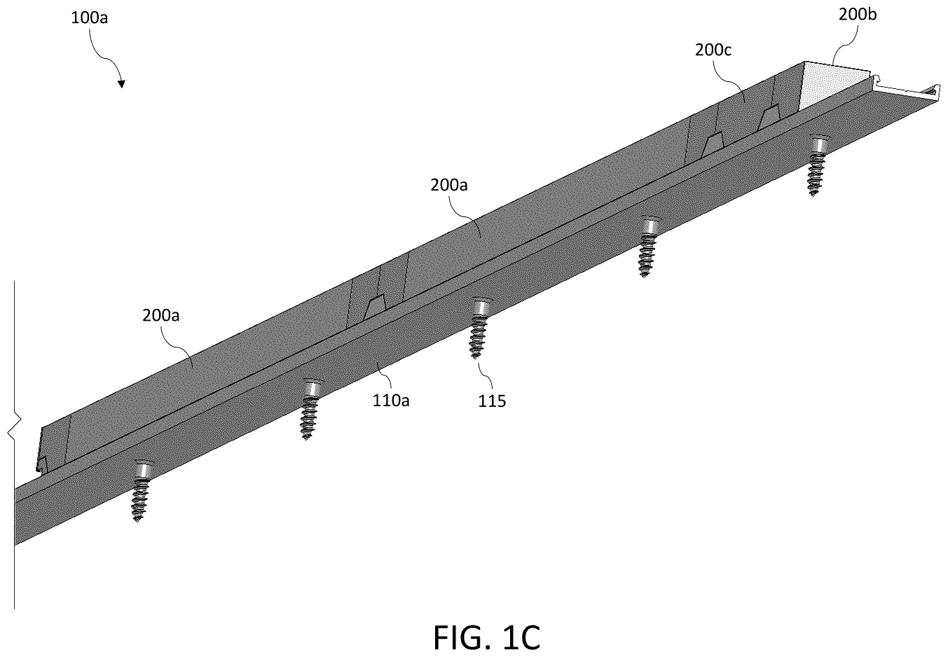

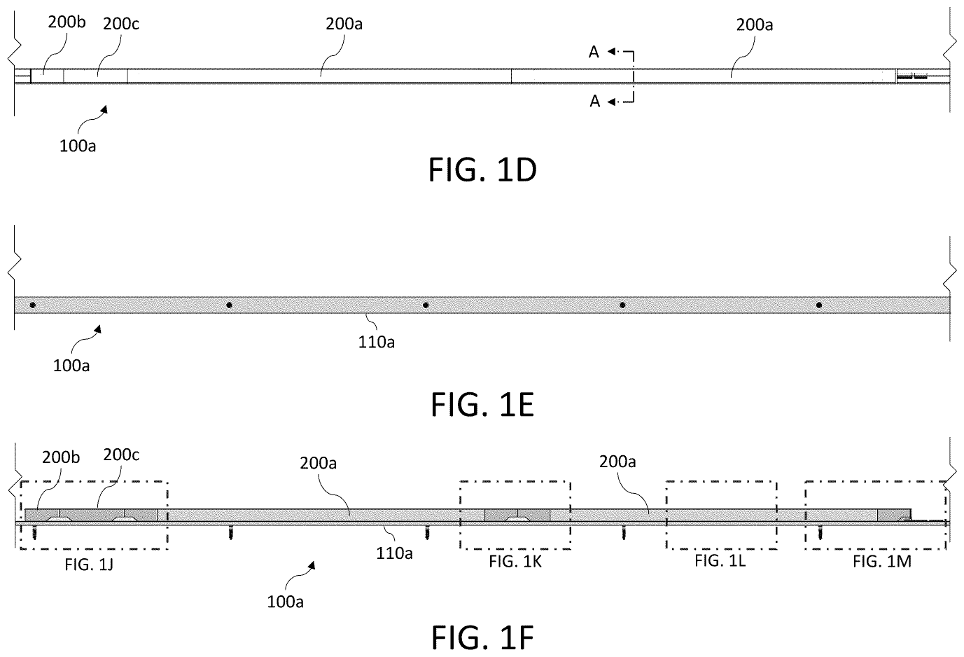

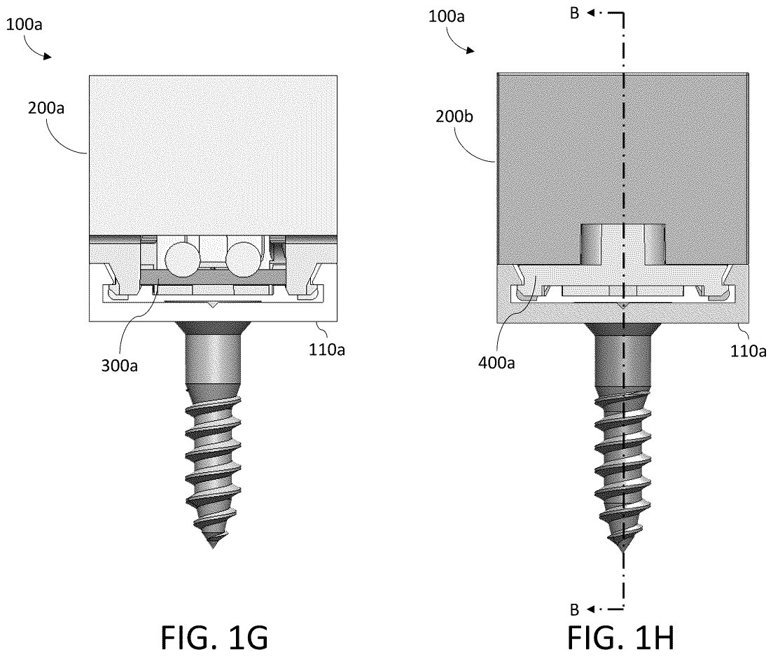

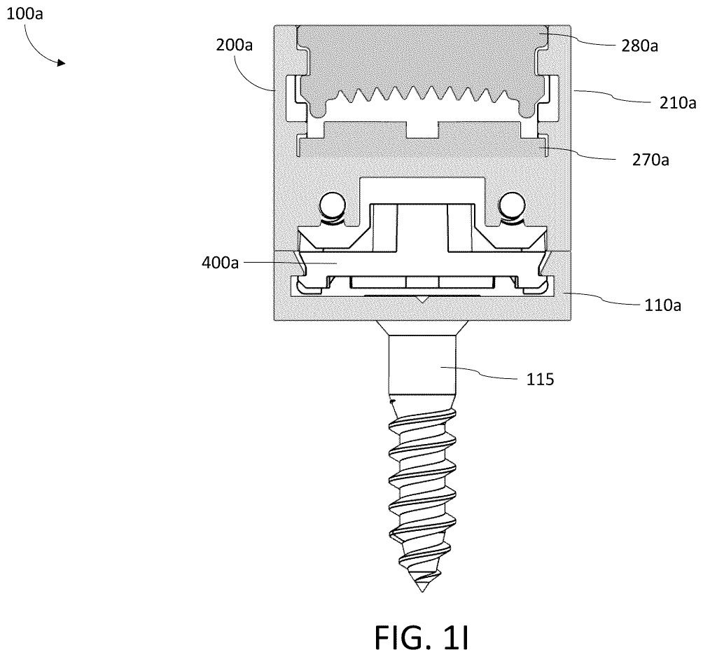

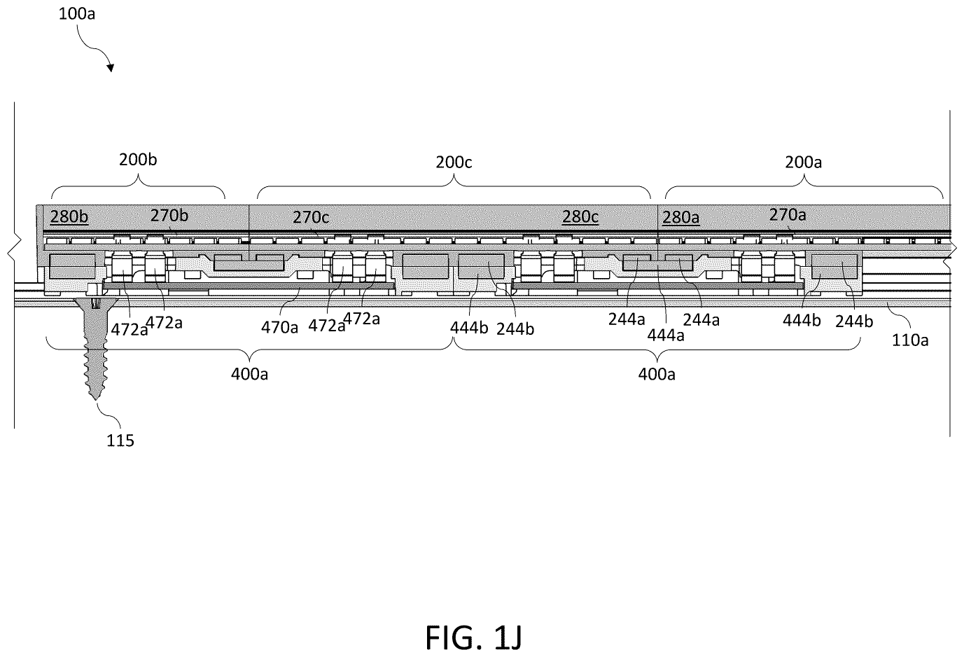

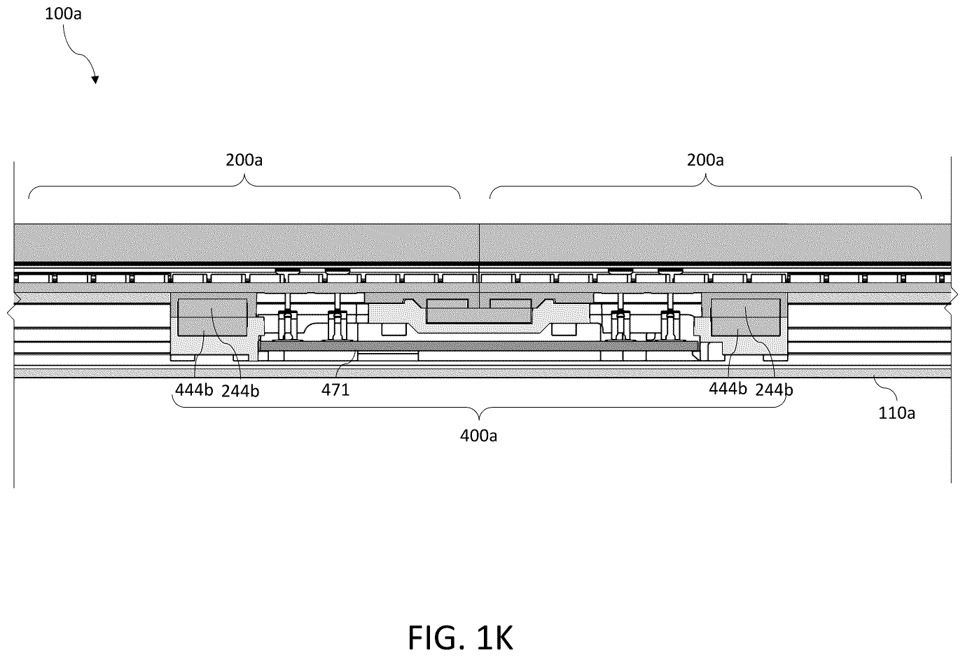

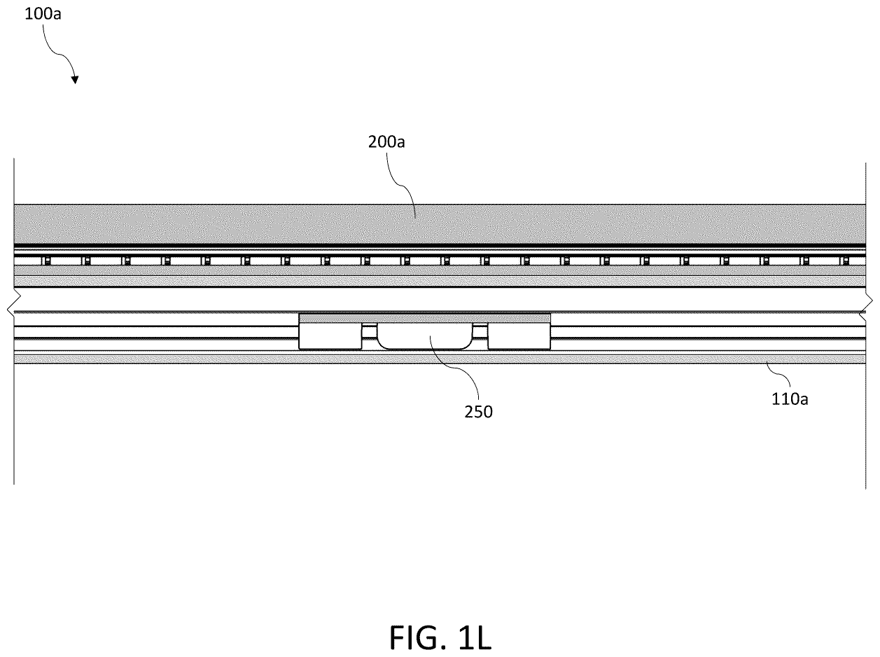

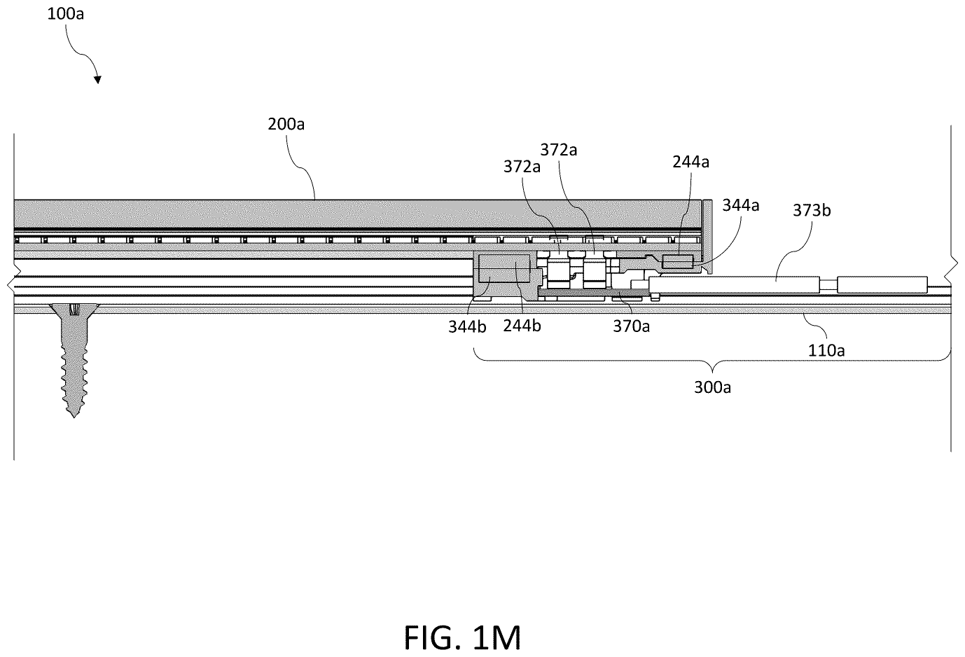

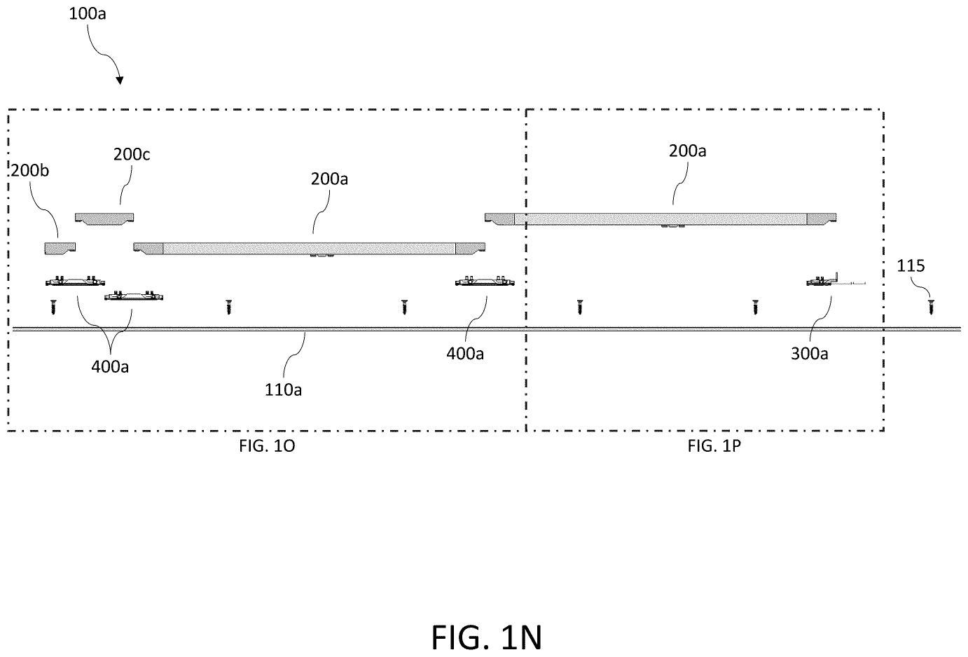

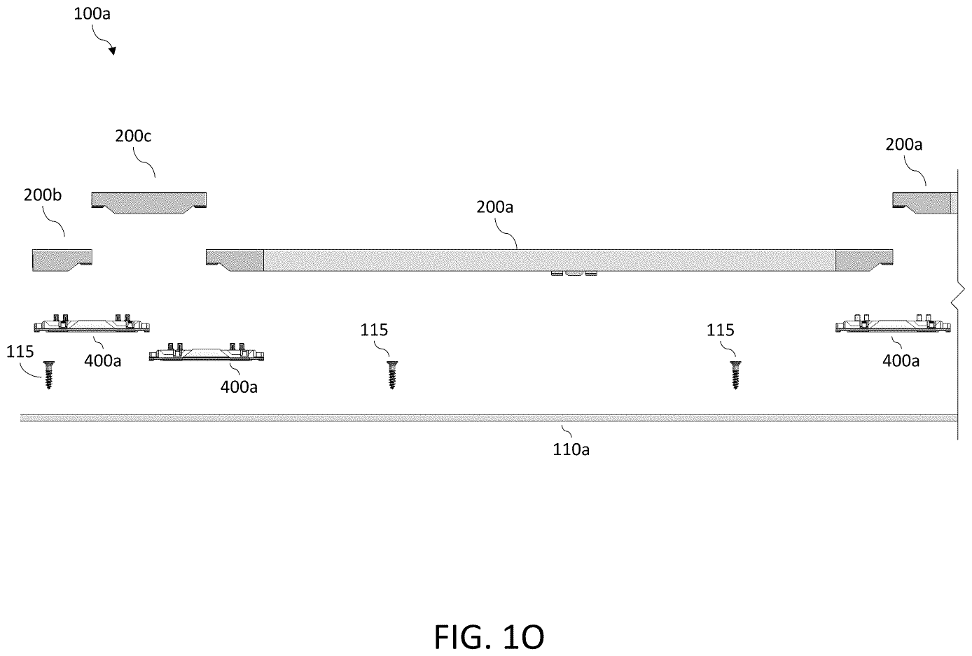

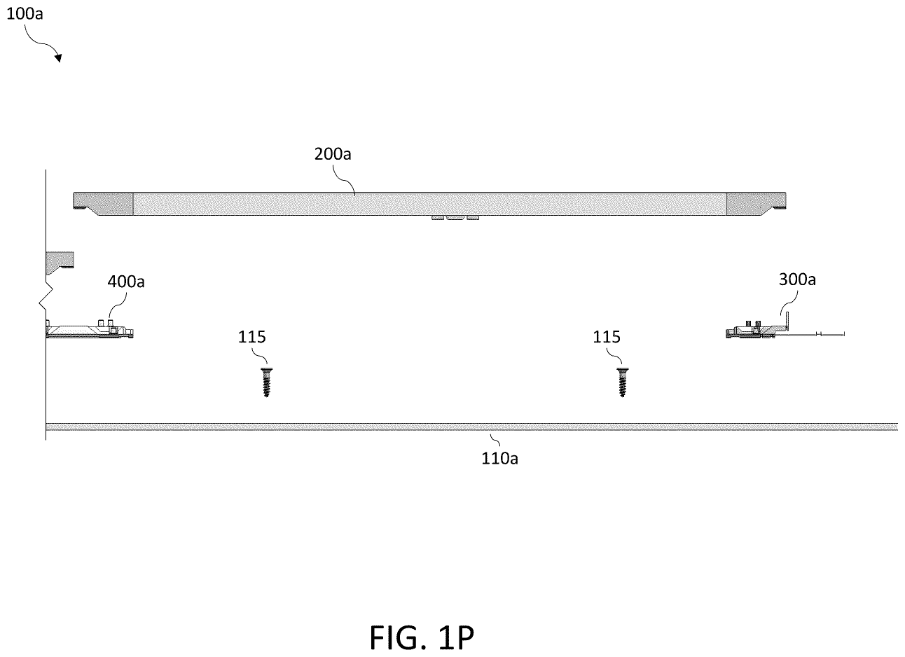

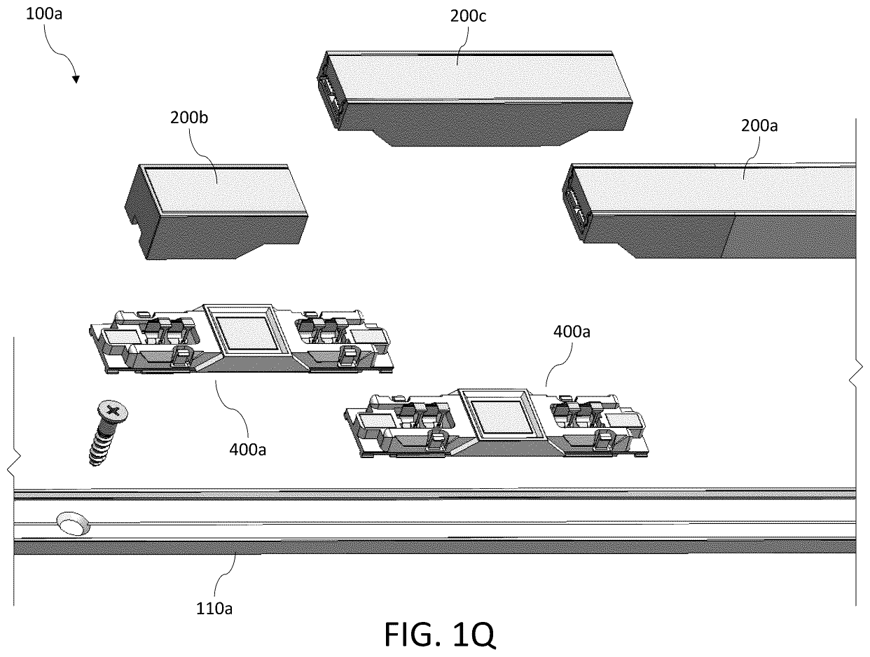

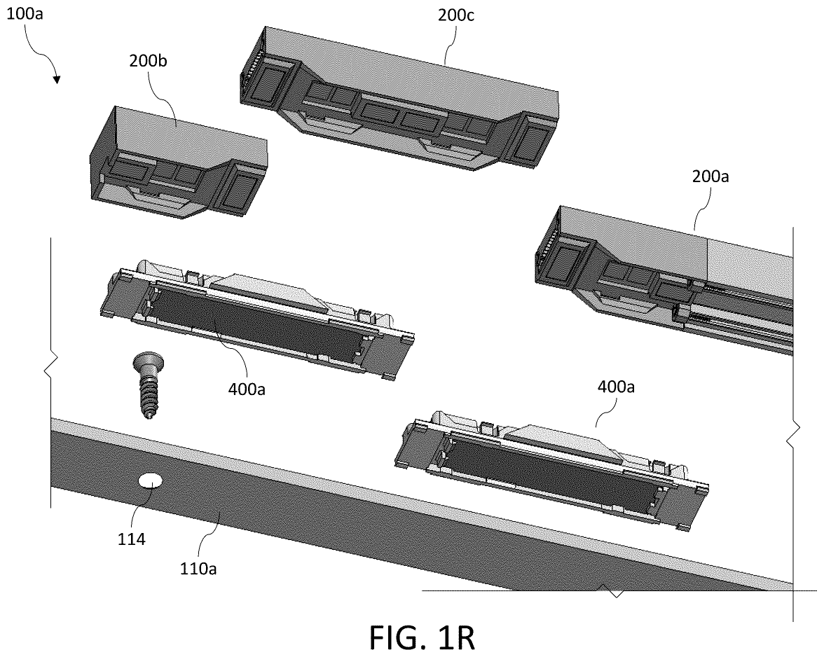

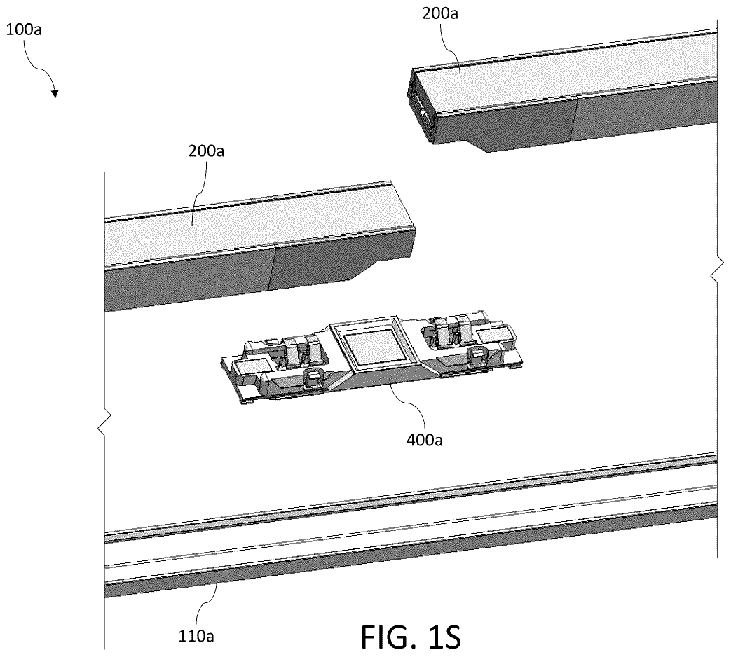

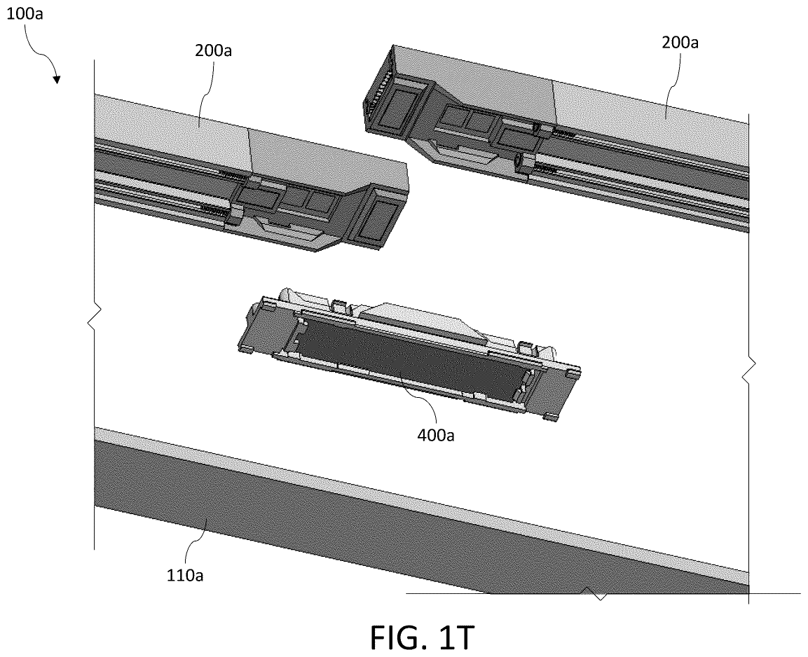

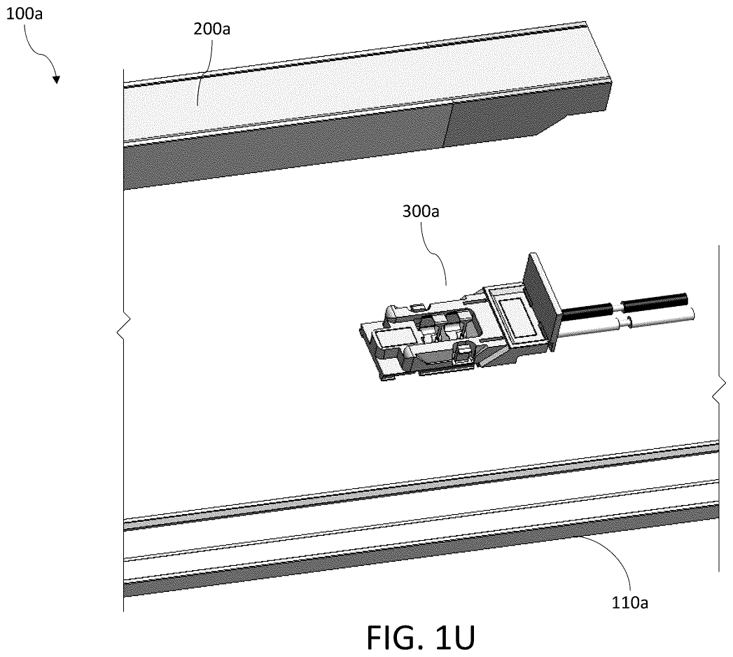

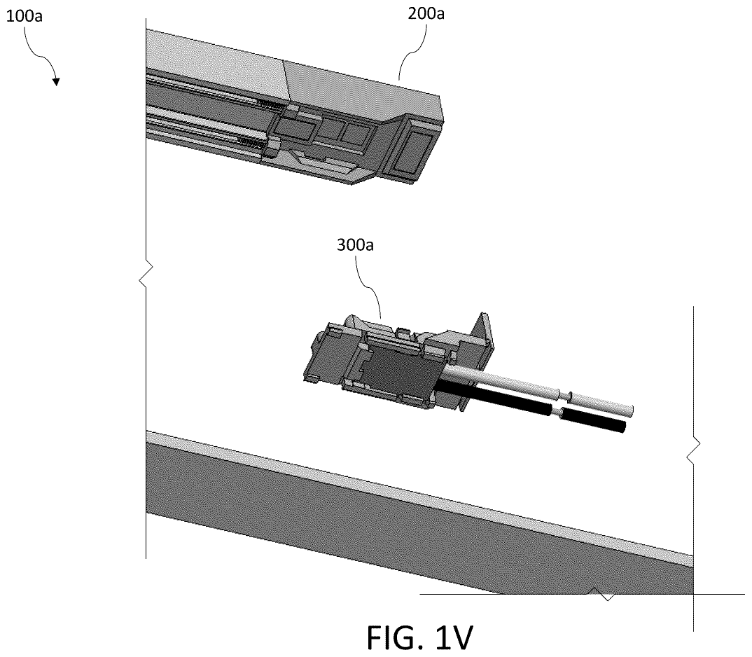

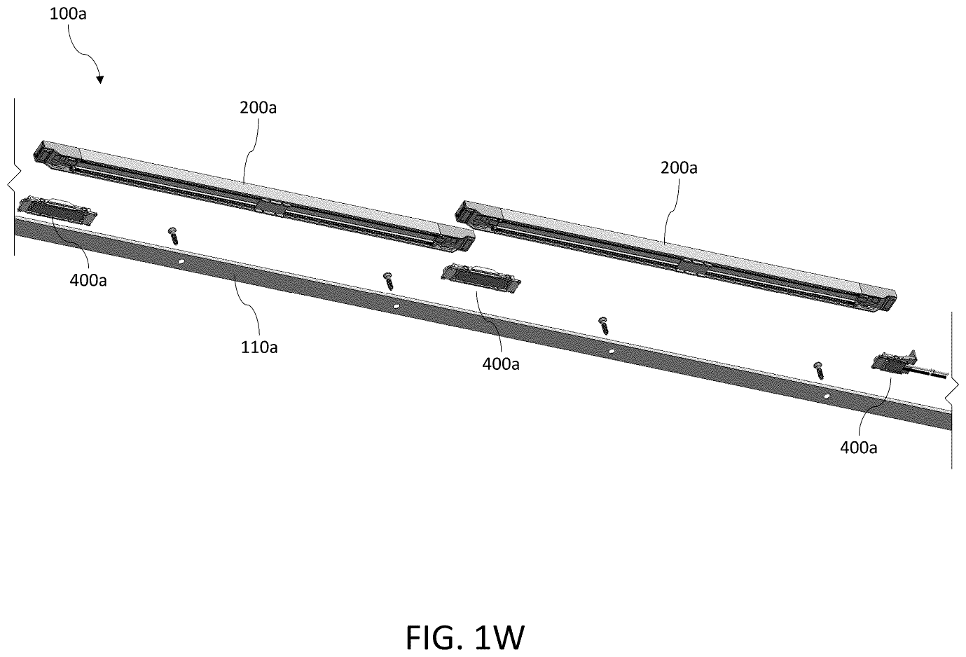

In one non-limiting example, FIGS. 1A-1W show a linear lighting system 100a. As shown, the linear lighting system 100a may include a pair of light bars 200a, a light bar 200b, and a light bar 200c (collectively referred to as “light bars 200”) mechanically coupled to a mounting track 110a. In this example, the linear lighting system 100a may include a mounting track 110a securely coupled to a building surface (e.g., a ceiling, a wall) via one or more fasteners 115. As described above, the mounting track 110a may provide a mechanical interface to mechanically couple together the various components of the linear lighting system 100a.

The linear lighting system 100a may include an input connector 300a to supply electrical power and, in some instances, control signals to control the brightness of the light output from the light bars. The input connector 300a may be connected to an external LED driver (not shown) via a pair of wires (e.g., wires 373a and 373b).

The light bars 200 may receive the electrical power and the control signals from the input connector 300a as follows. One end of a first light bar 200a may be mechanically and electrically coupled to the input connector 300a. The other end of the first light bar 200a may be mechanically and electrically coupled to a first middle connector 400a. The middle connector 400a may include electronics 470a to transmit the electrical power and the control signals between the light bars 200. One end of a second light bar 200a may be mechanically and electrically coupled to the first middle connector 400a. The other end of the first light bar 200a may be mechanically and electrically coupled to a second middle connector 400a. One end of the light bar 200c may be mechanically and electrically coupled to the second middle connector 400a. The other end of the light bar 200c may be mechanically and electrically coupled to a third middle connector 400a. Lastly, the light bar 200b may be mechanically and electrically coupled to third middle connector 400a. In this example, only one end of the light bar 200b may be electrically connected to a connector. Thus, the light bar 200b may constitute the end of the run of light bars 200 in the linear lighting system 100a.

Each of the light bars 200, the input connector 300a, and the middle connector 400a may be mechanically coupled to the mounting track 110a, e.g., via a snap-fit connection. Each light bar 200 may be mechanically coupled to the input connector 300a and/or the middle connector 400a via a magnetic coupling mechanism (see, for example, the magnets 244a and 244b of the light bars 200a-200c, the magnets 344a and 344b of the input connector 300a, and the magnets 444a and 444b of the middle connector 400a), and/or a snap-fit connection mechanism (see, for example, the snap-fit retainers 245 of the light bars 200a-200c, the snap-fit connectors 315a and 315b of the input connector 300a, and the snap-fit connectors 415a and 415b of the middle connector 400a), neither of which require the use of any tools. Each light bar 200 may be electrically coupled to the input connector 300a and/or the middle connector 400a via spring-loaded electrical connectors (e.g., electrical contact pads 273a of the light bars 200a-200c, electrical spring contacts 372a of the input connector 300a, and the electrical spring contacts 472a of the middle connector 400a), which similarly do not require the use of any tools.

In some implementations, the linear lighting system 100a may be assembled by mounting, for example, the input connector 300a and the middle connectors 400a to one light bar 200 and thereafter installing the subassembly of the light bar 200 and the input connector 300a and/or the middle connectors 400a onto the mounting track 110a. This way, the components of the linear lighting system 100a may be installed onto the mounting track 110a without requiring precise placement of any one component on the mounting track 110a. However, it should be appreciated that, in some implementations, the input connector 300a and the middle connectors 400a may be installed onto the mounting track 110a first. Thereafter, the light bars 200 may be installed onto the input connector 300a and/or the middle connectors 400a as appropriate. With this approach, the input connector 300a and the middle connectors 400a may require more precise placement on the mounting track 110a to ensure mechanical and electrical coupling with the light bars 200.

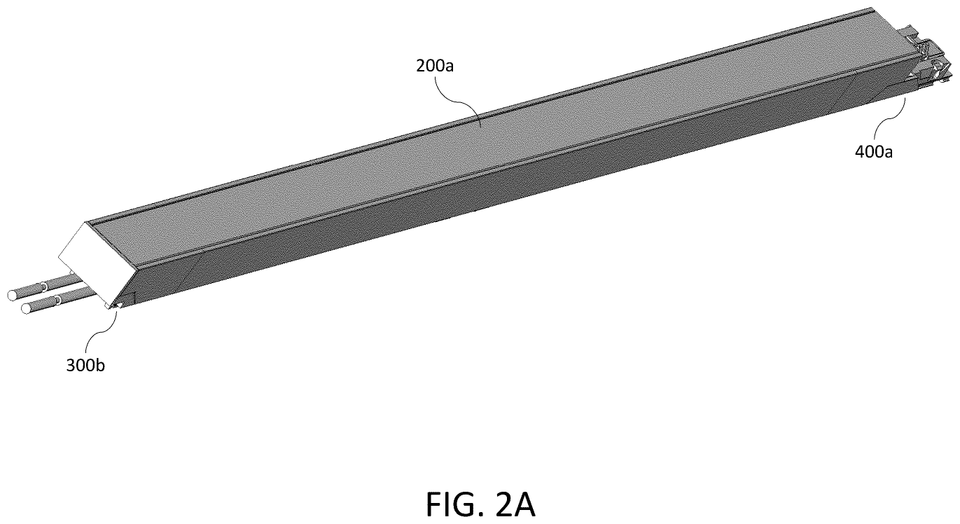

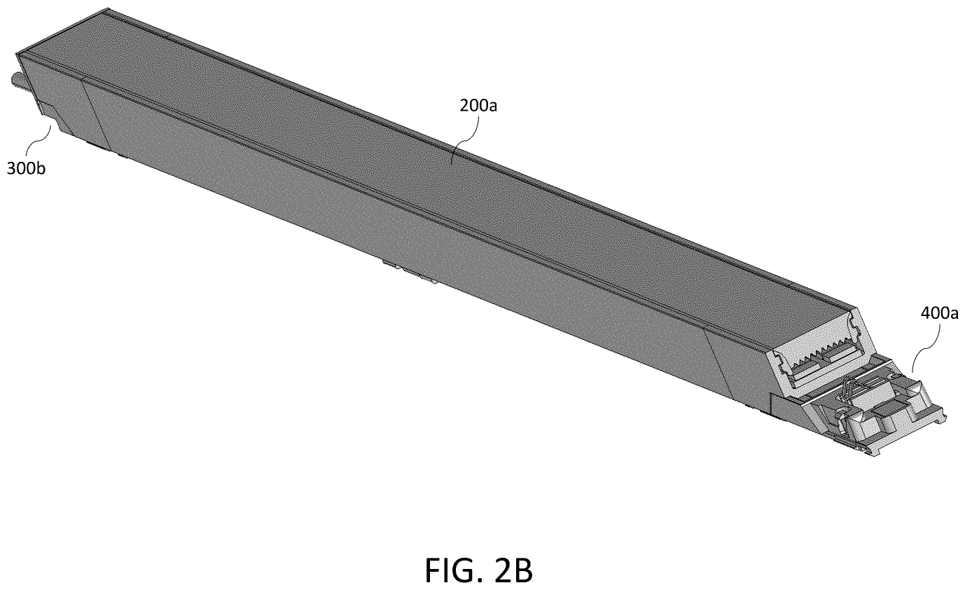

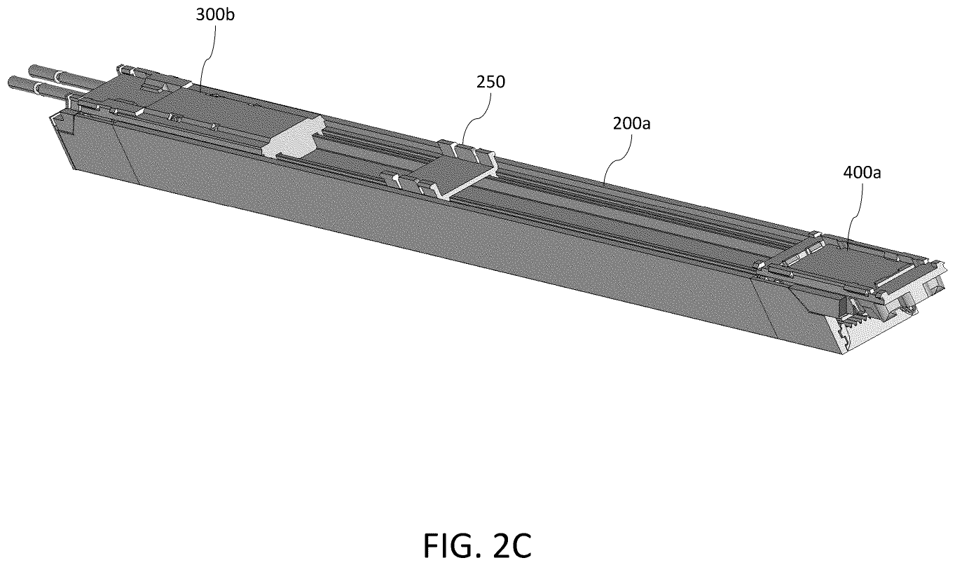

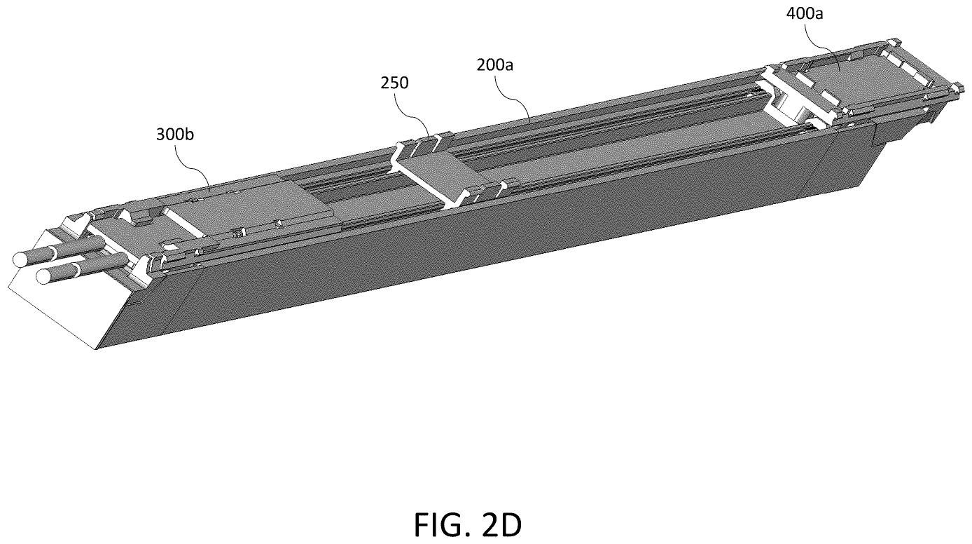

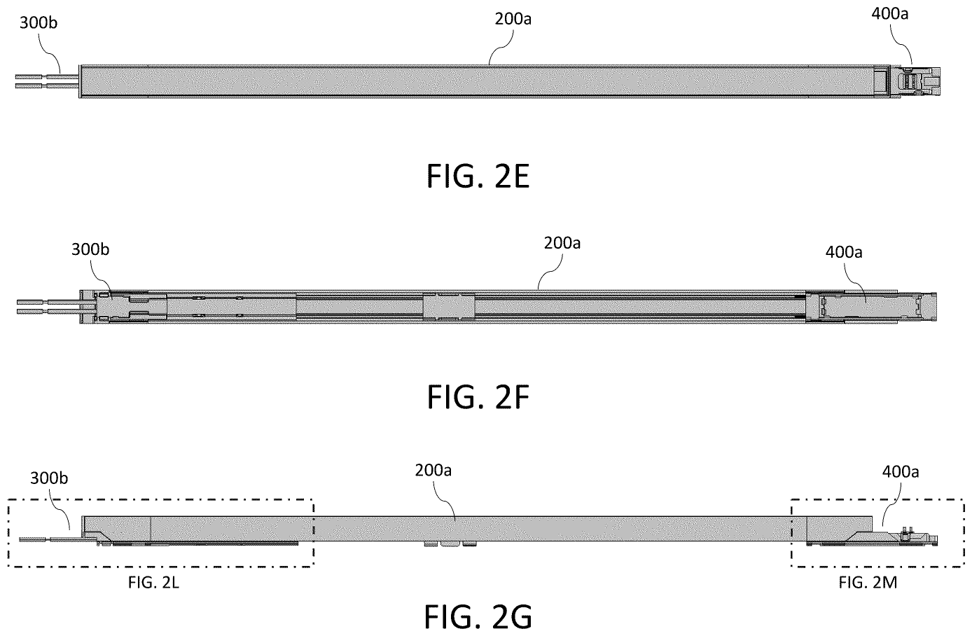

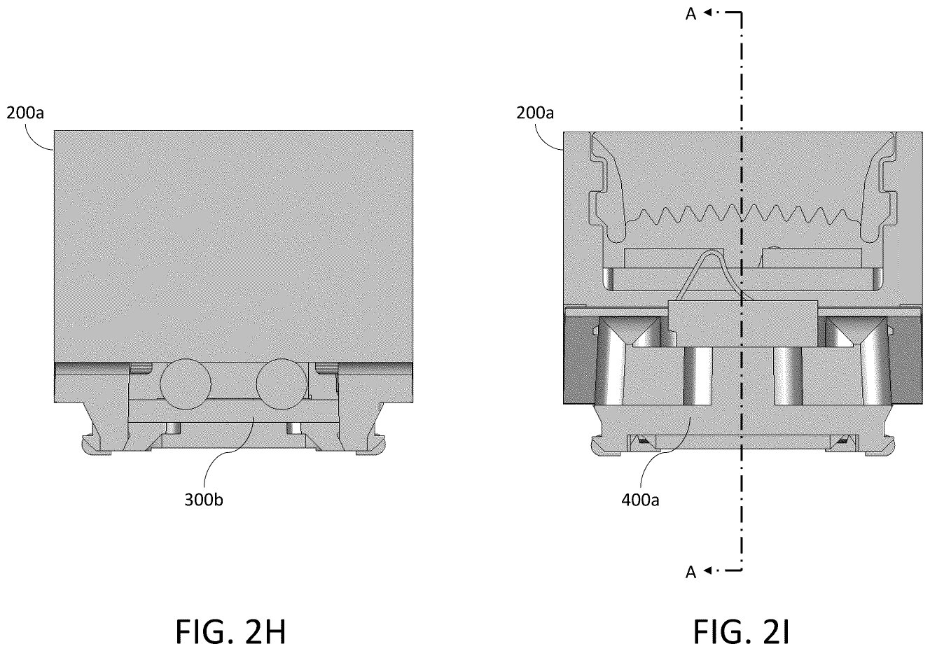

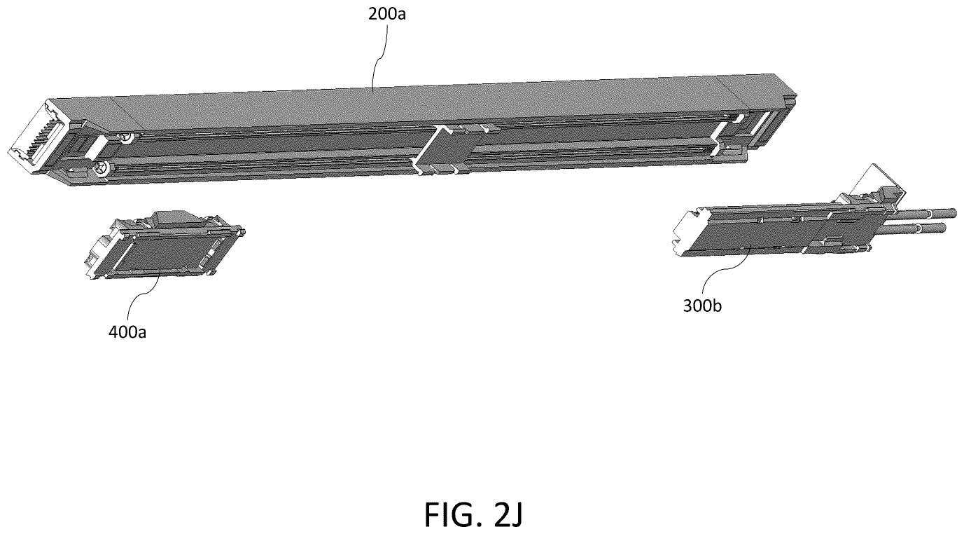

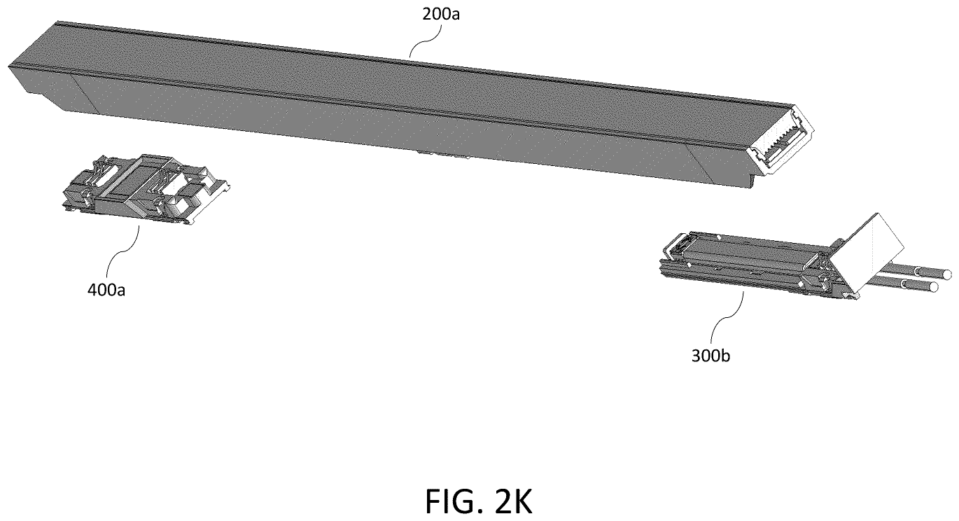

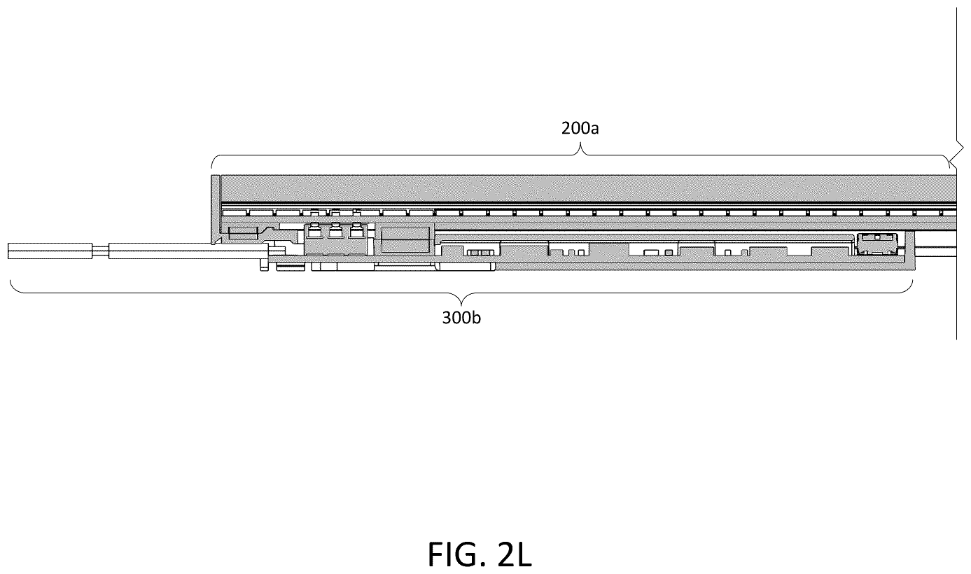

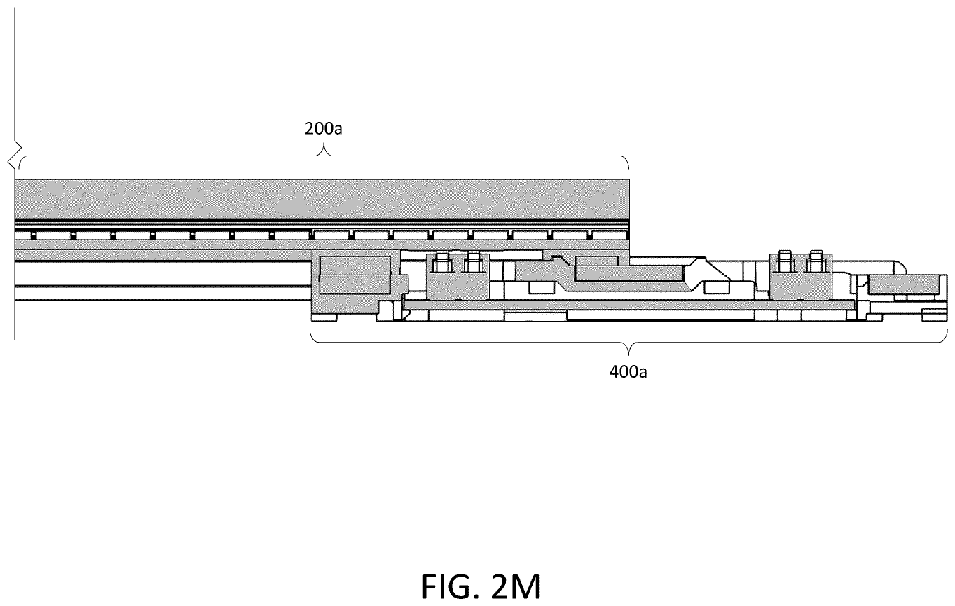

In another non-limiting example, FIGS. 2A-2M show a subassembly for another linear lighting system. As shown, the subassembly may include an input connector 300b. The input connector 300b may include an integrated LED controller that provides control signals to adjust, for example, the color of the light output. In some implementations, the input connector 300b may only be paired with light bars 200 that incorporate two or more different types of LEDs (e.g., LEDs that emit different CCTs).

The input connector 300b may connect to an external LED driver (not shown) via a pair of wires (e.g., wires 373a and 373b). In some implementations, the input connector 300b may receive electrical power and control signals affecting the brightness of the light output from the LED driver. Thus, the input connector 300b may receive a two-signal input. The LED controller, as described above, may provide an additional control signal affecting the color of the light output. Thus, the input connector 300b may provide a three-signal output to the light bars.

The subassembly may be assembled in a similar manner to the lighting system 100a described above. As shown, one end of a light bar 200a may be mechanically and electrically coupled to the input connector 300b. The other end of the light bar 200a may be mechanically and electrically coupled to a middle connector 400a to facilitate subsequent connections of additional light bars 200. Although not shown, the sub assembly may be mechanically mounted to a mounting track (e.g., the mounting track 110a).

### 1.1 Examples of Light Bars

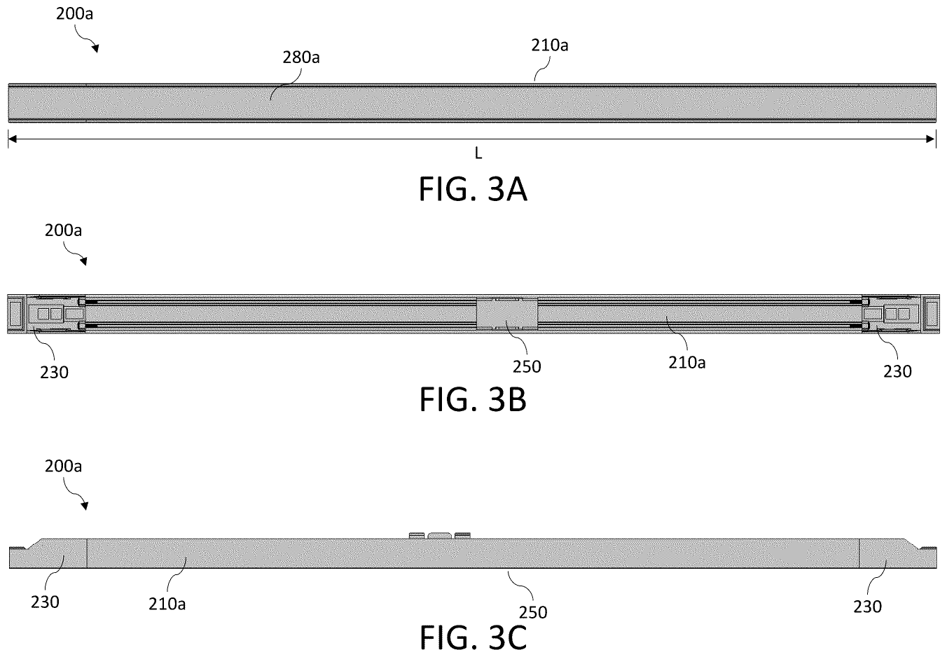

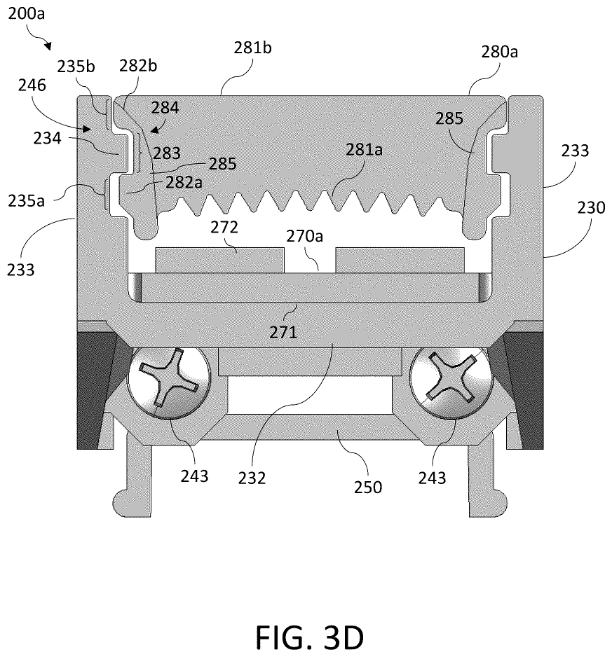

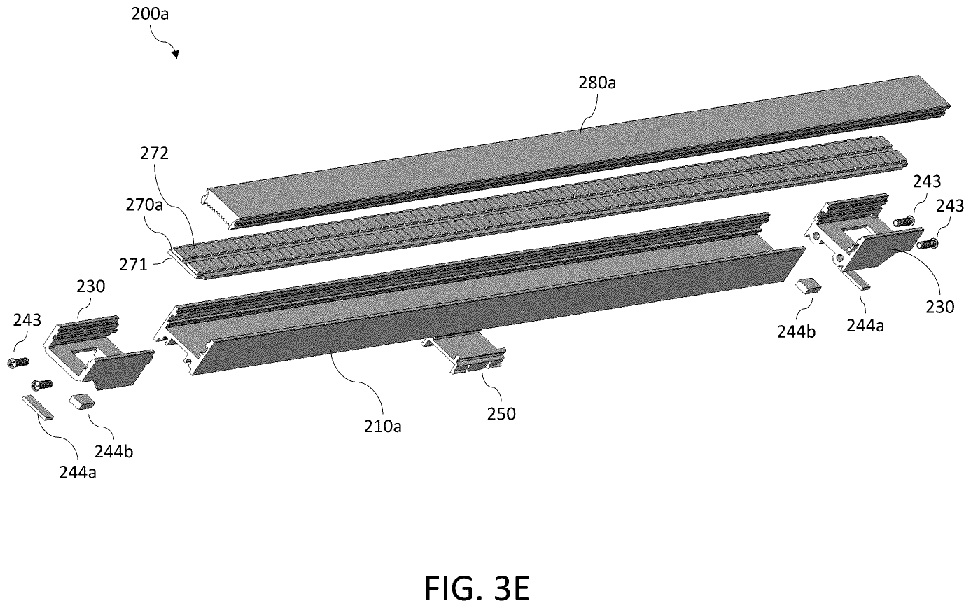

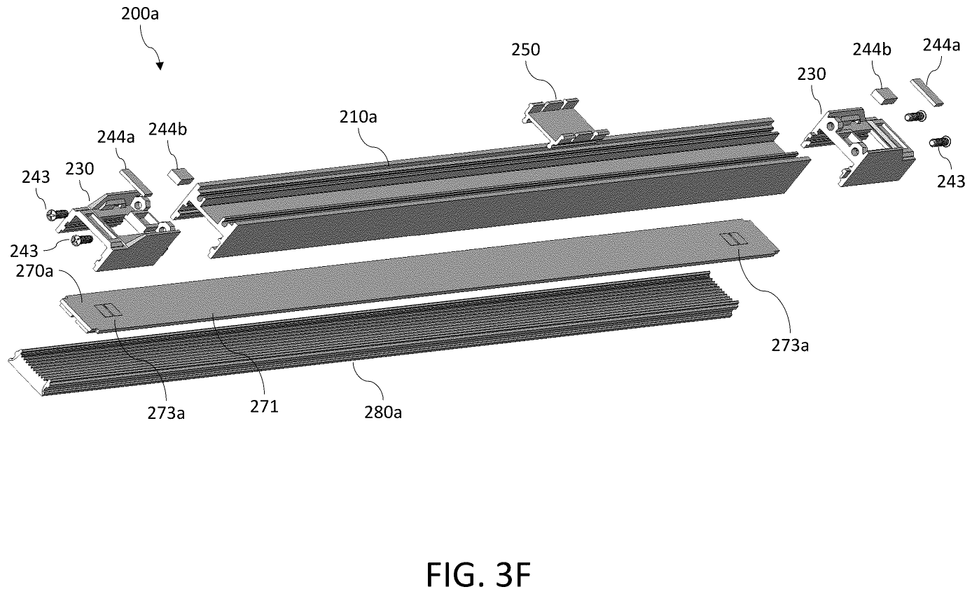

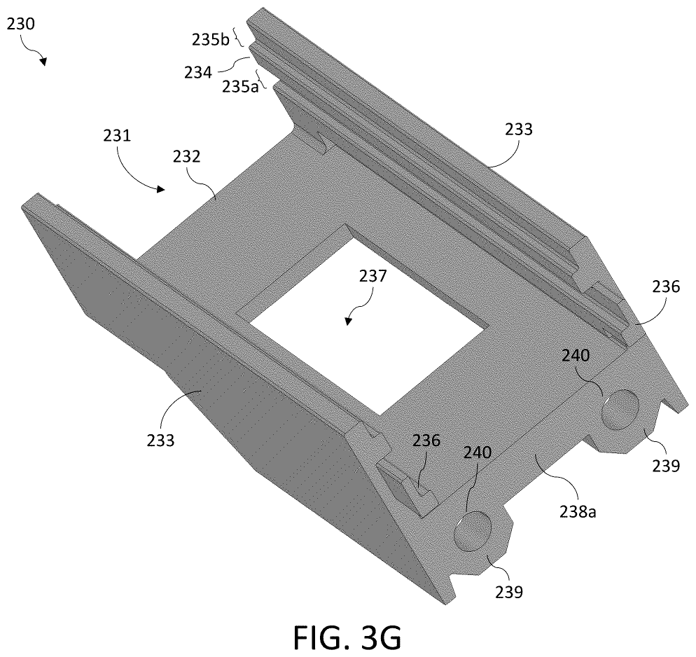

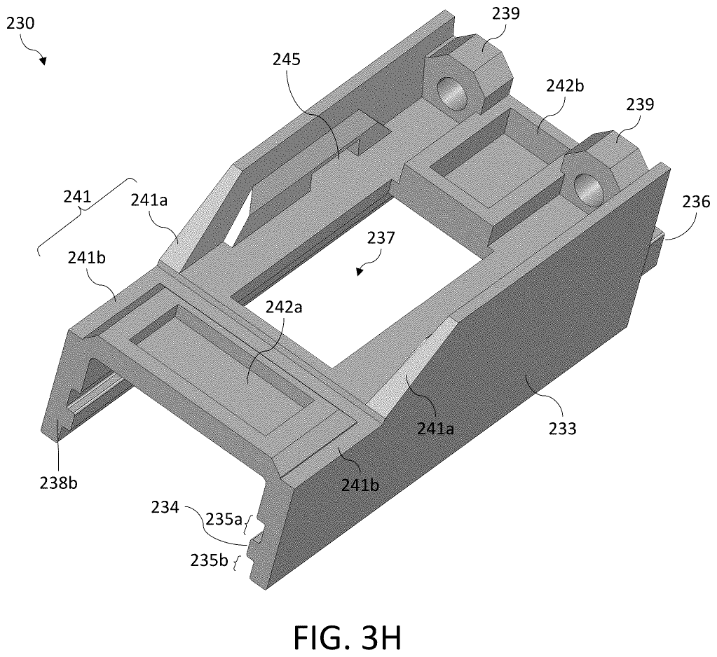

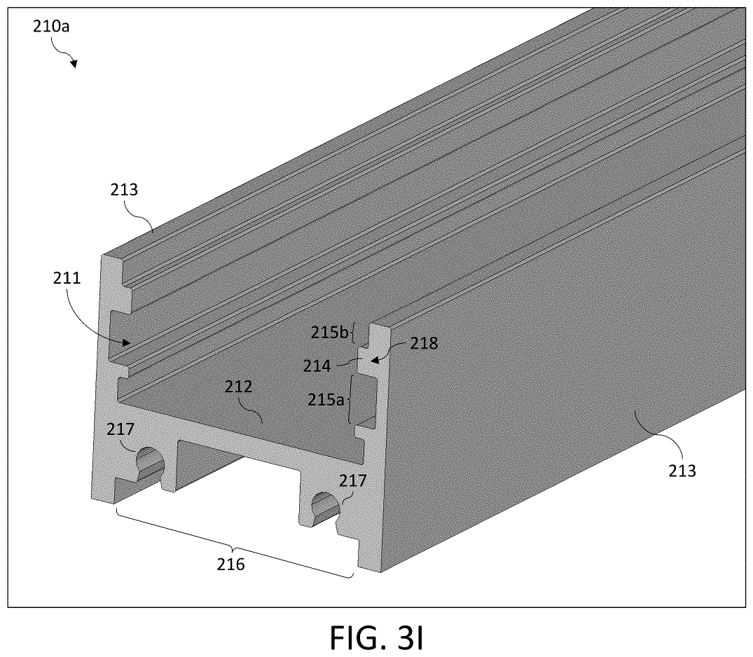

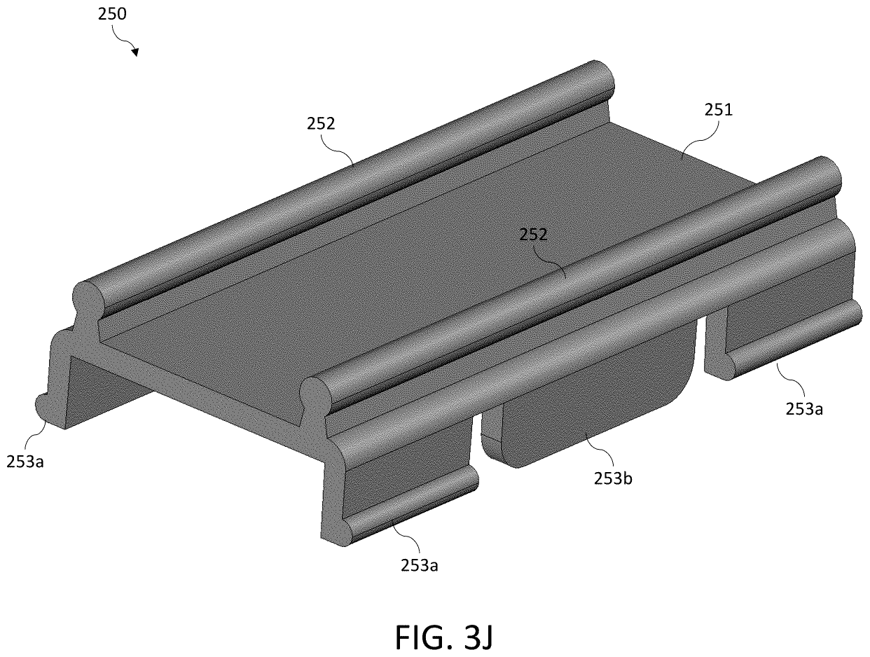

FIGS. 3A-3J show several views of the light bar 200a. In this example, the light bar 200a may be installed at any location along the run of light bars forming the linear lighting system, e.g., at the beginning of the run, in the middle of the run, or at the end of the run. Moreover, the light bar 200a may be mechanically and electrically connected to the input connectors 300a or 300b, the middle connector 400a, or the end connector 500a. The light bar 200a may have a length, L, equal to about 12 inches. However, it should be appreciated that the components and features of the light bar 200a may be readily implemented into other light bars with different lengths, L (see, for example, the light bars 200b and 200c described below). As described in Section 1, the length, L, of a light bar may range from about 1 inch to about 48 inches, including all sub-ranges and values in between.

As shown, the light bar 200a may include a housing 210a to mechanically support other components in the light bar 200a. The light bar 200a may further include a pair of end sections 230 mechanically coupled to opposite ends of the housing 210a where each end section 230 provides features to mechanically align and couple the light bar 200a to the input connectors 300a or 300b, the middle connector 400a, or the end connector 500a. The light bar 200a may include a light source 270a mechanically coupled to the light bar 200a to emit light and an optic 280a mechanically coupled to the housing 210a to redirect and redistribute the emitted light to provide a light output with a desired spatial and/or angular distribution. The light bar 200a may also include a bracket 250 mechanically coupled to the housing 210a to mechanically couple the light bar 200a to the mounting track 110a. Each of the foregoing components of the light bar 200a are described in further detail below.

The housing 210a may include a base 212 and a pair of sidewalls 213 joined to opposing sides of the base 212. Together, the base 212 and the sidewalls 213 may define a channel 211 to contain, for example, the light source 270a and the optic 280a. The sidewalls 213 may further define a channel 216, which provide features to facilitate connection with the end sections 230 and the bracket 250. As shown, the channel 211 and the channel 216 may be disposed on opposite sides of the base 212. When the light bar 200a is installed into a ceiling, the channel 211 may be located along a bottom side of the base 212 and the channel 216 may be located along a top side of the base 212. In some implementations, the housing 210a may have a constant cross-section across its length. This, in turn, may allow the optic 280a to be manufactured via an extrusion process. It should be appreciated, however, that the housing 210a may be formed using other manufacturing processes, such as injection molding (e.g., when the housing 210a is formed from a polymer) or die casting (e.g., when the housing 210a is formed from metal).

FIG. 3I shows the portions of the sidewalls 213 defining the channel 211 may further include features to securely couple the optic 280a to the housing 210a. For example, each sidewall 213 may include a snap-fit connector 218. As shown, each snap-fit connector 218 may include a pair of channels 215a and 215b separated by a rail 214. The snap-fit connectors 218 may engage with corresponding snap-fit connectors 284 on the optic 280a as discussed below.

FIG. 3I further shows the housing 210a may define a pair of openings 217 disposed on opposing sides of the channel 216. The channel 216 and the openings 217 may provide support for the bracket 250. For example, FIG. 3J shows the bracket 250 may include a base 251 and a pair of rails 252. The rails 252 may be inserted through respective openings 217 and the base 251 may be partially disposed within the channel 216. In this manner, the bracket 250 may be slidably coupled to the housing 210a. The bracket 250 may further provide features to mechanically couple the light bar 200a to the mounting track 110a as discussed further below.

The openings 217 may further be used to securely couple each end section 230 to respective ends of the housing 210a. For example, FIGS. 3E and 3F show the light bar 200a may include fasteners 243 inserted through corresponding fastener openings 240 on the end section 230 and the openings 217 on the housing 210a. In some implementations, the portion of the housing 210a that defines the openings 217 may be threaded so that the fasteners 243 may be securely fastened directly to the housing 210a. It should also be appreciated that the fastening mechanism shown in FIGS. 3E and 3F to couple the end section 230 to the housing 210a is a non-limiting example. More generally, the end section 230 may be securely coupled to the housing 210a using various coupling mechanisms including, but not limited to, a snap-fit connection, an adhesive, a rivet, a bolt fastener with a nut, and the like.

In some implementations, the housing 210a may be formed from aluminum (e.g., an aluminum extrusion). More generally, the housing 210a may be formed from various metals and/or polymers including, but not limited to, aluminum, steel, zinc, polyethylene, polypropylene, polyvinyl chloride, polystyrene, acrylonitrile butadiene styrene, polyamide, polycarbonate, polymethyl methacrylate, polybutylene terephthalate, polyethylene terephthalate, and the like. In some implementations, the housing 210a may be manufactured as a single part.

FIGS. 3G and 3H further show each end section 230 may include a base 232 and a pair of sidewalls 233 joined to opposing sides of the base 232. Similar to the housing 210a, the base 232 and the sidewalls 233 may define a channel 231 to contain, for example, a portion of the light source 270a and the optic 280a. When the light bar 200a is installed in a ceiling, the channel 231 may be formed along a bottom side of the base 232.

As shown in FIGS. 3E and 3F, each end section 230 may be coupled to one end of the housing 210a. Specifically, the end section 230 may include a surface 238a that physically abuts one end of the housing 210a. The end section 230 may further include a pair of tabs 239 joined to a top side of the base 232 and each tab 239 may define a fastener opening 240. As described above, the fastener openings 240 may align with corresponding openings 217 on the housing 210a and fasteners 243 may be inserted through corresponding fastener openings 240 and openings 217 to securely couple the end section 230 to the housing 210a.

In some implementations, the end section 230 may further include one or more alignment features to facilitate assembly of the end section 230 to the housing 210a. For example, FIG. 3G shows each sidewall 233 may include a tab 236 that extends from the surface 238a. Each tab 236 may be inserted into corresponding channels 215a formed on the sidewalls 213 of the housing 210a. In this manner, the tabs 236 may facilitate alignment between the end section 230 and the housing 210a, e.g., before the end section 230 is securely coupled to the housing 210a via the fasteners 243.

The portions of the sidewalls 233 defining the channel 231 may include features to securely couple the optic 280a to the end section 230. For example, each sidewall 233 may include a snap-fit connector 246 formed via a pair of channels 235a and 235b separated by a rail 234. The snap-fit connectors 246 may engage with corresponding snap-fit connectors 284 on the optic 280a as discussed below.

FIGS. 3G and 3H further show the base 232 of the end section 230 may include an opening 237. The opening 237 may be aligned with a set of electrical connectors 273a on the light source 270a. This, in turn, may allow electrical connectors from the input connectors 300a or 300b (e.g., the electrical connectors 372a) or the middle connector 400a (e.g., the electrical connectors 472a) to electrically couple to the electrical connectors 273a of the light source 270a.

As described above, the light bar 200a may be mechanically coupled to the input connectors 300a or 300b, the middle connector 400a, or the end connector 500a, in part, via a magnetic coupling mechanism. This may be accomplished by each end section 230 supporting one or more magnets that magnetically couple to corresponding magnets in the input connectors 300a or 300b, the middle connector 400a, or the end connector 500a. For example, FIGS. 3E and 3F show each end section 230 may support a pair of magnets 244a and 244b. The magnets 244a and 244b may magnetically couple to the magnets 344a and 344b, respectively, of the input connectors 300a or 300b, the magnets 444a and 444b, respectively, of the middle connector 400a, or the magnets 344a and 344b, respectively, of the end connector 500a. FIG. 3H shows the magnets 244a and 244b may be inserted into respective magnet holders 242a and 242b joined to the top side of the base 232. As shown, the magnet holders 242a and 242b may be disposed on opposing sides of the opening 237 with the magnet holder 242b further disposed between the tabs 239. In some implementations, the magnets 244a and 244b may be securely coupled to the magnet holders 242a and 242b, respectively, via an adhesive, a press-fit connection, or the like.

It should also be appreciated that the inclusion of magnets on the light bar 200a as well as the input connectors 300a or 300b, the middle connector 400a, and the end connector 500a is a non-limiting example. In another non-limiting example, the magnets 244a and 244b of the light bar 200a may be substituted with a pair of magnetizable plates that magnetically couple to the respective magnets of the input connectors 300a and 300b, the middle connector 400a, and/or the end connector 500a. Alternatively, the magnets 344a and 344b of the input connectors 300a and 300b and the end connector 500a and the magnets 444a and 444b of the middle connector 400a may be substituted with corresponding magnetizable plates that magnetically couple to the respective magnets of the light bar 200a. The plates may be formed from various magnetized or magnetizable materials including, but not limited to, iron, steel, cobalt, nickel, and any combinations of the foregoing.

In addition to the magnetic coupling mechanism described above, the light bar 200a may also be mechanically coupled to the input connectors 300a or 300b, the middle connector 400a, or the end connector 500a via a snap-fit connection. Thus, the magnetic coupling mechanism and the snap-fit coupling mechanism may together securely couple the light bar 200a to the input connectors 300a or 300b, the middle connector 400a, or the end connector 500a in a tool-free manner.

In some implementations, each end section 230 may include one or more snap-fit connectors to provide a snap-fit connection with the input connectors 300a or 300b, the middle connector 400a, or the end connector 500a. For example, the end section 230 may include a pair of snap-fit retainers 245 (i.e., a female snap-fit connector) that couples to corresponding snap-fit connectors 315a or 315b (i.e., a male snap-fit connector) of the input connectors 300a or 300b or the end connector 500a, or corresponding snap-fit connectors 415a or 415b (i.e., a male snap-fit connector) of the middle connector 400a. As shown in FIG. 3H, each snap-fit retainer 245 may be formed onto a portion of the sidewall 233 that joins the top side of the base 232. It should be appreciated that, in some implementations, the end section 230 may include male snap-fit connectors and the input connectors 300a or 300b, the middle connector 400a, and the end connector 500a may each include corresponding female snap-fit connectors.

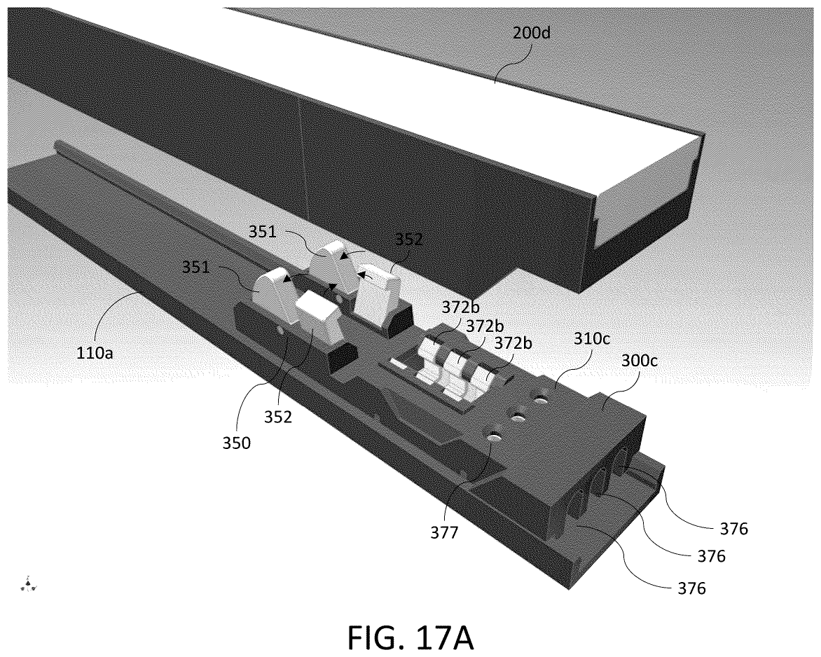

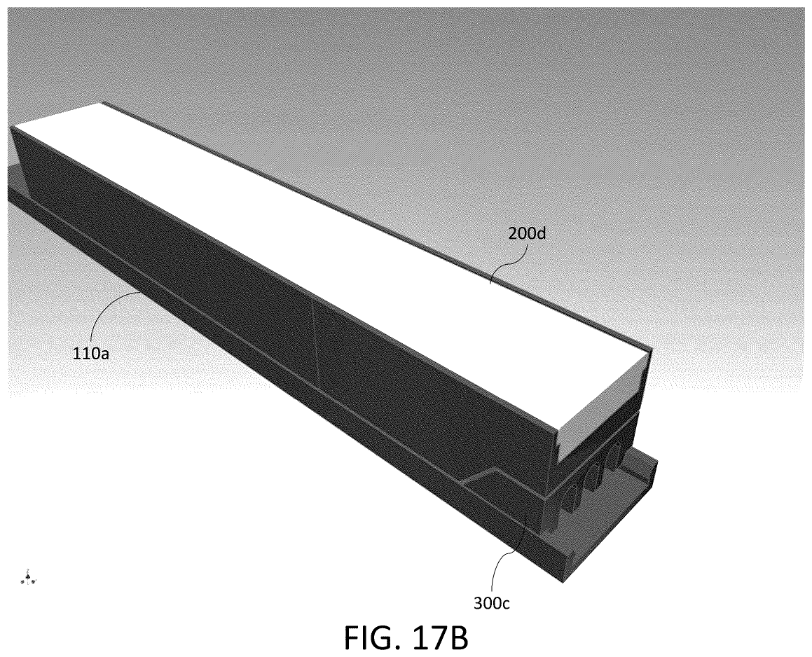

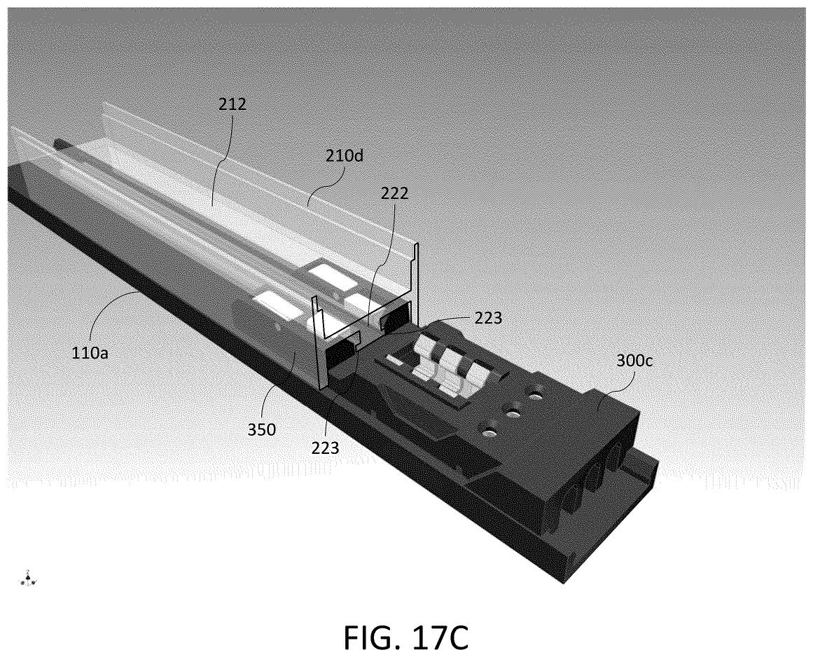

It should be appreciated that the magnetic coupling mechanism and the snap-fit connection are non-limiting examples. In another example, FIGS. 17A-17C show a light bar 200d coupled an input connector 300c via a latch mechanism 350. As shown, the latch mechanism 350 disposed on the input connector 300c may include a pair of levers 351 that, when pushed down, cause a pair of arms 352 to rotate toward each other. FIG. 17C shows the light bar 200d may include a housing 210d with a rail 222 joined to the base 212. The rail 222 may include ridges 223 shaped such that, when the arms 352 are rotated, the arms 352 latch onto the ridges 223, thus securely coupling the light bar 200d to the input connector 300c. In some implementations, the latch mechanism 350 may be spring-loaded.

The end section 230 may further include one or more mechanical registration features to further align the light bar 200a to the input connectors 300a or 300b, the middle connector 400a, or the end connector 500a during assembly. As shown in FIGS. 3G and 3H, the end section 230 may include a pair of mechanical registration features 241 that terminate respective portions of the sidewall 233. Each mechanical registration feature 241 may include a sloped surface 241a and a flat surface 241b. The surfaces 241a and 241b may align with corresponding sloped surfaces 341a and flat surfaces 341b of the input connectors 300a or 300b, or the end connector 500a, and the sloped surfaces 441a and flat surfaces 441b of the middle connector 400a. During installation of the linear lighting system, the mechanical registration features 241 may help the installer align the magnets 244a and 244b and the snap-fit retainers 245 to corresponding magnets and snap-fit connectors in the input connectors 300a or 300b, the middle connector 400a, and the end connector 500a for engagement.

In some implementations, each end section 230 may be formed from plastic (e.g., via injection molding). More generally, the end section 230 may be formed from various metals and/or polymers including, but not limited to, aluminum, steel, zinc, polyethylene, polypropylene, polyvinyl chloride, polystyrene, acrylonitrile butadiene styrene, polyamide, polycarbonate, polymethyl methacrylate, polybutylene terephthalate, polyethylene terephthalate, and the like. In some implementations, the end section 230 may be manufactured as a single part (excluding the magnets 244a and 244b).

The light source 270a may include a printed circuit board (PCB) 271 supporting a plurality of LEDs 272 on one side of the PCB 271 and two sets of electrical connectors 273a disposed on the other side of the PCB 271. The PCB 271 may further incorporate various electrical components (e.g., wiring traces electrically connected to the LEDs 272). In some implementations, the light source 270a may have a length approximately equal or equal to the length of the light bar 200a. Accordingly, the PCB 271 may have a length approximately equal or equal to the combined length of the housing 210a and the end sections 230. For example, the respective ends of the PCB 271 may align with surfaces 238b of each end section 230 as shown in FIGS. 3A-3C. Thus, the PCB 271 may be disposed within the channel 211 of the housing 210a and the respective channels 231 of the end sections 230.

The PCB 271 may be securely coupled to at least the base 212 of the housing 210a. For example, the PCB 271 may be coupled to the base 212 via an adhesive. In another example, the PCB 271 may be coupled to the base 212 via a thermal pad or thermal paste to facilitate the dissipation of heat generated by the LEDs 272 to the housing 210a. In some implementations, the PCB 271 may further be securely coupled to the respective bases 232 of the end sections 230 using, for example, an adhesive, a thermal pad, and/or thermal paste.

In the non-limiting example shown in FIGS. 3E and 3F, the electrical connectors 273a may comprise a pair of electrical contact pads. However, it should be appreciated that the electrical connectors 273a may comprise other types of electrical connectors, such as an electrical spring contact or a pogo-pin connector. Each set of electrical connectors 273 may be disposed across the opening 237 of one end section 230, e.g., to facilitate an electrical connection with corresponding electrical connectors of the input connectors 300a or 300b (e.g., the electrical connectors 372a) or the middle connector 400a (e.g., the electrical connectors 472a). In this manner, the light bar 200a may be electrically coupled to the input connectors 300a or 300b or the middle connector 400a in a tool-free manner.

The placement of the LEDs 272 may influence the spatial and angular distribution of light emission. Moreover, the presence of other electrical components may give rise to dark bands (e.g., portions of the light profile that have a relatively lower intensity) due to the LEDs 272 being spaced relatively far apart. In some implementations, the LED light source 270a may include two rows of LEDs 272 to reduce the appearance of dark bands along different directions (e.g., two orthogonal axes along the plane of the LED light source 270a). In one example, the ratio of the LED pitch to blend depth may be approximately 3.173:5.124. In another example, the ratio of the LED pitch to blend depth may be approximately 3.175:4.125. In yet another example, the ratio of the LED pitch to blend depth may be approximately 3.175:4.425. More generally, the ratio of the LED pitch to blend depth may range from 0.6 to 0.85, including all sub-ranges and values in between. In some implementations, the ratio of the LED pitch to blend depth may range from 0.7 to 0.75, including all sub-ranges and values in between. Here, the LED pitch may be defined as the center-to-center distance between adjacent LEDs 272 disposed along the same row or, alternatively, the shortest center-to-center distance between neighboring LEDs 272. The blend depth may be defined as the distance from the light emitting surface of the LEDs 272 to the surface 281b of the optic 280a.

The LEDs 272 may comprise individual color LEDs, 2-in-1 LEDs where the warm and cool channels are controlled individually, and/or 4-in-1 RGBW LEDs. In some implementations, the LEDs 272 may include full spectrum, tunable LEDs (e.g., the LEDs may emit light across the visible spectrum and/or emit light with varying correlate color temperatures). The linear lighting system may provide three or more channels of control and independently controlled circuits. In one non-limiting example, the light source 270a may include one type of LEDs 272 configured to emit light with one color (e.g., one CCT). In another non-limiting example, the light source 270a may include two or more types of LEDs 272 configured to emit light with two or more colors (e.g., two or more CCTs). In implementations where the light source 270a includes two or more types of LEDs 272, the color of the light output may be adjusted using, for example, a LED controller (see, for example, the LED controller integrated into the input connector 300b).

The optic 280a may have a length approximately equal or equal to the length of the light bar 200a, i.e., the combined length of the housing 210a and the end sections 230. Similar to the light source 270a, the respective ends of the optic 280a may align with surfaces 238b of each end section 230 as shown in FIGS. 3A-3C. In some implementations, the ends of the light source 270a and the optic 280a and the surface 238b of the end section 230 may be flat. This may allow the light bar 200a to readily abut other light bars in the linear lighting system in such a way that light output is continuous when transitioning from one light bar to another light bar. Thus, the optic 280a may be disposed within the channel 211 of the housing 210a and the respective channels 231 of the end sections 230.

The optic 280a may be securely coupled to the sidewalls 213 of the housing 210a and the respective sidewalls 233 of the end sections 230 (see FIG. 3D). For example, the optic 280a may include integrated snap-fit connectors 284 disposed on the front and rear sides of the optic 280a to engage with corresponding snap-fit connectors 218 on the housing 210a and snap-fit connectors 246 on each end section 230. As shown, each snap-fit connector 284 may include rails 282a and 282b separated by a channel 283. When the snap-fit connector 284 is engaged with the snap-fit connector 218 of the housing 210a, the rails 282a may be disposed within the channels 215a and 215b, respectively, and the channel 283 may receive the rail 214. Similarly, when the snap-fit connector 284 is engaged with the snap-fit connector 246 of each end section 230, the rails 282a may be disposed within the channels 235a and 235b, respectively, and the channel 283 may receive the rail 234.

In some implementations, installation of the optic 280a onto the housing 210a and/or the end sections 230 may be facilitated, in part, by forming the optic 280a from a flexible and/or mechanically compliant material. For example, the optic 280a may be formed from silicone. More generally, the optic 280a may be formed from a polymer and/or a glass including, but not limited to, silicone, polycarbonate, acrylic polymer, cyclo olefin polymer (Zeonex), polystyrene, silicate-based glasses, and any combinations of the foregoing. In some implementations, the optic 280a may have a constant cross-section across its length. This, in turn, may allow the optic 280a to be manufactured via an extrusion process.

The optic 280a may be positioned below the light source 270a to receive and redirect light emitted by the light source 270a. As shown in FIG. 3D, the optic 280a may be positioned such that light emitted by the light source 270a passes through a surface 281a followed by a surface 281b of the optic 280a. Thus, the interaction of the emitted light with the surfaces 281a and 281b may determine the spatial distribution and the angular distribution of the light output provided by the light bar 200a. In some implementations, the optic 280a may include integrated optical reflectors to increase light throughput through the optic 280a, e.g., by reducing the amount of light that may be scattered back towards the light source 270a. In one non-limiting example, FIG. 3D shows the optic 280a may include a pair of reflectors 285 disposed along the sides of the optic 280a where the snap-fit connectors 284 are located. In some implementations, the reflectors 285 may be formed from opaque white silicone that is coextruded with translucent silicone forming the remaining portion of the optic 280a.

In one non-limiting example, the optic 280a may provide light with a Lambertian distribution (e.g., the light bar 200a provides a diffuse light output to illuminate an environment). For instance, FIG. 3D shows the surface 281a may be curved and the surface 281b may be flat. Additionally, the surface 281a may be patterned, e.g., to diffusely scatter light and thus provide light output with a smoother angular distribution and a smoother spatial distribution. Specifically, FIG. 3D shows the surface 281a may be patterned with triangular grooves that extend longitudinally along the length of the optic 280a.

It should be appreciated that the foregoing optic 280a is a non-limiting example. More generally, the light bar 200a may include various optics that provide different distributions of light to accommodate different lighting applications including, but not limited to, ambient lighting, task lighting, accent lighting, and the like. In another non-limiting example, the optic 280a may provide a full blend lighting profile at a relatively shallow blend depth due, in part, to the optic 280a including a built-in reflector (e.g., the reflectors 285). Here, a full blend lighting profile refers to an optic 280a that obscures the visibility of individual LEDs 272 when viewing the light source 270a through the optic 280a under various lighting conditions. Instead, the optic 280a may appear as an opaque, white luminous surface when the light source 270a emits light. In yet another non-limiting example, the optic 280a may be a prismatic lens. In yet another example, the optic 280a may be a solite lens. More generally, one or both of the surfaces 281a and 281b may be flat or curved (e.g., a convex curve, a concave curve). One or both of the surfaces 281a and 281b may be patterned (e.g., with a plurality of triangular grooves).

The bracket 250 may mechanically couple the light bar 200a to the mounting track 110a. FIG. 3J shows the bracket 250 may include a base 251 and a pair of rails 252 joined to the base 251. As described above, the bracket 250 may be slidably coupled to the housing 210a by inserting the rails 252 into corresponding openings 217 formed on the housing 210a. FIG. 3J further shows the bracket 250 may include multiple tabs 253a and 253b joined to the base 251. The tabs 253a may be shaped to secure the bracket 250 and, by extension, the light bar 200a to the retaining walls 112 of the mounting track 110a. The tabs 253b may further facilitate alignment of the bracket 250 to the channel 111 of the mounting track 110a.

In some implementations, the tabs 253a may be sufficiently compliant such that the bracket 250 may be readily pressed onto and secured to the mounting track 110a in a similar manner as a snap-fit connection. For example, each tab 253a may readily bend when physically contacting the sloped portion of the retaining wall 112 of the mounting track 110a. As the bracket 250 is pushed further toward the base 113 of the mounting track 110a, the tab 253a may pass the sloped portion of the retaining wall 112 and bend back to its original shape, thus securing the bracket 250 to the mounting track 110a.

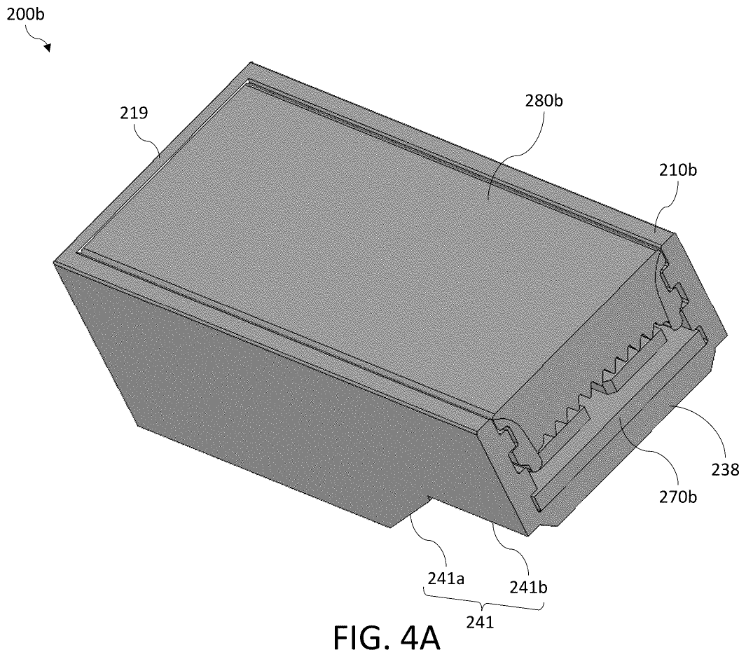

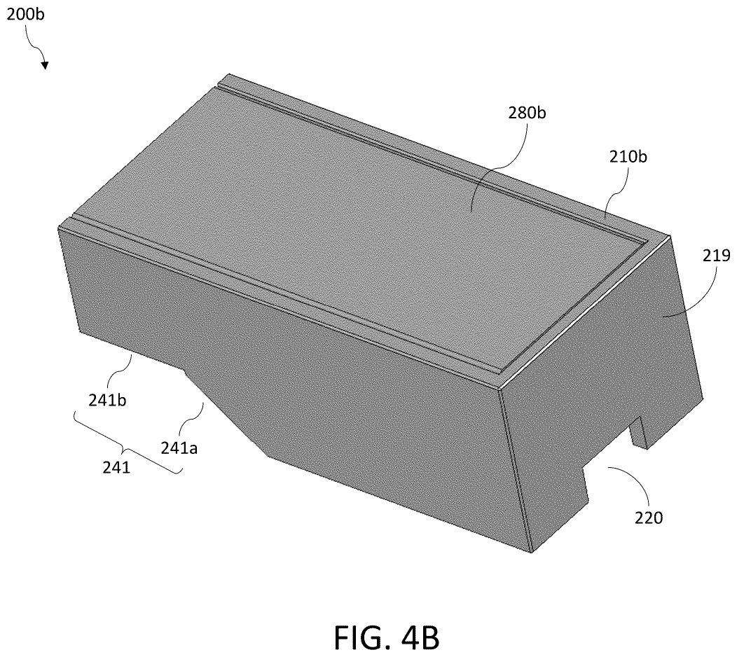

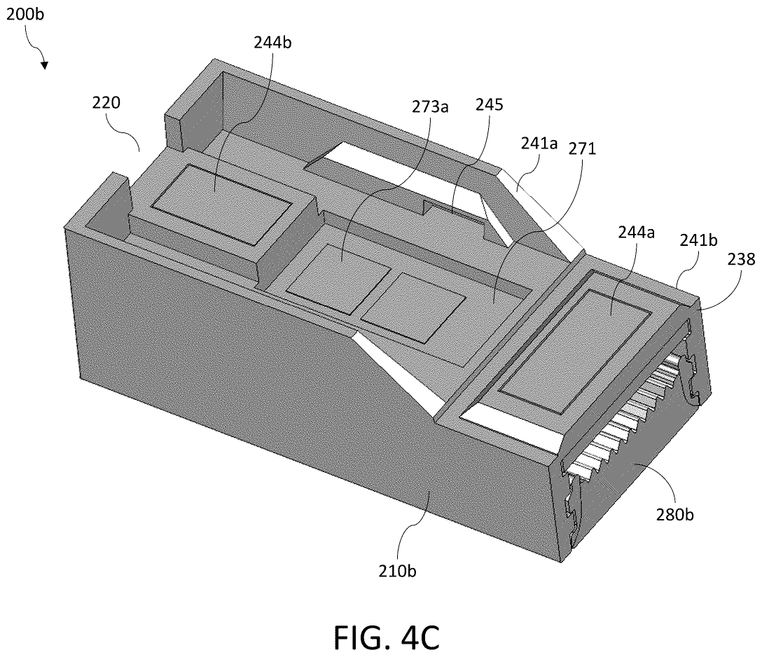

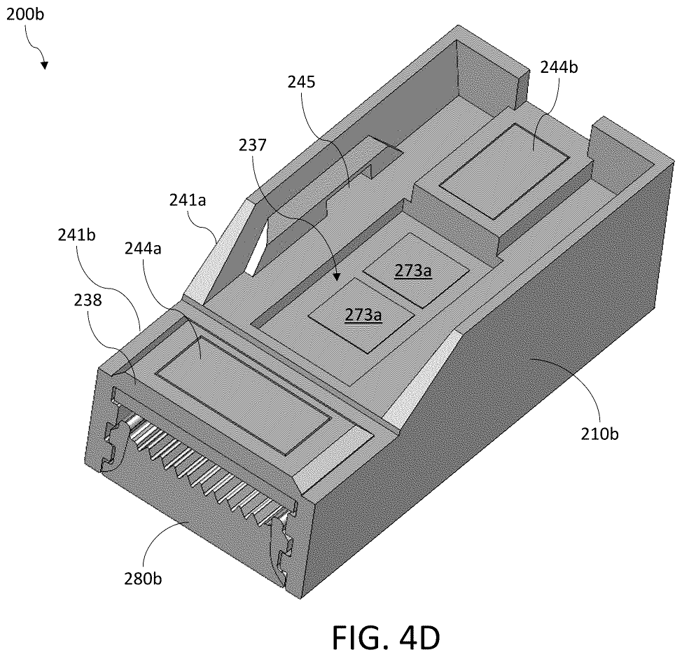

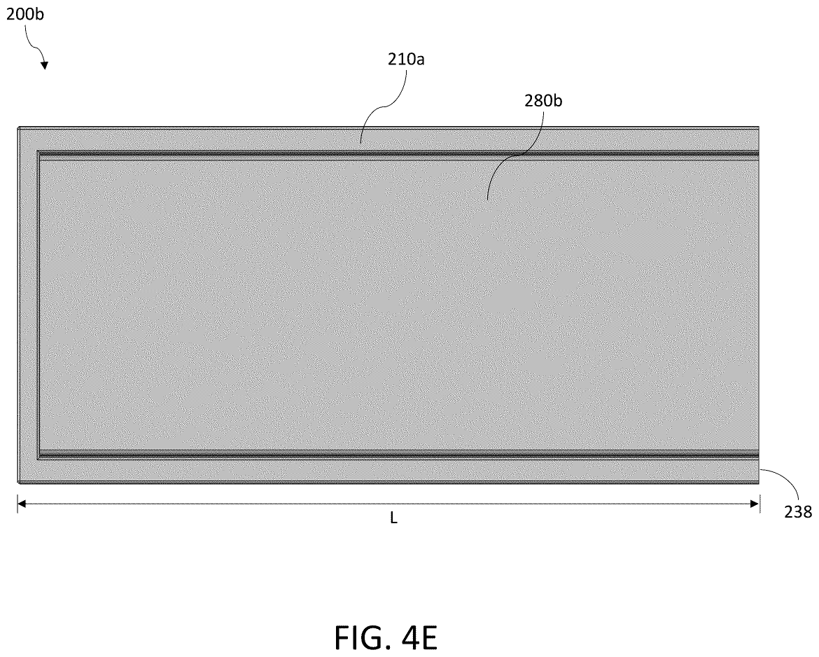

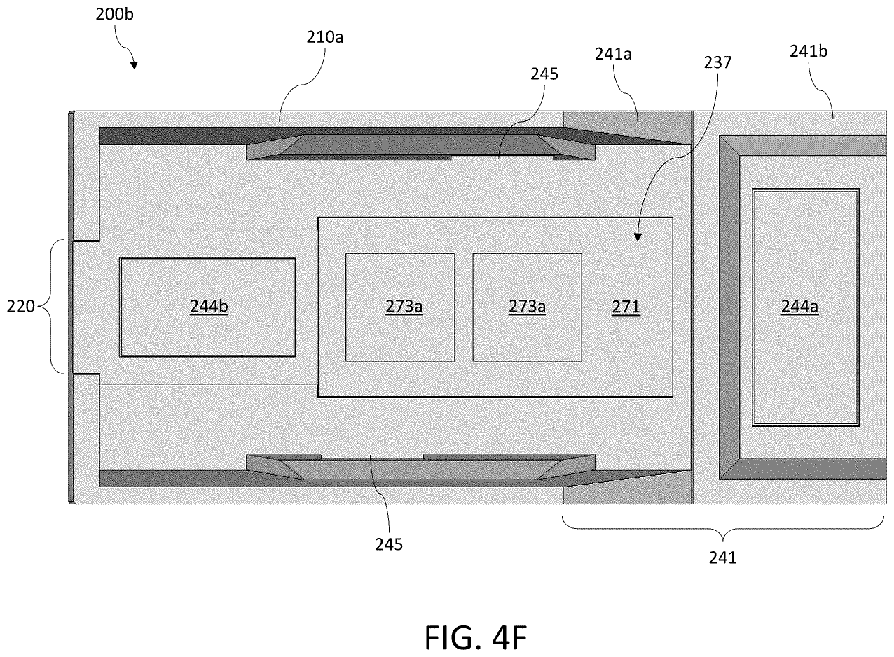

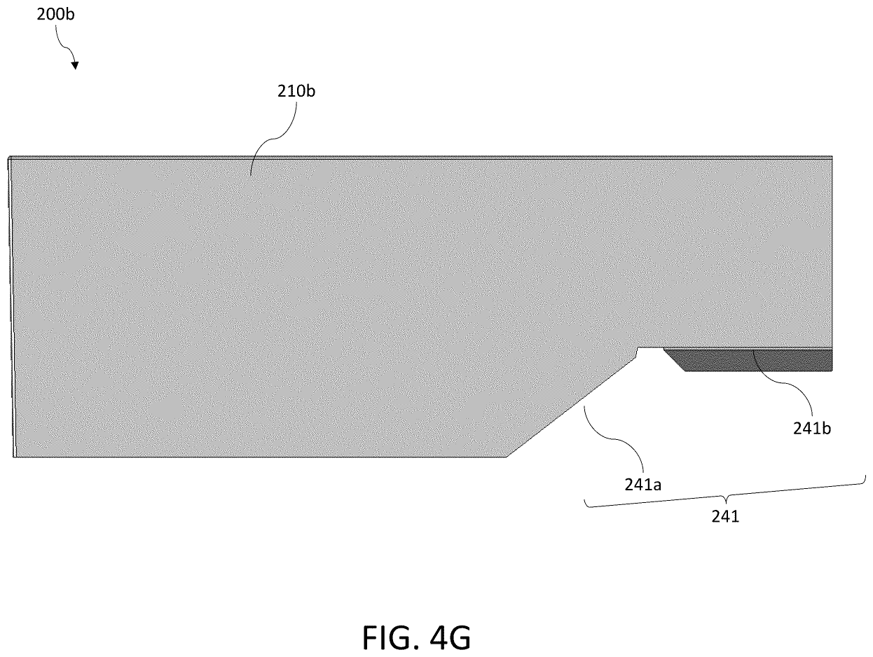

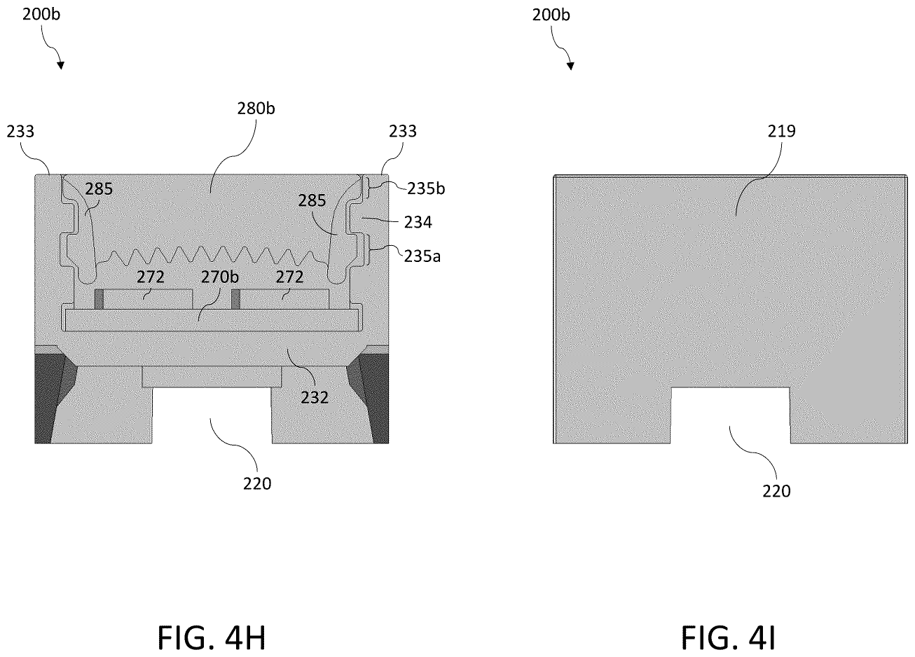

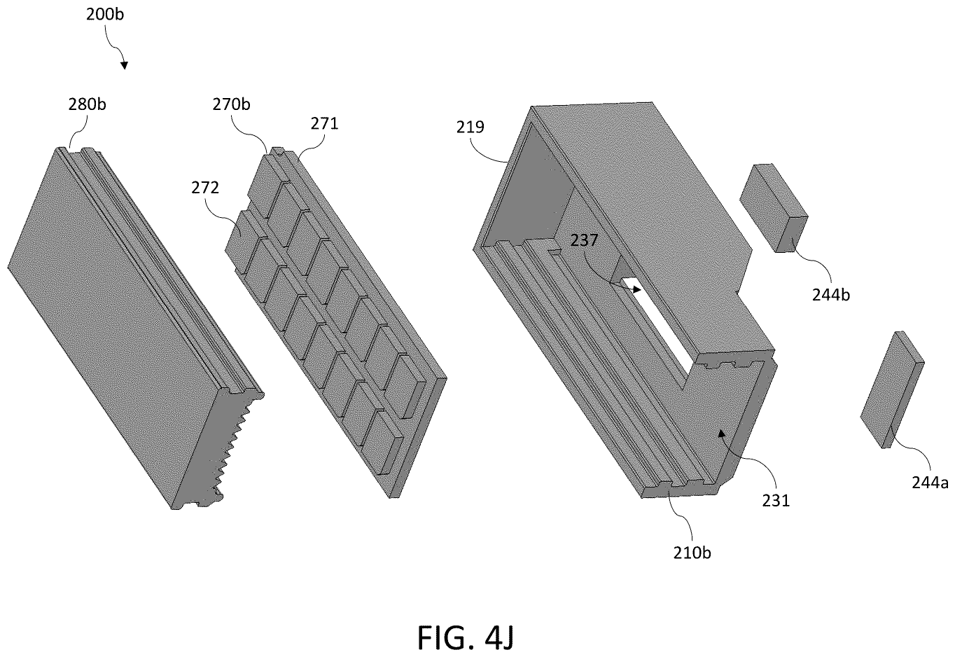

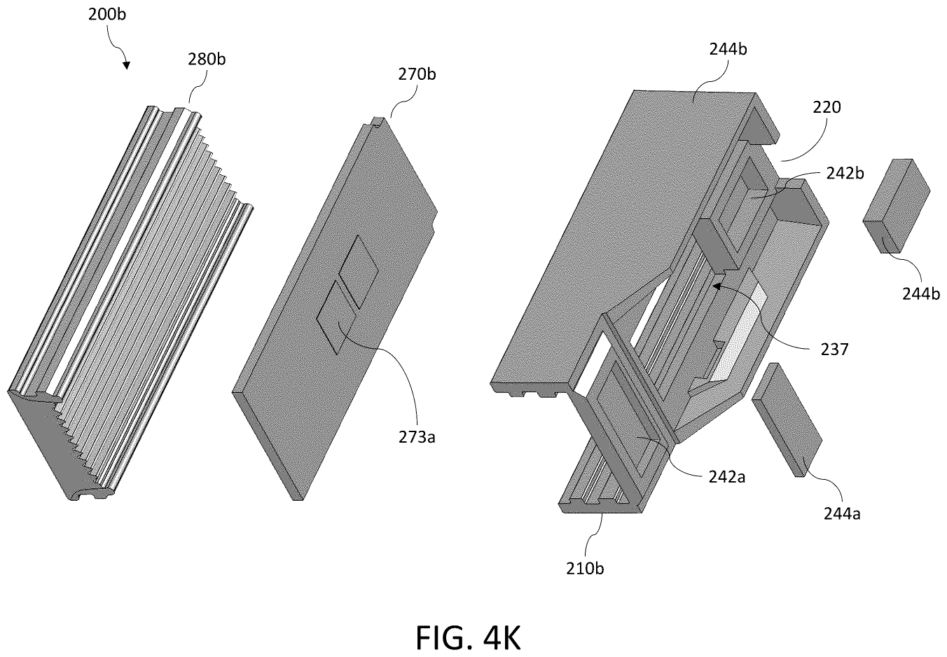

FIGS. 4A-4K show several views of the light bar 200b. In this example, the light bar 200b may be installed at the respective ends of a run of light bars forming the linear lighting system, e.g., only at the beginning of the run, or at the end of the run. As a result, the light bar 200b may only be connected to the input connector 300a or the middle connector 400a. The light bar 200b may have a length, L, equal to about 1 inch. As shown, the light bar 200b may include a housing 210b, a light source 270b mechanically coupled to the housing 210b, and an optic 280b mechanically coupled to the housing 210b. The light bar 200b may incorporate one or more of the same components and/or features from the light bar 200a. For brevity, repeated discussion of these components and/or features are not provided below unless indicated otherwise.

In this example, the housing 210b may incorporate several of the same features as the end section 230 in the light bar 200a. For example, the housing 210b may include a base 232 and a pair of sidewalls 233 joined to the base 232 to define a channel 231 to contain the light source 270b and the optic 280b. Each sidewall 233 may include a snap-fit connector 246 to securely couple the optic 280b to the housing 210b. The housing 210b may further include an opening 237 to provide access to the electrical connectors 273a of the light source 270b.

The housing 210b may also provide several coupling mechanisms to mechanically couple the light bar 200b to the input connectors 300a or 300b, the middle connector 400a, and the end connector 500a. For example, the housing 210b may include magnet holders 242a and 242b to support corresponding magnets 244a and 244b as shown in FIG. 4K. In another example, the housing 210b may include a pair of snap-fit retainers 245. The housing 210b may further include the mechanical registration feature 241 to facilitate alignment of the light bar 200b to the input connector 300a or the middle connector 400a for engagement.

In this example, only one end of the light bar 200b may be configured to abut another light bar. For example, FIGS. 4C and 4D show one end of the housing 210b may include a surface 238 to abut another light bar. As shown, corresponding ends of the light source 270b and the optic 280b may align with the surface 238. On the other end of the housing 210b, the housing 210b may include an end cap 219 joined to the base 232 and the sidewalls 233. The end cap 219 may correspond to one end of the linear lighting system (e.g., the end of the run of light bars). As shown in FIGS. 4B and 4C, the housing 210b may further include a notch 220 to accommodate, for example, the magnet holder 342b of the input connector 300a, or the magnet holder 442b of the middle connector 400a.

The light source 270b may share the same or similar features as the light source 270a with the difference being the light source 270b is shorter than the light source 270a. Similarly, the optic 280b may share the same or similar features as the optic 280a with the difference being the optic 280b is shorter than the optic 280a. As described above, the light source 270b and the optic 280b may each have a length that is approximately equal or equal to the length of the light bar 200b (e.g., 1 inch).

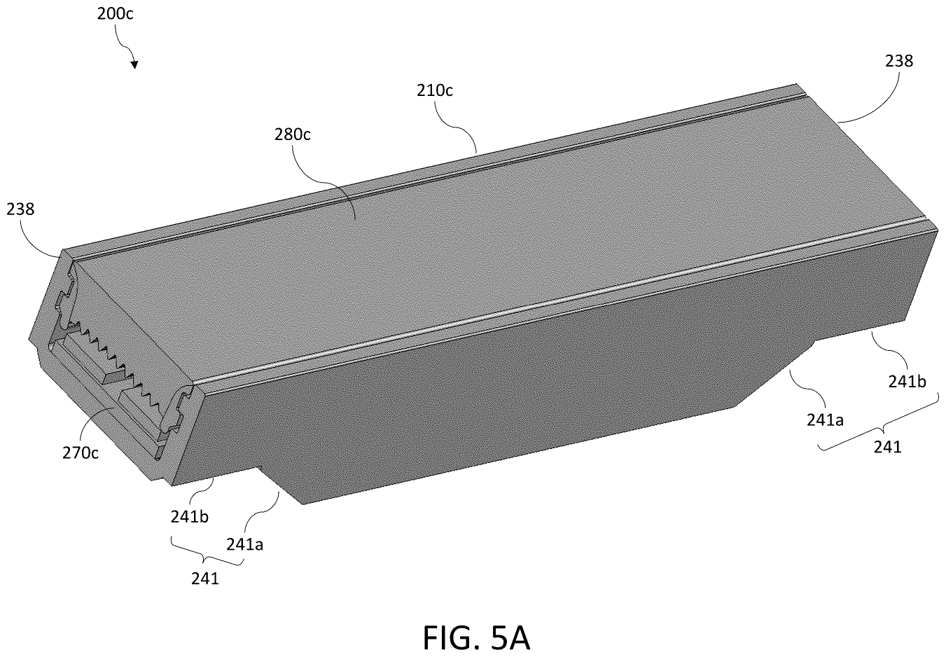

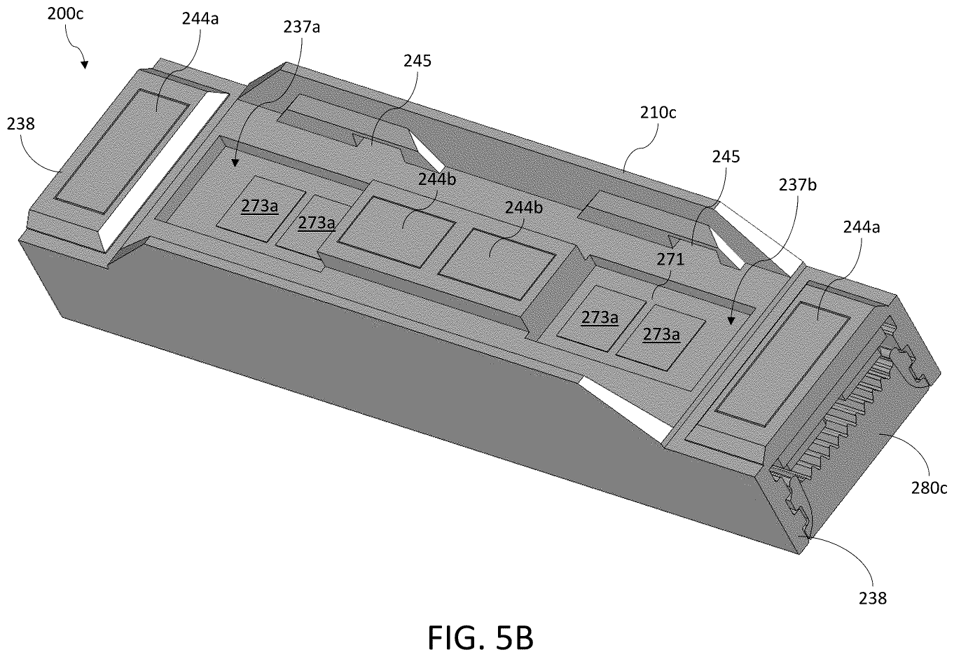

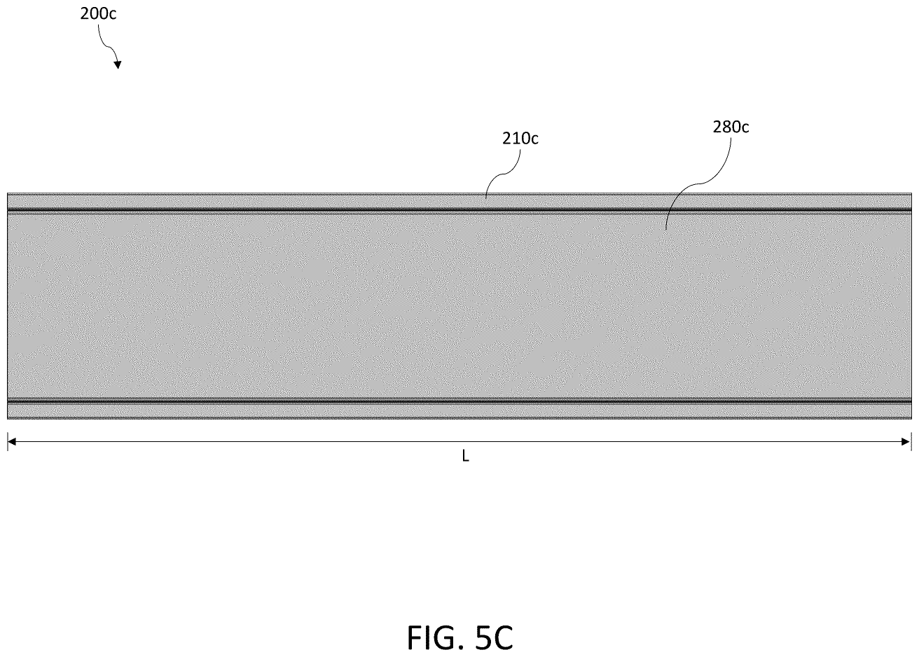

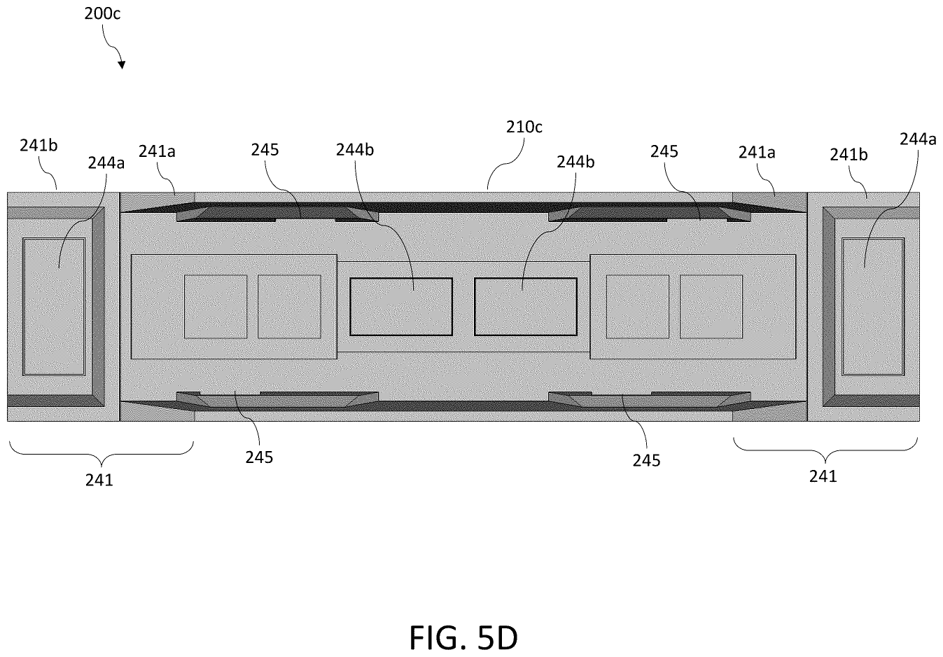

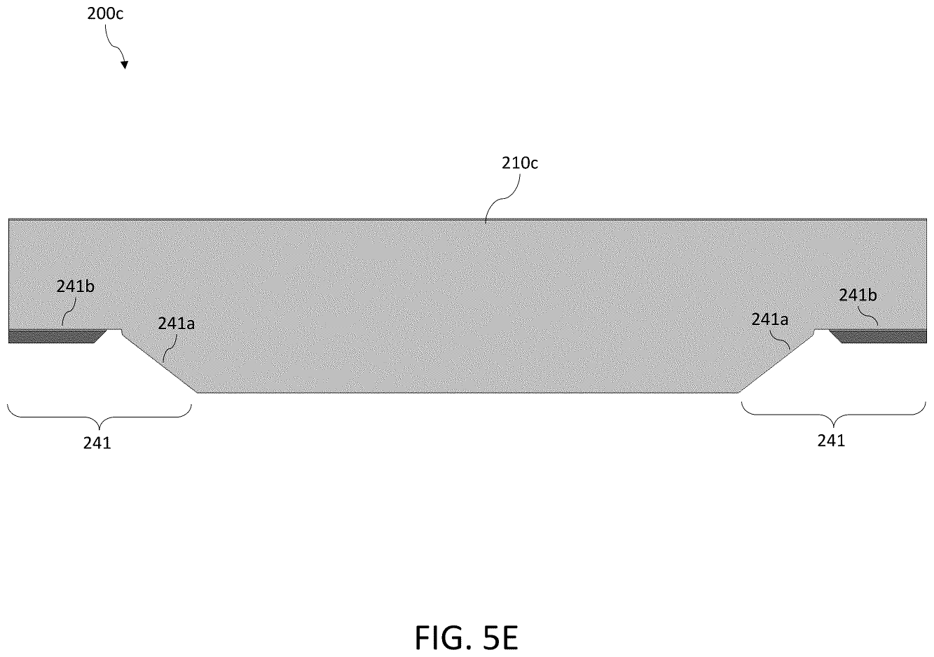

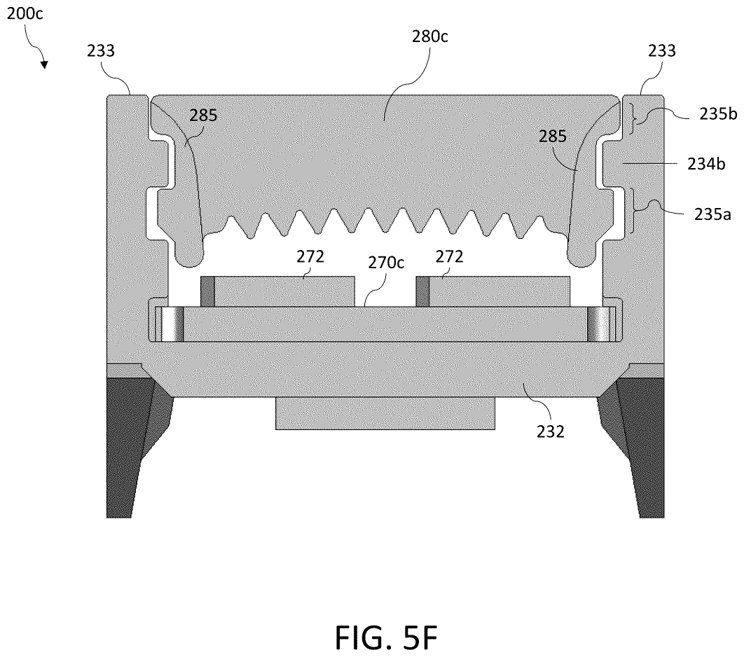

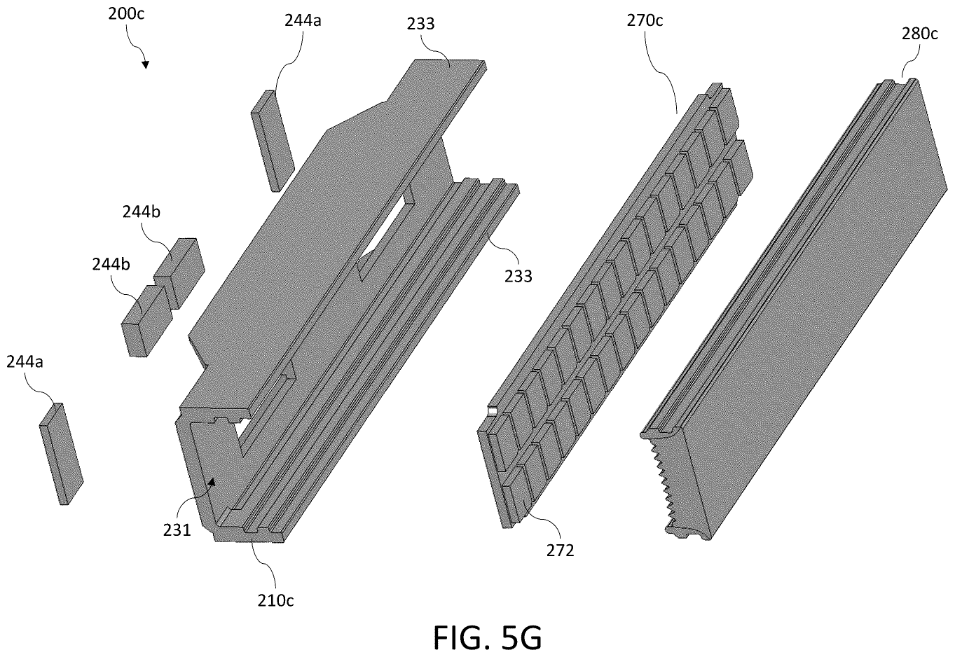

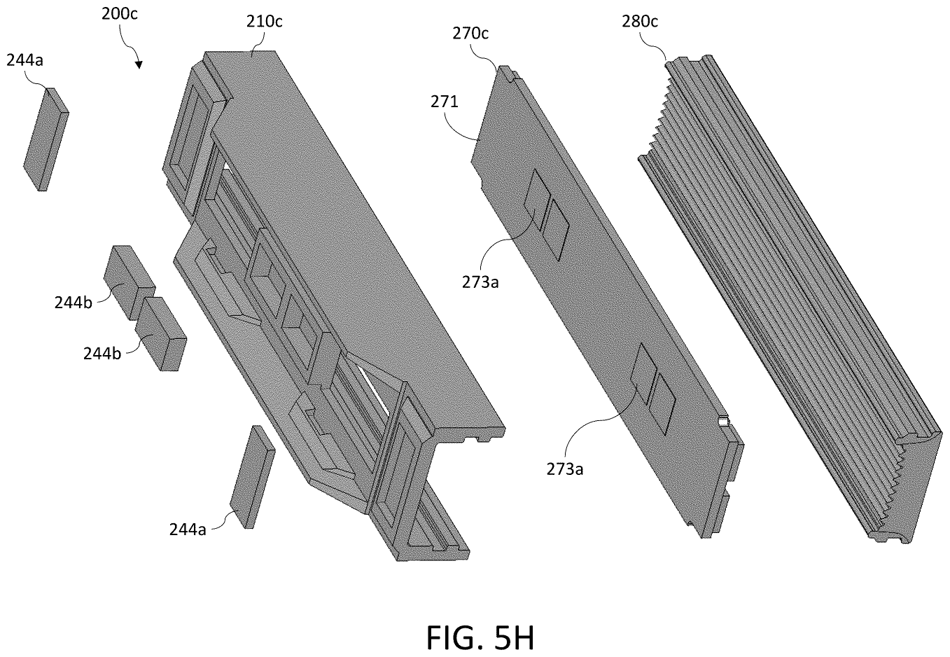

FIGS. 5A-5H show several views of the light bar 200c. In this example, the light bar 200c may be installed at any location along the run of light bars forming the linear lighting system, e.g., at the beginning of the run, in the middle of the run, or at the end of the run. Moreover, the light bar 200c may be mechanically and electrically connected to the input connectors 300a or 300b, the middle connector 400a, or the end connector 500a. The light bar 200c may have a length, L, equal to about 2 inches. As shown, the light bar 200c may include a housing 210c, a light source 270c mechanically coupled to the housing 210c, and an optic 280c mechanically coupled to the housing 210c. The light bar 200c may incorporate one or more of the same components and/or features from the light bars 200a or 200b. For brevity, repeated discussion of these components and/or features are not provided below unless indicated otherwise.

In this example, the housing 210c may incorporate several of the same features as the end section 230 in the light bar 200a. In some implementations, the housing 210c may have a design that effectively combines two end sections 230 joined together via their respective surfaces 238a. For example, the housing 210c may include a base 232 and a pair of sidewalls 233 joined to the base 232 to define a channel 231 to contain the light source 270c and the optic 280c. Each sidewall 233 may include a snap-fit connector 246 to securely couple the optic 280c to the housing 210c. The housing 210c may further include a pair of openings 237 to provide access to the electrical connectors 273a of the light source 270c.

The housing 210c may also provide several coupling mechanisms to mechanically couple the light bar 200c to the input connectors 300a or 300b, the middle connector 400a, and/or the end connector 500a. For example, the housing 210c may include two pairs of magnet holders 242a and 242b to support corresponding pairs of magnets 244a and 244b as shown in FIG. 5H. In another example, the housing 210c may include two pairs of snap-fit retainers 245. The housing 210c may further include a pair of mechanical registration features 241 disposed at opposing ends of the housing 210c to facilitate alignment of the light bar 200c to the input connector 300a or 300b, the middle connector 400a, or the end connector 500a for engagement.

The light source 270c may share the same or similar features as the light source 270a with the difference being the light source 270c is shorter than the light source 270a. Similarly, the optic 280c may share the same or similar features as the optic 280a with the difference being the optic 280c is shorter than the optic 280a. As described above, the light source 270c and the optic 280c may each have a length that is approximately equal or equal to the length of the light bar 200c (e.g., 2 inches).

In some implementations, the light bars disclosed herein may be cuttable without disassembly, e.g., to provide a light bar with a custom length. Referring to the example light bar 200a described above, the housing 210a, the light source 270a, and the optic 280a may be cut, e.g., via a cutting device, such as a saw. An accessory may thereafter be attached to the cut end of the housing 210a to facilitate attachment of the cut end to the mounting track 110a. For example, the accessory may combine the features of the end section 230 and the bracket 250, such as by including tabs 239 with fastener openings 240 that align with the openings 217 of the housing 210a to receive fasteners 243 and tabs 253a and 253b to couple the accessory directly to the mounting track 110a. The accessory may not provide any electrical connections. In this manner, the accessory may provide a similar function to the end cover 500a in that it would only be used for the last light bar in a run. In other words, the process of cutting the light bar to a custom length may only be applied to the last light bar in the run.

In some implementations, the light bars disclosed herein may include a breakable end cap for a power feed (e.g., the input connectors 300a or 300b). The breakable end cap may provide a way for a linear lighting system to reach a particular point in the environment from two directions (e.g. two linear feeds that start at opposite ends). The breakable starter (feed) may allow a linear lighting system to extend along two directions from a single entry for the driver. In this manner, the light bars may each have fewer parts and/or provide greater ease of handling.

### 1.2 Examples of Input Connectors

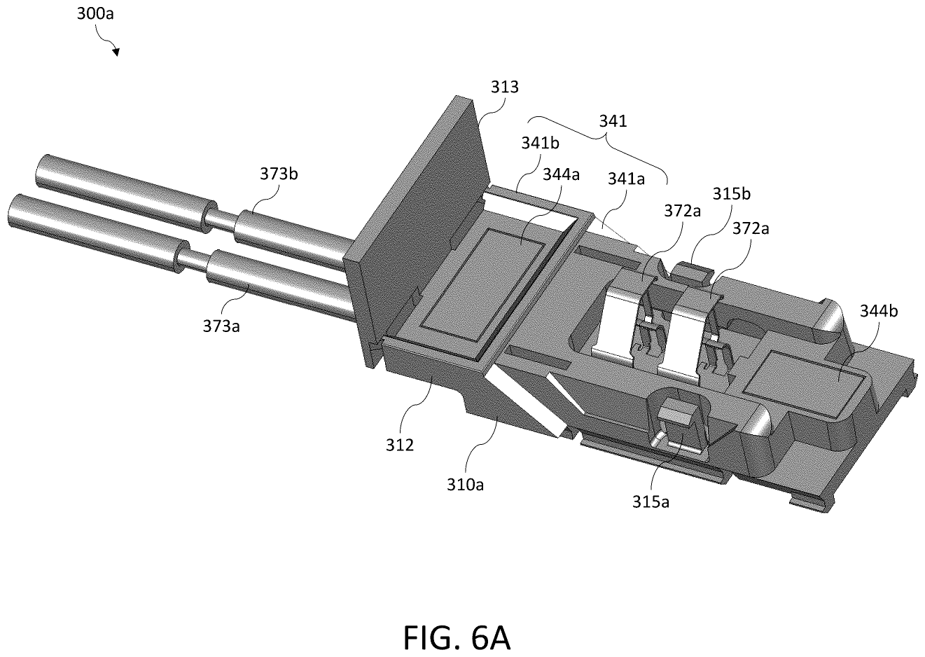

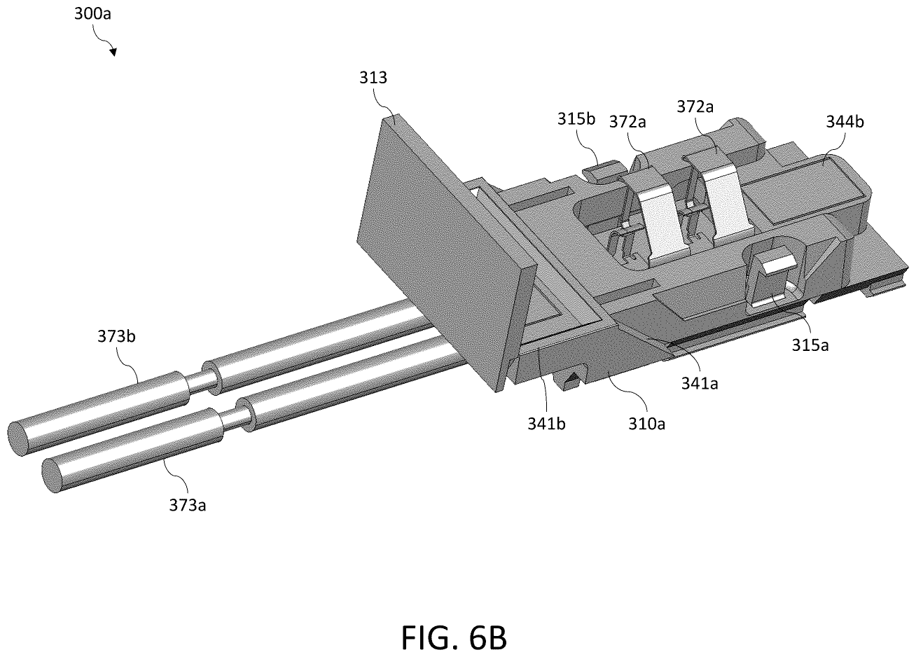

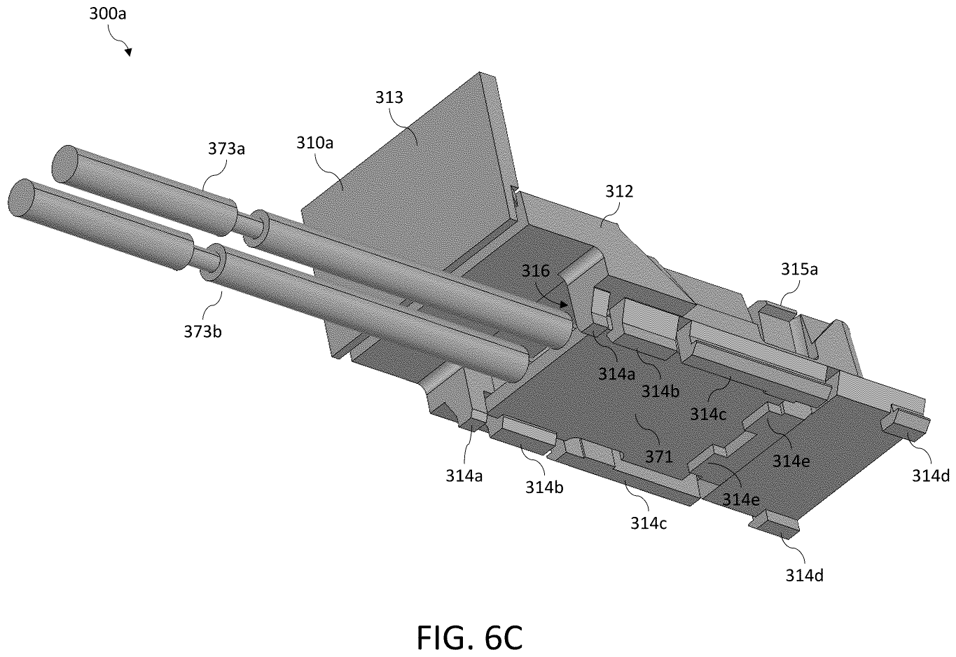

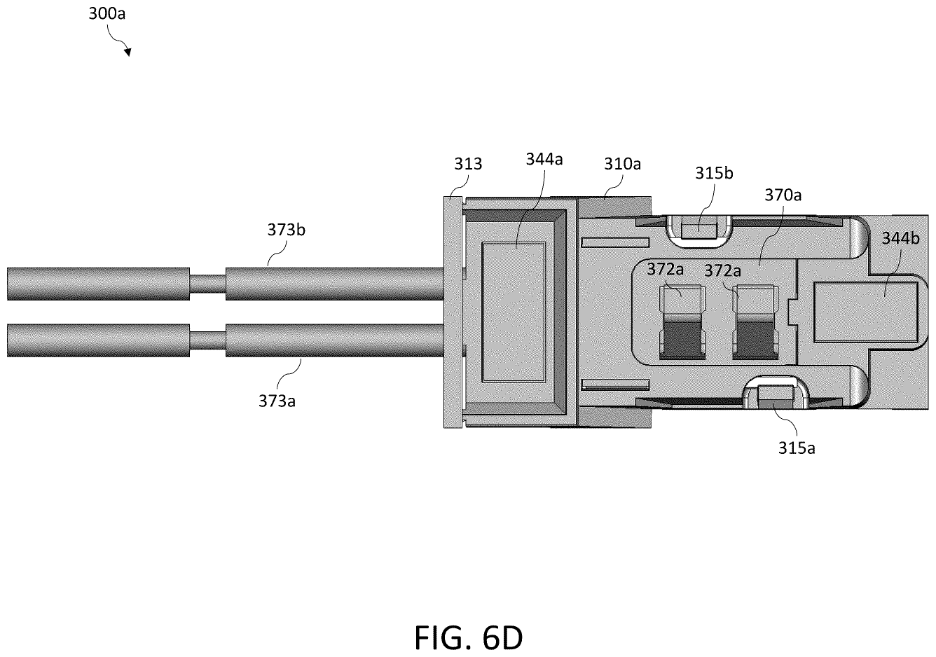

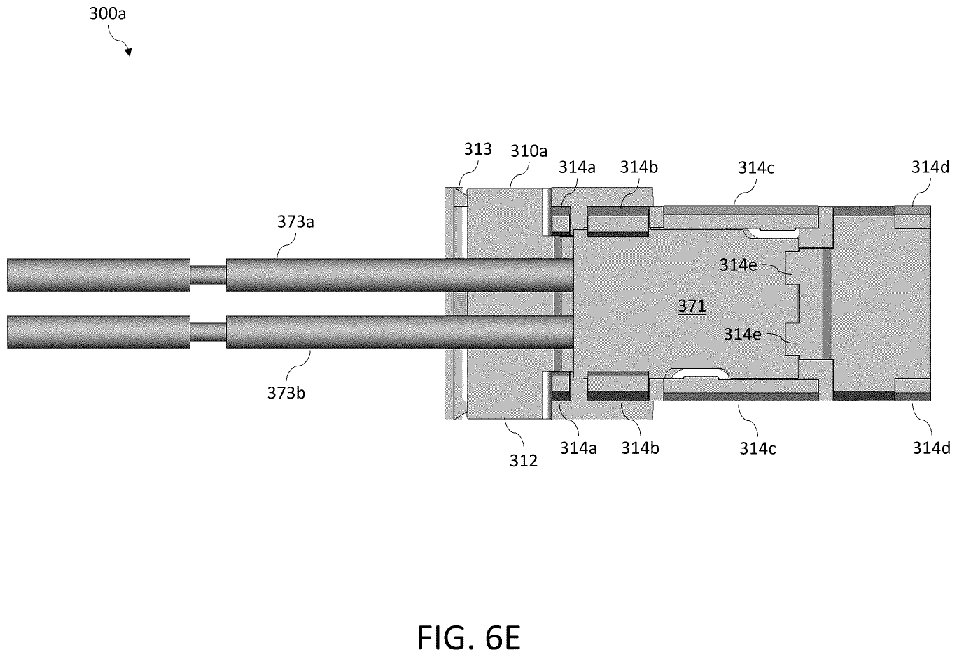

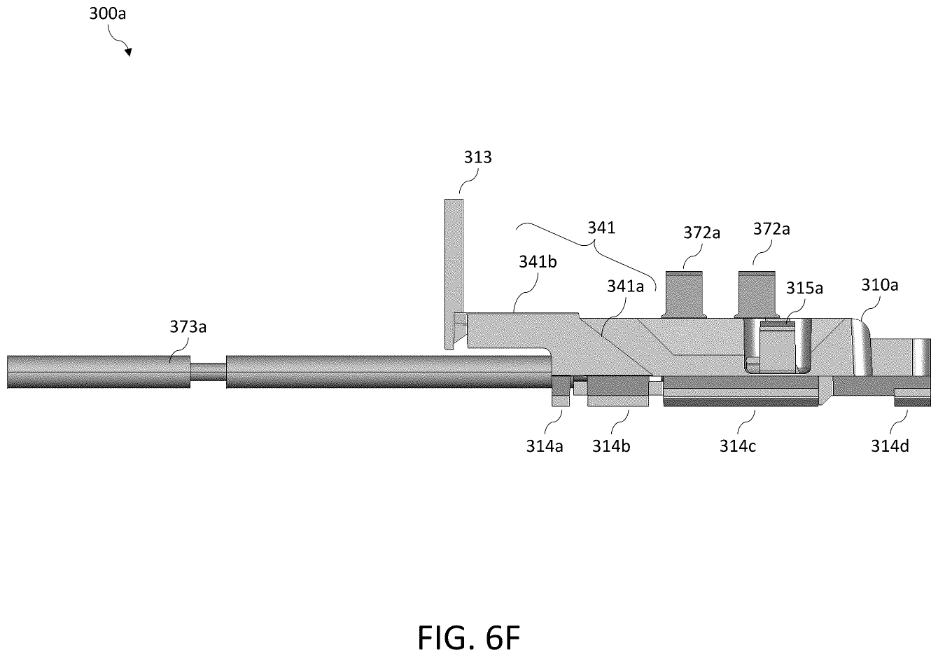

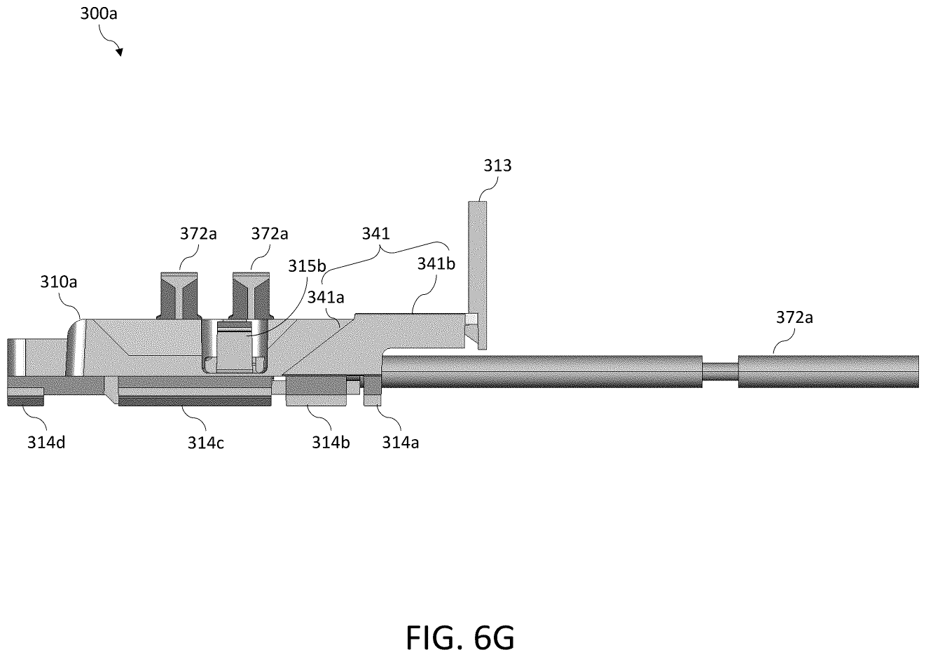

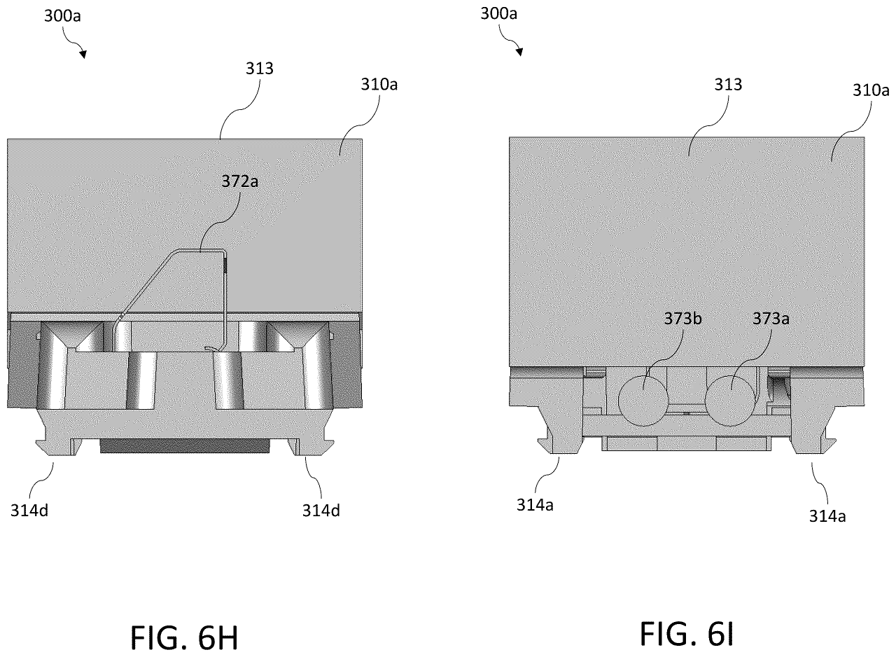

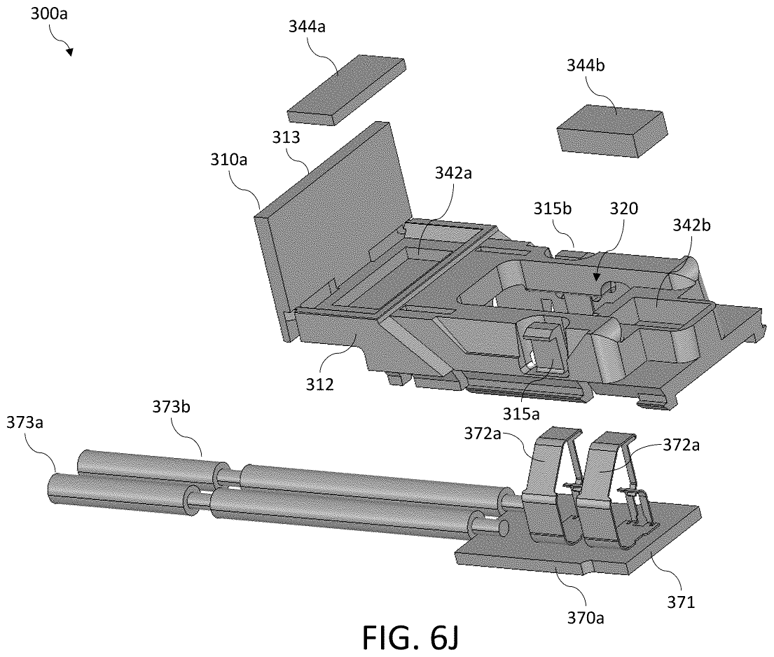

FIGS. 6A-6J show several views of the input connector 300a. The input connector 300a (also referred to as a “power feed 300a”) may provide an electrical connection between the LED light sources 270a-270c of the light bars 200a-200c and wires carrying electrical power and/or control signals. Thus, in some implementations, the input connector 300a may be installed at the beginning of a run of light bars forming the linear lighting system. However, it should be appreciated that, in some implementations, the input connector 300a may be located along any portion of the run of light bars. For example, the input connector 300a may be located in the middle of the run and may supply electrical power and/or control signals to a sub-run of light bars.

As shown, the input connector 300a may include a housing 310a and input electronics 370a mechanically coupled to the housing 310a. The housing 310a may provide features to mechanically align and couple the input connector 300a to a light bar in the lighting system (e.g., one of the light bars 200a-200c) and to the mounting track 110a. The input electronics 370a may electrically couple to one or more wires (e.g., the wires 373a and 373b) and electrical connectors 372a to electrically connect the input connector 300a to the light bars 200a-200c (e.g., via the electrical connectors 273a of the light sources 270a-270c). Each of the foregoing components of the input connector 300a are described in further detail below.

The housing 310a may include a frame 312 and an end cap 313 joined to the frame 312. The end cap 313 may correspond to one end of the linear lighting system (e.g., the beginning of the run of light bars). For example, the end cap 313 may be aligned with the surface 238b of the end section 230 in the light bar 200a and, by extension, the respective ends of the light source 270a and the optic 280a. In some implementations, the end cap 313 may abut the surface 238b and the ends of the light source 270a and the optic 280a. The end cap 313 may conform in shape and/or dimensions to the end of the light bar 200a. For example, FIG. 3D shows one end of the light bar 200a where the surface 281b of the optic 280a and the exterior sides of the sidewalls 233 together form a rectangular shape. Accordingly, FIGS. 6H and 6I show the end cap 313 may have a rectangular shape. In some implementations where the linear lighting system is installed into a ceiling, the end cap 313 may be shaped such that no portion of the end cap 313 extends below a plane defined by the surface 281b of the optic 280a, in front of a plane defined by the exterior front surfaces of the sidewalls 213 and 233 of the light bar 200a, and/or behind a plane defined by the exterior rear surfaces of the sidewalls 213 and 233 of the light bar 200a.

In some implementations, the end cap 313 may be removable from the frame 312. For example, the end cap 313 may be readily removed from the frame 312, e.g., by bending and/or twisting the end cap 313. Removing the end cap 313 may allow the input connector 300a to be installed in the middle of a run of light bars. For example, the input connector 300a may be mechanically and electrically coupled to a first light bar 200a. A second light bar 200a may be installed and disposed adjacent to the first light bar 200a such that one end of the second light bar 200a abuts one end of the first light bar 200a, thus providing continuity in the light output from both light bars 200a. However, the second light bar 200a may receive electrical power and/or control signals from another input connector 300a. Said another way, the first and second light bars 200a may belong to different sub-runs.

The housing 310a may include various features to mechanically couple the input connector 300a to a light bar (e.g., the light bars 200a-200c). For example, the housing 310a may support magnets 344a and 344b via respective magnet holders 342a and 342b. The magnets 344a and 344b, as described above, may form part of a magnetic coupling mechanism with the light bars 200a-200c. The magnets 344a and 344b may be shaped and/or dimensioned to be the same as the magnets 244a and 244b of the light bars 200a-200c, respectively. In some implementations, the magnets 344a and 344b may be securely coupled to the magnet holders 342a and 342b, respectively, via an adhesive, a press-fit connection, or the like.

In another example, the housing 310a may include one or more snap-fit connectors, e.g., to engage with corresponding snap-fit retainers on the light bar. For example, FIGS. 6A and 6B show the housing 310a may include a pair of snap-fit connectors 315a and 315b. The snap-fit connectors 315a and 315b may be arranged to engage with snap-fit retainers 245 disposed on, for example, the end section 230 of the light bar 200a, the housing 210b of the light bar 200b, or the housing 210c of the light bar 200c. As described above, the combination of the magnetic coupling mechanism and the snap-fit connection mechanism supported by the input connector 300a may securely couple the input connector 300a to the light bar.

In yet another example, the housing 310a may include a mechanical registration feature 341 to facilitate alignment with a light bar during assembly. As shown in FIG. 6A, the mechanical registration feature 341 may include a sloped surface 341a and a flat surface 341b. When a light bar is coupled to the input connector 300a, the sloped surface 341a and the flat surface 341b may align with a sloped surface 241a and a flat surface 241b, respectively, of a mechanical registration feature 241 on the light bars 200a-200c.

The housing 310a may further provide features to mechanically couple the input connector 300a to the mounting track 110a. For example, FIG. 6C shows the housing 310a may include multiple tabs 314a, 314c, and 314d joined to the frame 312. The tabs 314a, 314c, and 314d may be shaped to secure the input connector 300a to the retaining walls 112 of the mounting track 110a. In some implementations, the tabs 314a, 314c, and 314d may be sufficiently compliant such that the input connector 300a may be readily pressed onto and secured to the mounting track 110a in a similar manner as a snap-fit connection. For example, each tab 314a, 314c, and 314d may readily bend when physically contacting the sloped portion of the retaining wall 112 of the mounting track 110a. As the input connector 300a is pushed further toward the base 113 of the mounting track 110a, the tabs 314a, 314c, and 314d may pass the sloped portion of the retaining wall 112 and bend back to its original shape, thus securing the input connector 300a to the mounting track 110a.

As shown in FIG. 6J, the housing 310a may further include an opening 320 disposed between the magnet holders 342a and 342b. The opening 320 may allow the electrical connectors 372a of the input electronics 370a to pass through so that the electrical connectors 372a can electrically connect to the electrical connectors of the light bar (e.g., the electrical contact pads 273a of the light bar 200a). For example, FIGS. 6A and 6B show the electrical connectors 372a disposed through the opening 320.

The housing 310a may further provide support for the input electronics 370a. For example, FIG. 6C further shows the housing 310a may include tabs 314b and 314e that together with the frame 312 defines a slot 316. The slot 316 may receive a PCB 371 of the input electronics 370a. As shown, the tabs 314b and 314e may support one side of the PCB 371 and the frame 312 may support the other side of the PCB 371.

The housing 310a may be formed from various metals and/or polymers including, but not limited to, aluminum, steel, zinc, polyethylene, polypropylene, polyvinyl chloride, polystyrene, acrylonitrile butadiene styrene, polyamide, polycarbonate, polymethyl methacrylate, polybutylene terephthalate, polyethylene terephthalate, and the like. In some implementations, the housing 310a may be manufactured as a single part.

The input electronics 370a may include the aforementioned PCB 371. The PCB 371 may connect to one or more wires supplying electrical power and/or electrical control signals for the light bars. For example, FIG. 6J shows the PCB 371 may connect to a pair of wires 373a and 373b to receive a two-signal input. The wires 373a and 373b may be electrically connected to an external LED driver. The LED driver may be installed into the environment separately from the other components of the linear lighting system, e.g., the mounting track 110a, the light bars 200a-200c, the input connector 300a, and so on. The wires 373a and 373b may generally receive electrical power from the LED driver. In some implementations, the wires 373a and 373b may receive control signals to facilitate dimming, e.g., by controlling the brightness of the light emitted by the light bars. The foregoing control signals may be embedded on the power line input.

The wires may connect to the input connectors disclosed herein in various ways. In one example, one end of the wires 373a and 373b may be soldered to corresponding electrical contacts on the PCB 371. The other end of the wires 373a and 373b may include an electrical connector configured to connect to corresponding wires connected to the LED driver. In another example, FIGS. 17A-17C show wires may be inserted through wiring ports 376 formed on the housing 310c of the input connector 300c and connected to the PCB 371 via corresponding set screws 377.

The PCB 371 may further support the electrical connectors 372a. In this example, the PCB 371 may support a pair of electrical connectors 372a for connection with the pair of electrical contact pads 273a on the light bars 200a-200c. The pair of electrical connectors 372a may transmit electrical power and, in some instances, control signals to control the dimming of the light sources 270a-270c in the light bars 200a-200c. Thus, the input electronics 370a may provide a two-signal output. The PCB 371 may further incorporate various electrical components (e.g., wiring traces electrically connected to the wires 373a and 373b and the electrical connectors 372a).

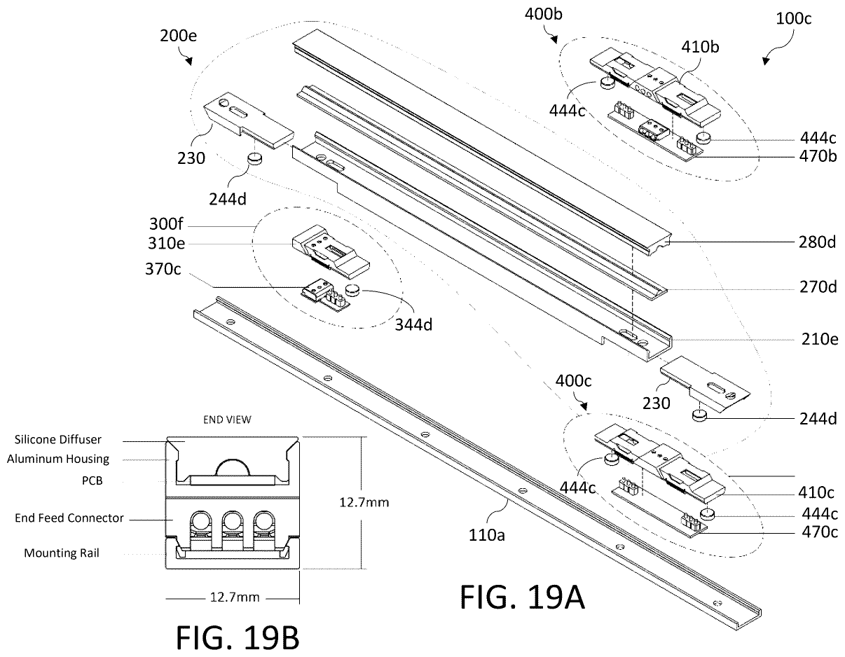

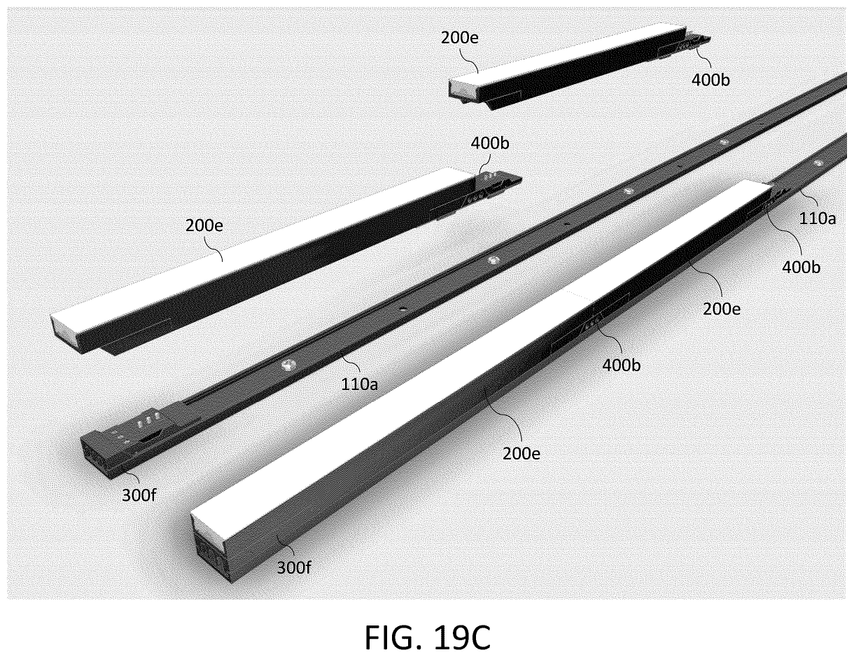

In this non-limiting example, the electrical connectors 372a may be electrical spring contacts. More generally, the electrical connectors 372a may include a male or a female connector including, but not limited to, an electrical spring contact, a pogo-pin connector, and the like. In another non-limiting example, FIGS. 17A-17C show the input connector 300c may include female electrical spring contacts 372b to receive male electrical connectors 273b on the light bar 200d. In yet another non-limiting example, FIGS. 19A and 19B show a lighting system 100c that includes an input connector 300f, a light bar 200e, and middle connectors 400b and 400c. In this example, the input connector 300f may include a housing 310e supporting a magnet 344d and input electronics 370c supporting pogo-pin connectors. The light bar 200e may include a housing 210e, a pair of end sections 230 supporting a magnet 244d, a light source 270d, and an optic 280d. The light source 270d may include one or more electrical contact pads to connect to the pogo-pin connectors of the input connector 300f. The middle connector 400b may similarly include a housing 410b supporting magnets 444c and electronics 470b with pogo-pin connectors for connection with a pair of light bars. The middle connector 400c may also include a housing 410c supporting magnets 444c and electronics 470c with pogo-pin connectors for connection with a pair of light bars. The electronics 470b may further allow for direct connections to one or more wires (e.g., wires connected to a LED driver).

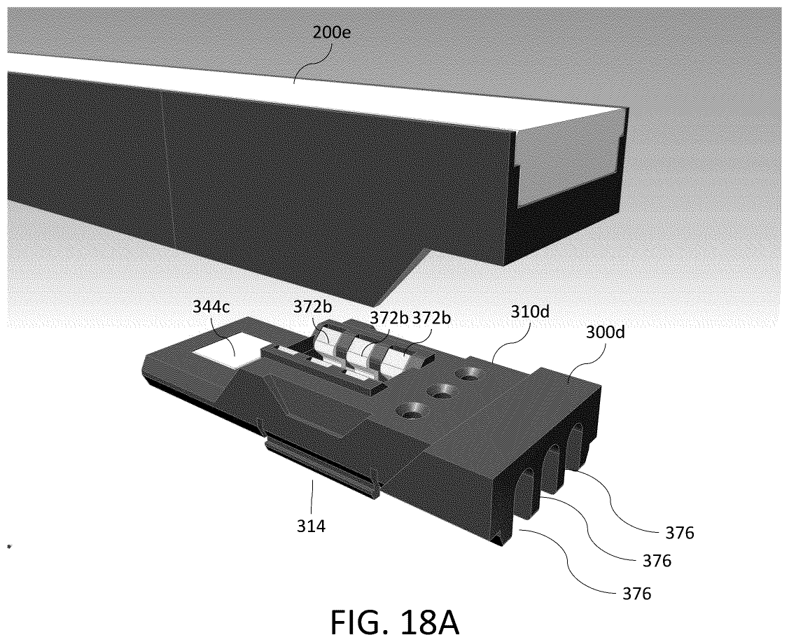

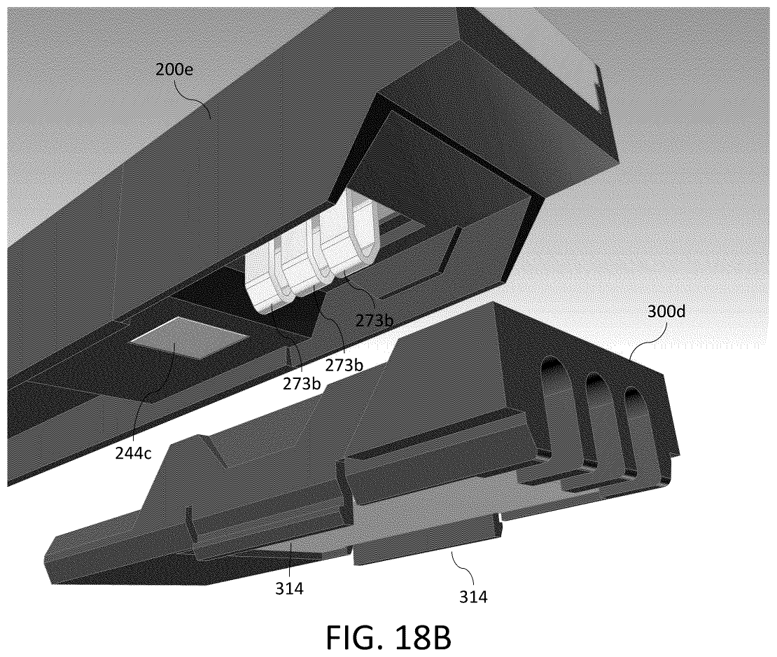

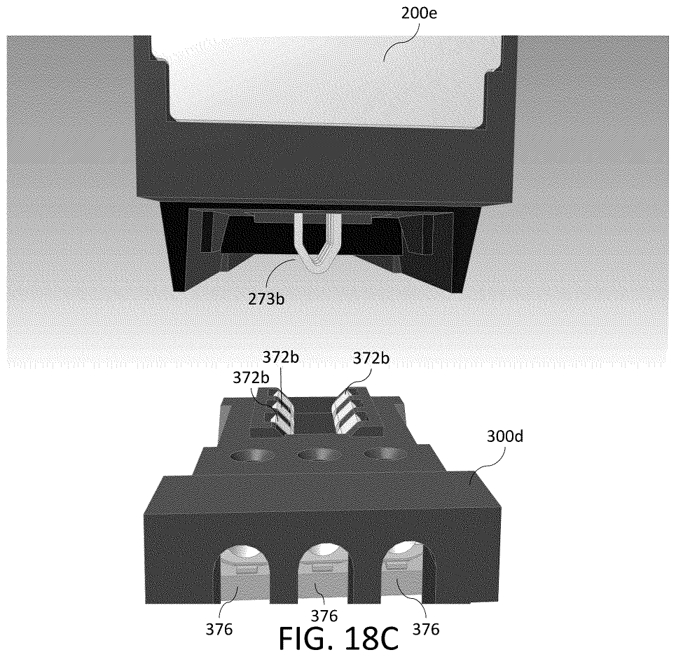

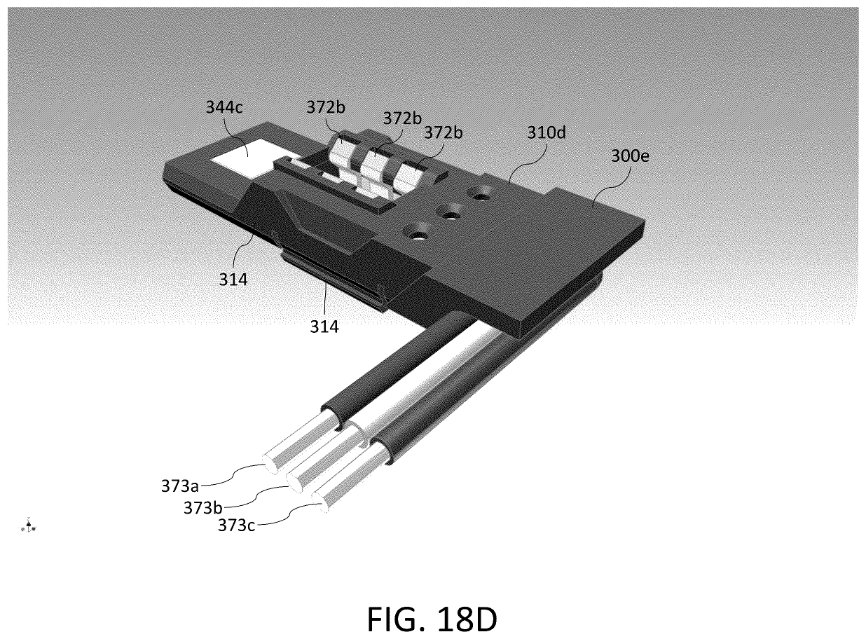

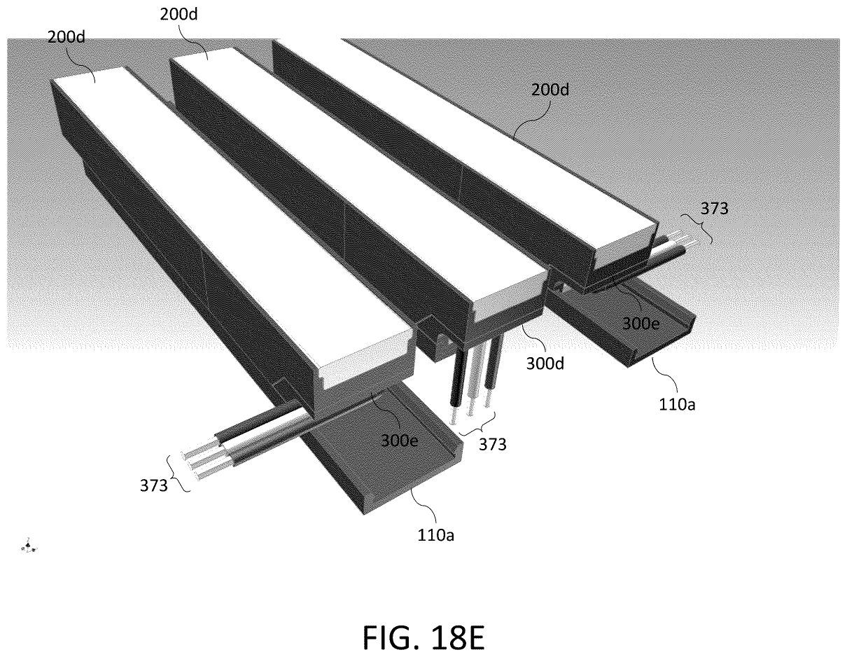

It should be appreciated that different combinations of the various mechanical and electrical coupling mechanisms described herein are contemplated herein. In yet another non-limiting example, FIGS. 18A-18C show an input connector 300d mechanically coupled to a light bar 200e via a magnet 344c on the input connector 300d and a magnet 244c on the light bar 200e and electrically coupled to the light bar 200e via the male electrical connectors 273b on the light bar 200e and the female electrical spring contacts 372b on the input connector 300d.

In some implementations, the input connector for the linear lighting systems disclosed herein may include an integrated LED controller. The LED controller may generate control signal(s) that allow greater customization of the light output provided by the linear lighting system. For example, the control signal(s) from the LED controller may adjust the color of the light output (e.g., the correlated color temperature) from light bars that include two or more different types of LEDs. Further details of example LED controllers that may be integrated into the linear lighting systems disclosed herein are provided in Section 2 below.

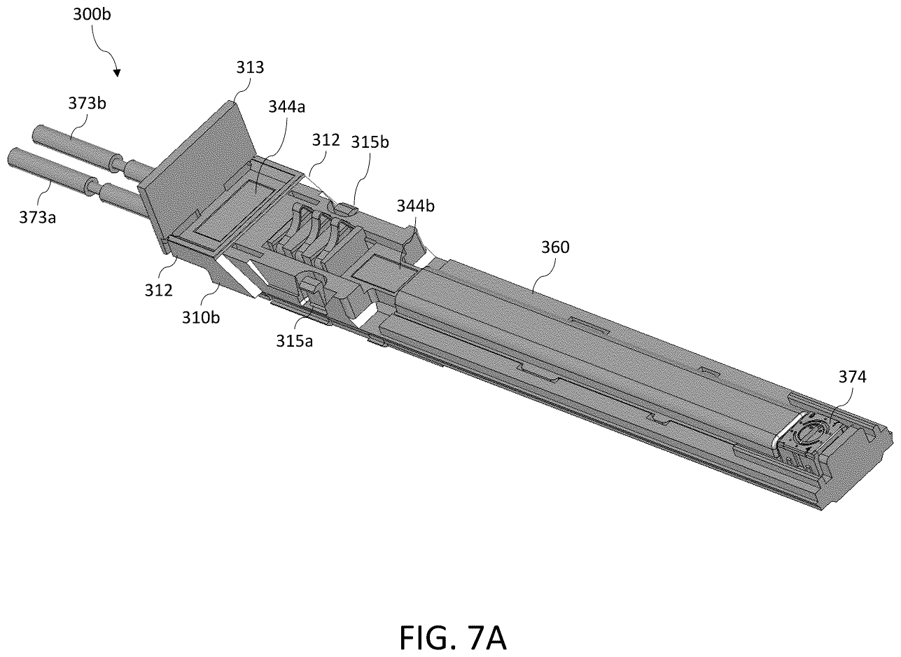

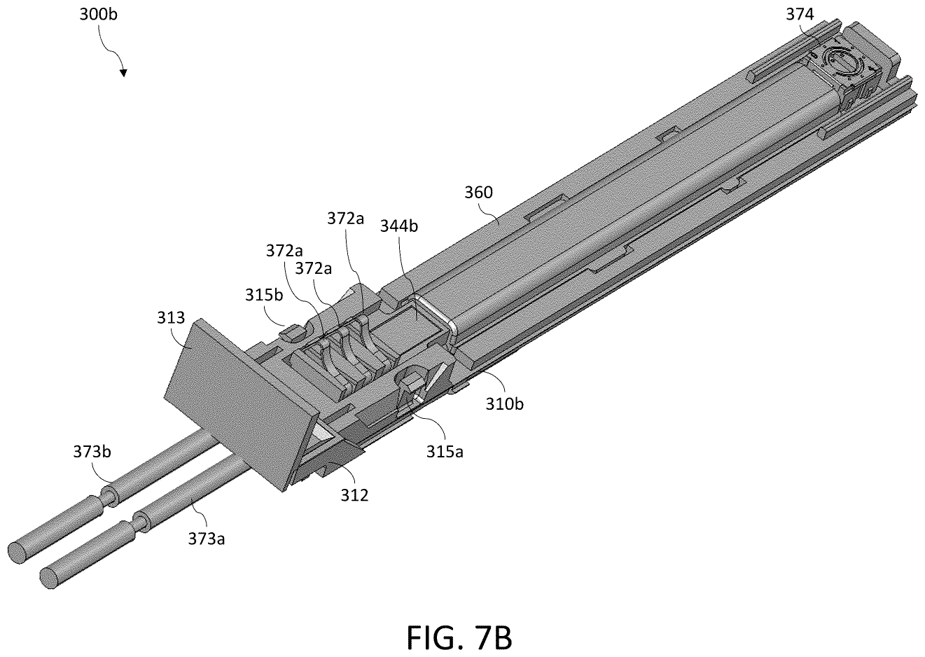

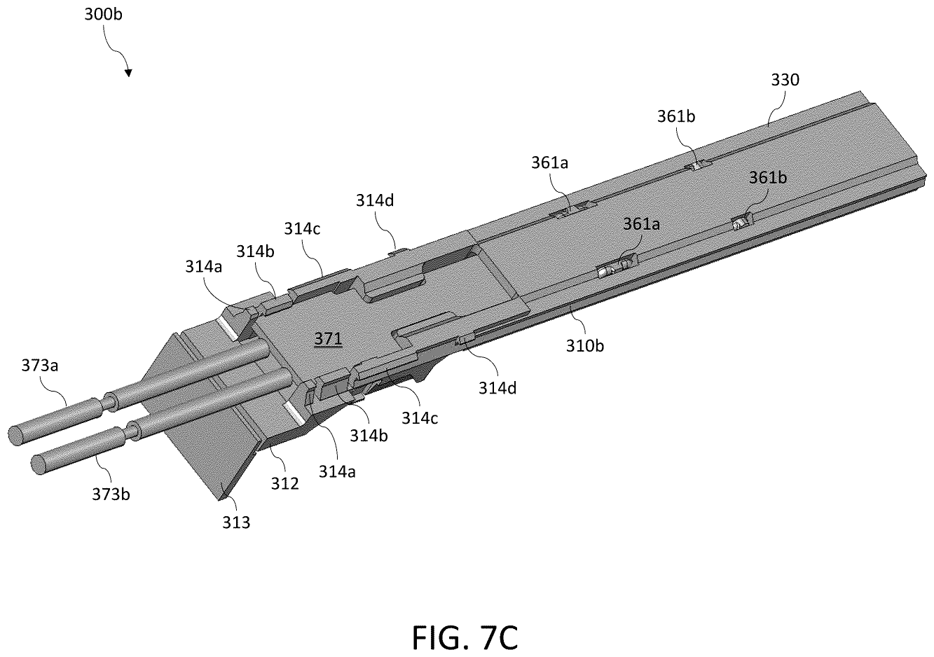

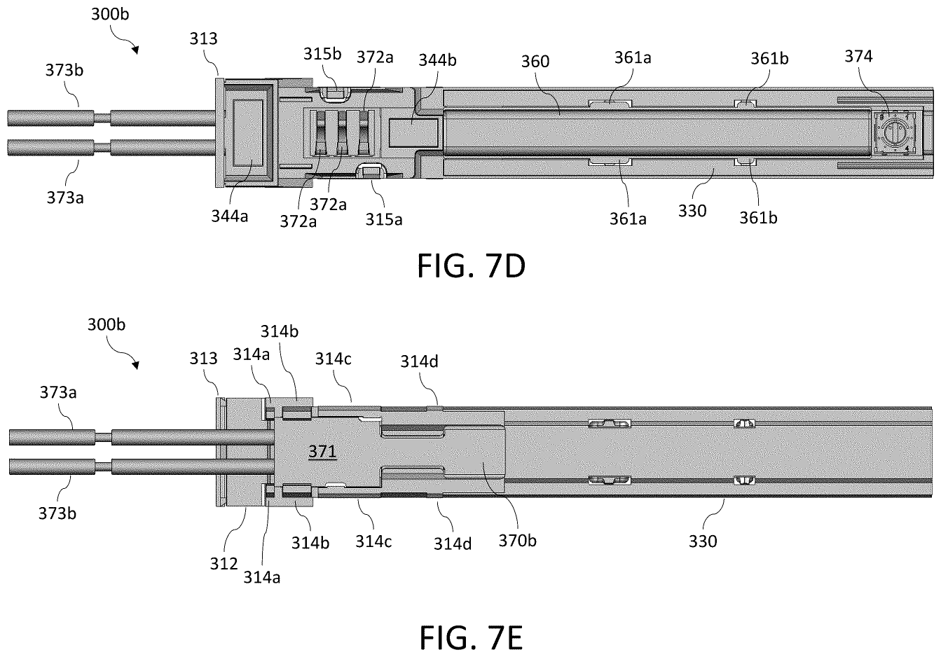

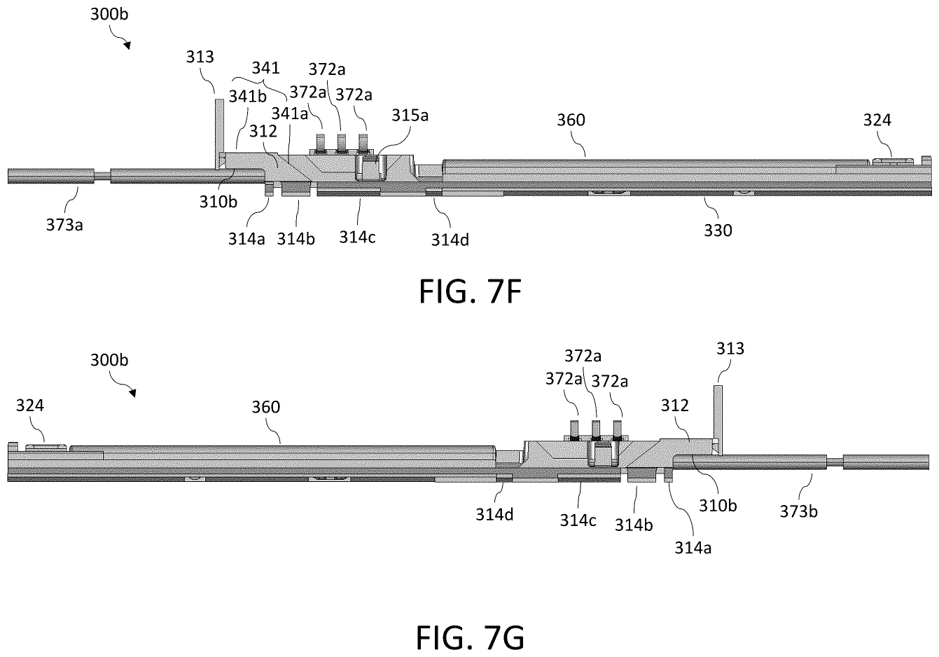

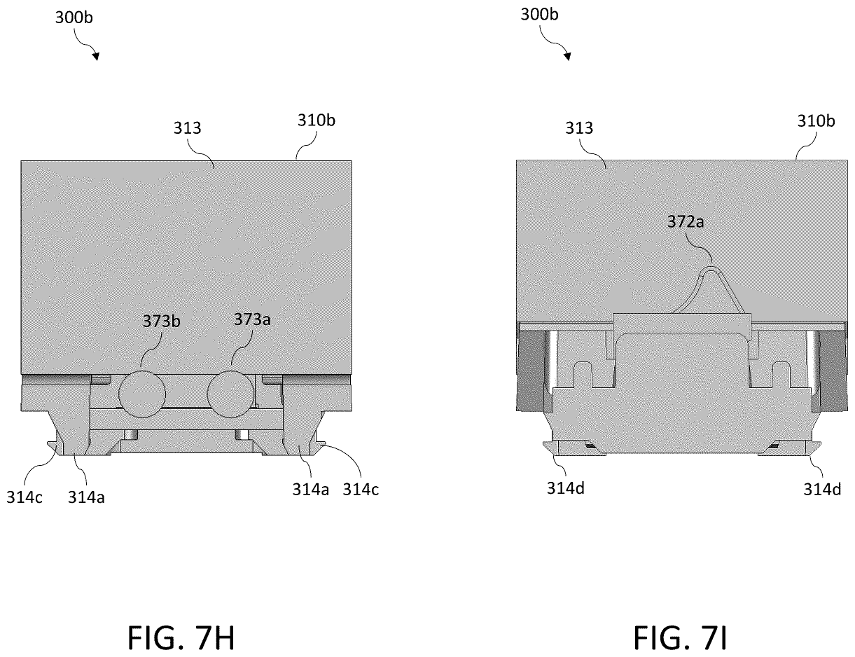

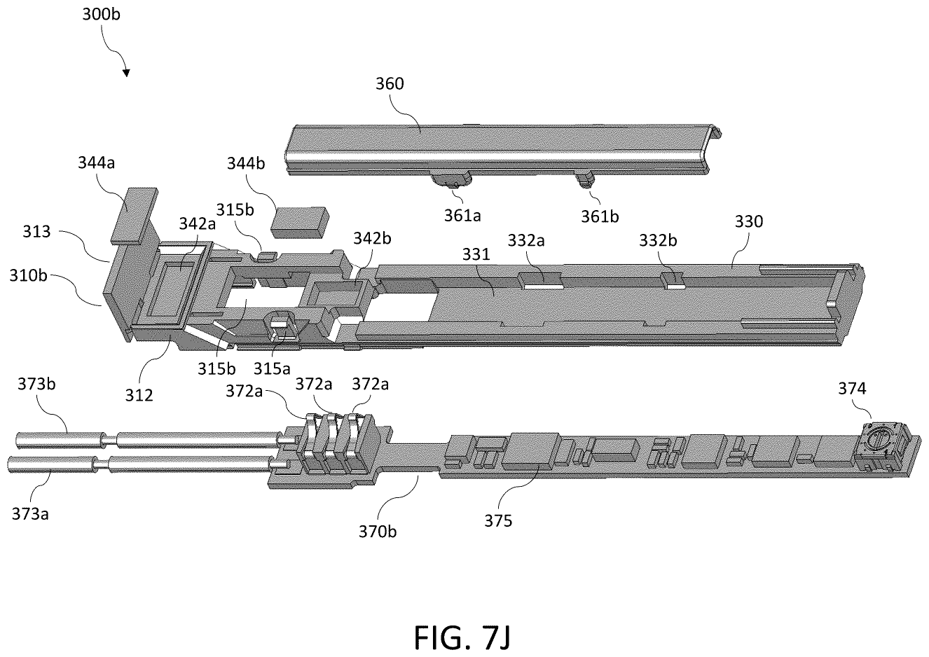

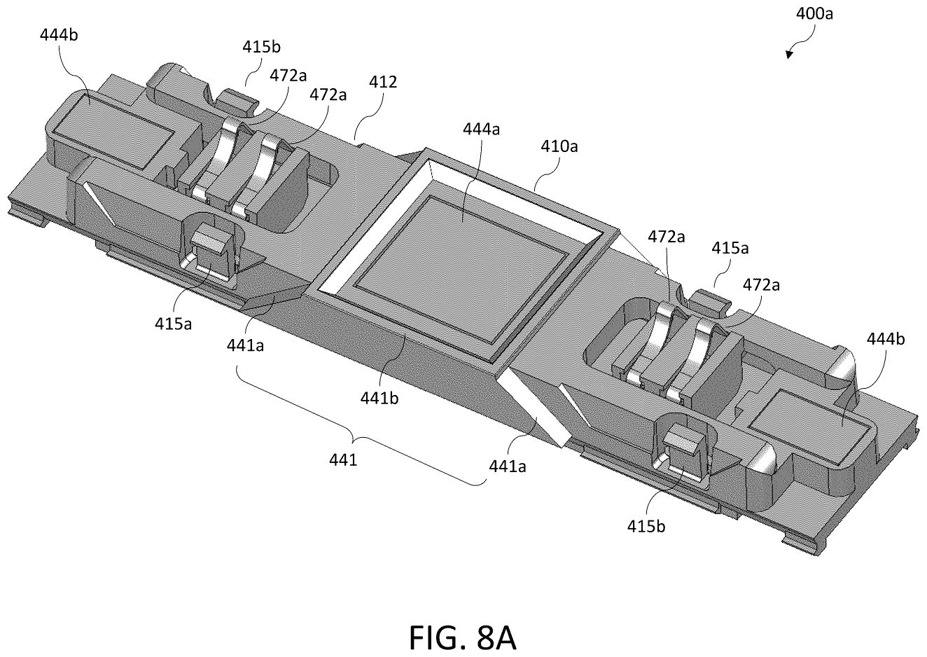

In one non-limiting example, FIGS. 7A-7J show several views of the input connector 300b from FIG. 2A, which includes an integrated LED controller. As shown, the input connector 300b may include a housing 310b, input electronics 370b mechanically coupled to the housing 310b, a cover 360 mechanically coupled to the housing 310b, and magnets 344a and 344b. The input connector 300b may incorporate one or more of the same components and/or features from the input connector 300a. For brevity, repeated discussion of these components and/or features are not provided below unless indicated otherwise.

As shown, the housing 310b may incorporate several of the same features as the housing 310a. For example, the housing 310b may include a frame 312 and a removable end cap 313 joined to the frame 312. The housing 310b may further incorporate various features to facilitate mechanical coupling of the input connector 300b to a light bar, such as magnet holders 342a and 342b, which support magnets 344a and 344b, respectively, snap-fit connectors 315a and 315b, and mechanical registration features 341. The housing 310b may also include features to mechanically couple the input connector 300b to the mounting track 110a, such as tabs 314a, 314c, and 314d. The housing 310b may further provide an opening 320 for electrical connectors 372a in the input electronics 370b.

Additionally, the housing 310b may include a frame 330 joined to the frame 312 to support additional electrical components 375 in the input electronics 370b. Thus, the LED controller of the input electronics 370b may be disposed under a light bar in the linear lighting system. As shown in FIG. 7J, the frame 330 may define a channel 331 to contain a portion of the input electronics 370b. The input connector 300b may further include a cover 360 to cover at least a portion of the channel 331 containing the input electronics 370b. For example, FIGS. 7A and 7B show the cover 360 may cover electrical components 375 of the input electronics 370b, but not the switch 374. In some implementations, the cover 360 may be mechanically coupled to the frame 330 via one or more snap-fit connectors. For example, FIG. 7J shows the cover 360 may include snap-fit connectors 361a and 361b, which couple to corresponding snap-fit retainers 332a and 332b, respectively, located on the frame 330 of the housing 310a.

The input electronics 370b may include the PCB 371, which is electrically coupled to a pair of wires 373a and 373b connected to an external LED driver to receive electrical power and, in some instances, control signals to control the brightness of the light output from the light bars. Thus, the input electronics 370b may receive a two-signal input like the input electronics 370a described above. However, compared to the input electronics 370a, the PCB 371 of the input electronics 370b may be larger, in part, to accommodate additional electrical components 375 for the LED controller. As described above, the LED controller may separately provide control signal(s) to adjust the color of the light output. Thus, in some implementations, the input electronics 370b may provide a three-signal output that includes electrical power, control signals to control dimming, and control signals to control the color of the light output. Accordingly, the PCB 371 may provide three electrical connectors 372a.

In some implementations, the linear lighting systems disclosed herein may be connected to an external LED controller via three wires. For example, the input connectors 300c and 300d shown in FIGS. 17A-17C and 18A-18C, respectively, may each connect to three wires inserted through corresponding wiring ports 376. FIG. 18D shows another example input connector 300e that connects to wires 373a, 373b, and 373c. FIG. 18E shows the wires connected to the input connectors 300d and 300e may be oriented along different directions to suit different environments and installations.

FIG. 7J further shows the PCB 371 may support a switch 374 (also referred to herein as a “selectable switch 374”), which provides a way to manually adjust the color and/or brightness of the light output from the linear lighting system according to one or more presets. For example, the presets may follow a dim-to-warm curve, which provides different combinations of dimming and CCT, e.g., to provide desired lighting conditions for different times of day. In another example, the presets may be based on a set of desired colors. The switch 374 may be accessed during installation of the linear lighting system, e.g., before a light bar is installed and/or by removing a light bar from the linear lighting system after installation. The switch 374 may be manually adjusted by hand or using a tool (e.g., a screwdriver).

In some implementations, the input electronics disclosed herein may receive control signals wirelessly. This may be accomplished, for example, by the input electronics including a wireless receiver to receive a control signal from a remote computing device (e.g., a phone, a computer) and appropriate electronics to convert the received signal into a control signal for transmission to the light bars in the linear lighting system.

### 1.3 An Example Middle Connector

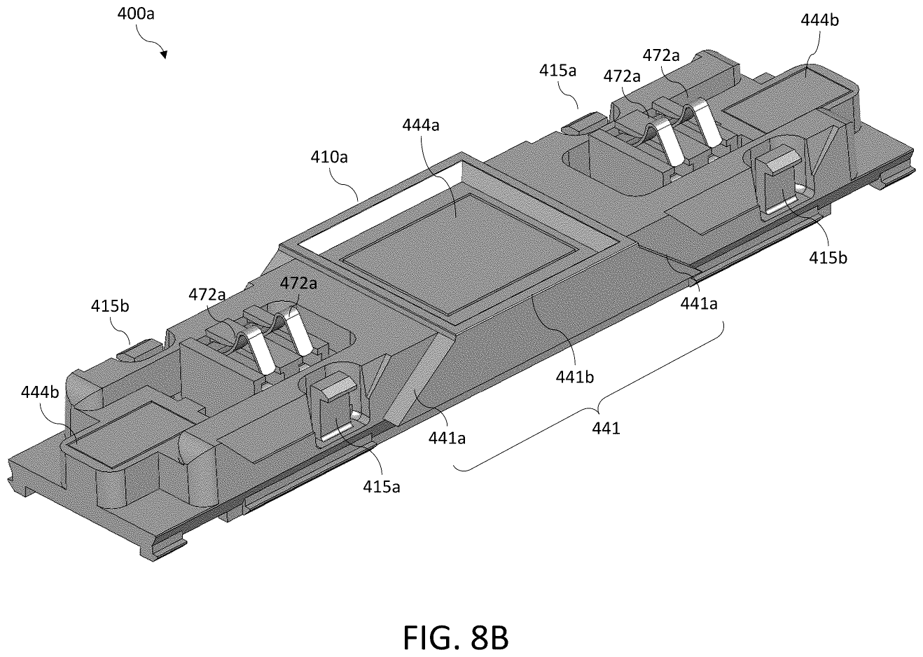

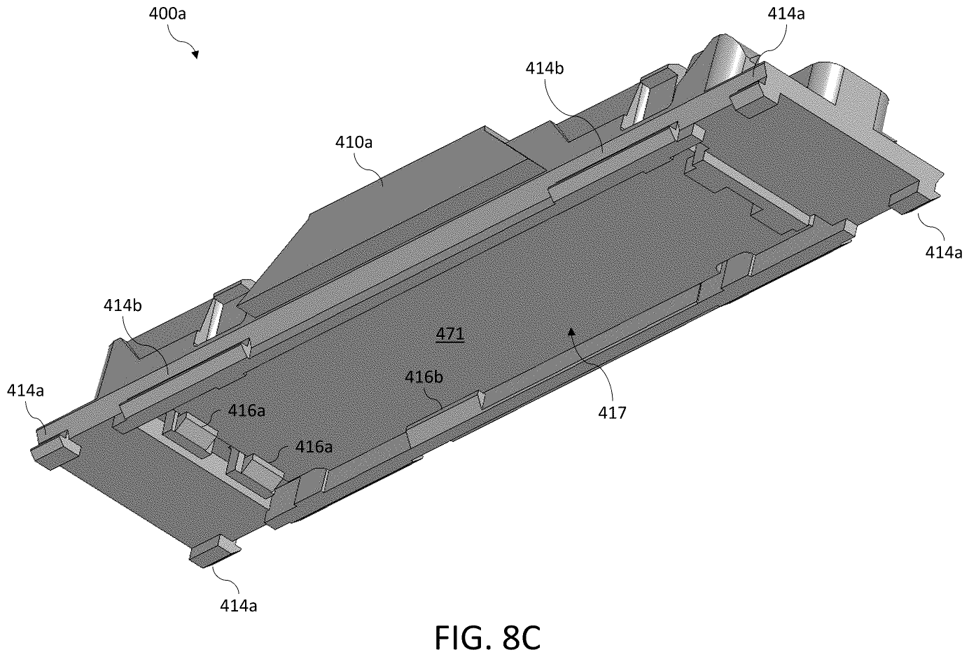

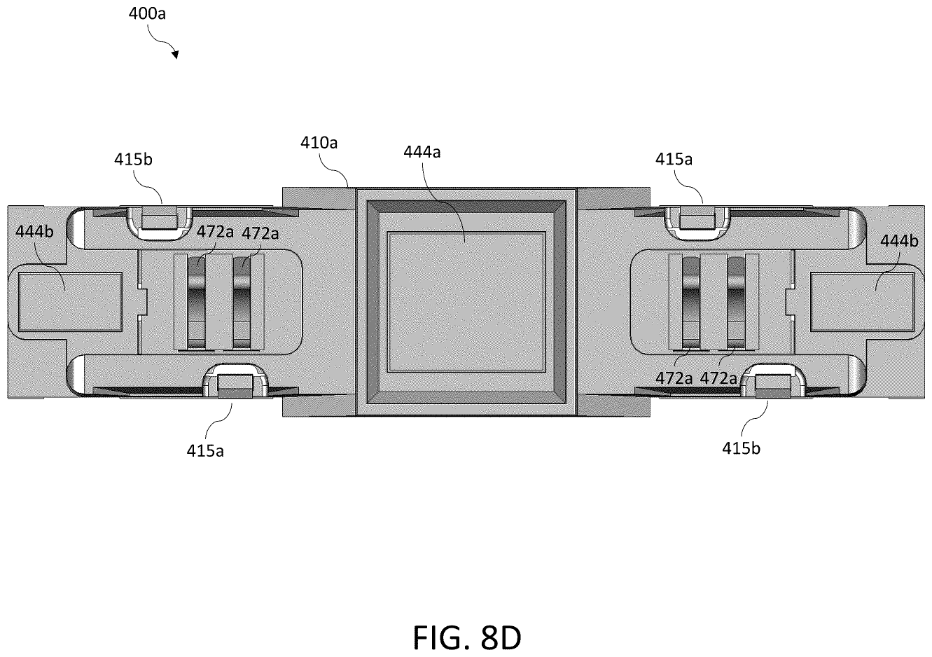

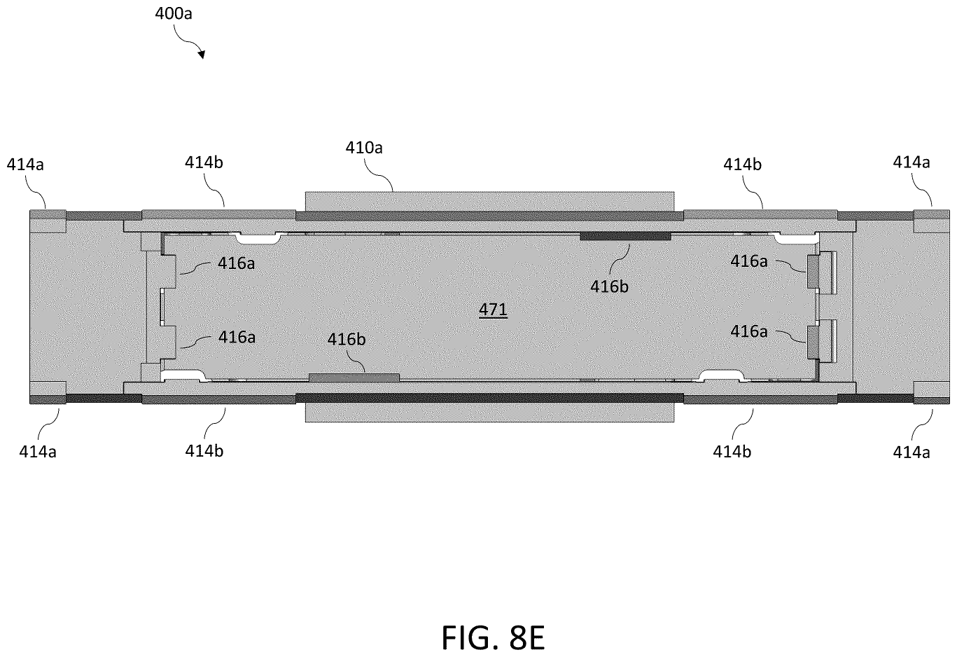

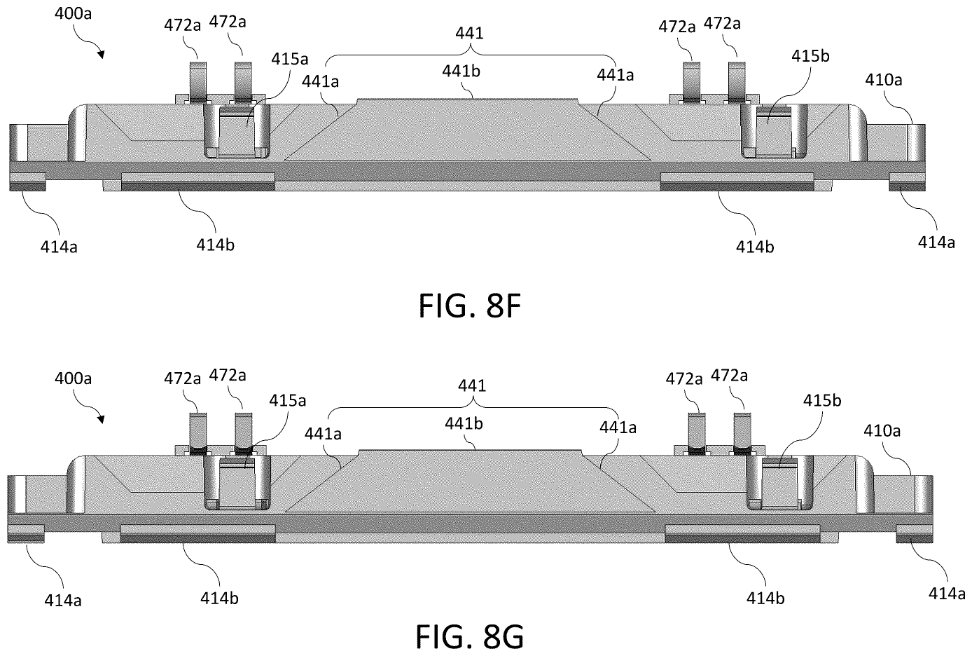

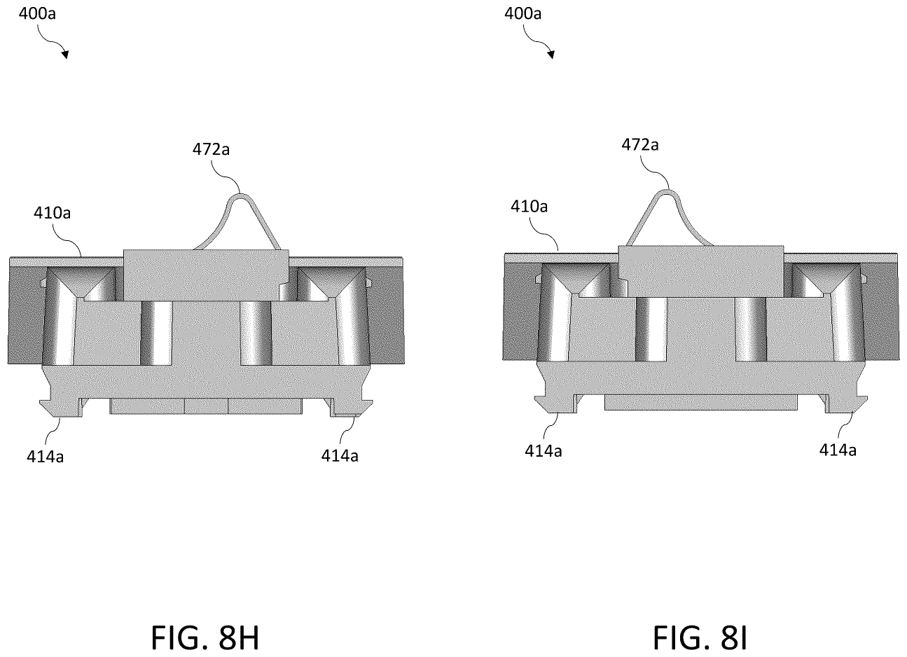

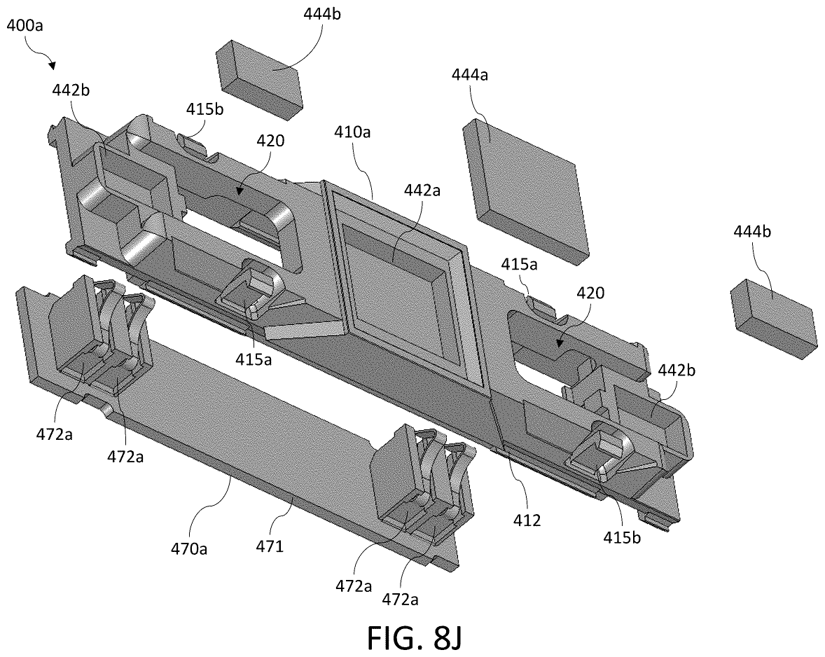

FIGS. 8A-8J show several views of an example middle connector 400a. The middle connector 400a may be used, for example, to electrically connect two light bars in series. Said another way, the middle connector 400a may facilitate daisy-chaining of multiple light bars in the same run. For example, the middle connector 400a may provide electronics to transmit electrical power and/or control signal(s) from one light bar to another light bar. Thus, in some implementations, the middle connector 400a may be installed in the middle of a run of light bars forming the linear lighting system.

Given the modular nature of the linear lighting systems disclosed herein, the middle connector 400a may provide a mechanical and electrical interface similar to the input connectors 300a and 300b. Accordingly, the middle connector 400a may incorporate one or more of the same components and/or features from the input connectors 300a or 300b. For brevity, repeated discussion of these components and/or features are not provided below unless indicated otherwise.

As shown, the middle connector 400a may include a housing 410a and electronics 470a mechanically coupled to the housing 410a. The housing 410a may provide features to mechanically align and couple the middle connector 400a to a pair of light bars in the linear lighting system (e.g., the light bars 200a-200c) and to the mounting track 110a. The input electronics 470a may provide two sets of electrical connectors 472a to electrically connect the middle connector 400a to the pair of light bars (e.g., via the electrical connectors 273a of the light sources 270a-270c). Each of the foregoing components of the input connector 300a are described in further detail below.

The housing 410a may include a frame 412 that provides various features to mechanically couple the middle connector 400a to a pair of light bars. For example, the housing 410a may support magnets 444a and 444b via respective magnet holders 442a and 442b. The magnets 444a and 444b, as described above, may form part of a magnetic coupling mechanism with the light bars 200a-200c. The magnet 444a may be shaped and/or dimensioned based on a pair of adjoining magnets 244a of the light bars 200a-200c since the magnets 244a in two adjacent light bars are disposed next to one another when installed onto the mounting track 110a. The magnet 444b may be shaped and/or dimensioned to be the same as the magnet 242b of the light bars 200a-200c. In some implementations, the magnets 444a and 444b may be securely coupled to the magnet holders 442a and 442b, respectively, via an adhesive, a press-fit connection, or the like.

In another example, the housing 410a may include one or more snap-fit connectors, e.g., to engage with corresponding snap-fit retainers on the light bars. For example, FIGS. 8A and 8B show the housing 410a may include two pairs of snap-fit connectors 415a and 415b. The snap-fit connectors 415a and 415b may be arranged to engage with snap-fit retainers 245 disposed on, for example, the end section 230 of the light bar 200a, the housing 210b of the light bar 200b, or the housing 210c of the light bar 200c. As described above, the combination of the magnetic coupling mechanism and the snap-fit connection mechanism supported by the middle connector 400a may securely couple the middle connector 400a to the pair of light bars.

In yet another example, the housing 410a may include a mechanical registration feature 441 to facilitate alignment with the light bars during assembly. As shown in FIGS. 8A and 8B, the mechanical registration feature 441 may include a pair of sloped surfaces 441a and a flat surface 441b. When the light bars are coupled to the middle connector 400a, the sloped surfaces 441a and the flat surface 441b may align with corresponding sloped surfaces 241a and flat surfaces 241b, respectively, on the light bars 200a-200c.

The housing 410a may further provide features to mechanically couple the middle connector 400a to the mounting track 110a. For example, FIG. 8C shows the housing 410a may include multiple tabs 414a and 414b joined to the frame 412. The tabs 414a and 414b may be shaped to secure the middle connector 400a to the retaining walls 112 of the mounting track 110a. In some implementations, the tabs 414a and 414b may be sufficiently compliant such that the middle connector 400a may be readily pressed onto and secured to the mounting track 110a in a similar manner as a snap-fit connection. For example, each tab 414a and 414b may readily bend when physically contacting the sloped portion of the retaining wall 112 of the mounting track 110a. As the middle connector 400a is pushed further toward the base 113 of the mounting track 110a, the tabs 414a and 414b may pass the sloped portion of the retaining wall 112 and bend back to its original shape, thus securing the middle connector 400a to the mounting track 110a.

In some implementations, the middle connector 400a may be mechanically coupled to one end of a light bar and, thereafter, the light bar and the middle connector 400a may together be mounted to the mounting track 110a. That way, the middle connector 400a need not be precisely positioned onto the mounting track 110a to ensure a light bar can be mounted to the middle connector 400a, thus improving the ease of installation of the linear lighting system.

As shown in FIG. 8J, the housing 410a may further include a pair of openings 420 where the openings 420 are disposed on opposing sides of the magnet holder 442a. Each opening 420 may allow one set of the electrical connectors 472a of the electronics 470a to pass through so that the electrical connectors 472a can electrically connect to corresponding electrical connectors of the light bar (e.g., the electrical contact pads 273a of the light bar 200a). For example, FIGS. 8A and 8B show two sets of electrical connectors 472a disposed through respective openings 420. The housing 410a may further provide support for the electronics 470a. For example, FIG. 8C further shows the frame 412 may include an opening 417 surrounded by snap-fit retainers 416a and 416b. The electronics 470a may include a PCB 471 that is inserted through the opening 417 and supported by the snap-fit retainers 416a and 416b.

The housing 410a may be formed from various metals and/or polymers including, but not limited to, aluminum, steel, zinc, polyethylene, polypropylene, polyvinyl chloride, polystyrene, acrylonitrile butadiene styrene, polyamide, polycarbonate, polymethyl methacrylate, polybutylene terephthalate, polyethylene terephthalate, and the like. In some implementations, the housing 410a may be manufactured as a single part.

The electronics 470a may include the PCB 471. As described above, the PCB 471 may include two sets of electrical connectors 472a to facilitate electrical connections to a pair of light bars. In this example, the PCB 471 may support a pair of electrical connectors 472a for connection with the pair of electrical contact pads 273a on the light bars 200a-200c. For example, the pair of electrical connectors 472a may transmit electrical power and, in some instances, control signals to control the dimming of the light sources 270a-270c in the light bars 200a-200c. Thus, the electronics 470a may receive a two-signal input (e.g., from one light bar) and provide a two-signal output (e.g., to another light bar). It should be appreciated, however, that in some implementations, the linear lighting system may further support adjustments to the color of the light output (e.g., the CCT). For example, the linear lighting system may include the input connector 300b with an integrated LED controller, which provides a three-signal output as described in Section 1.2. Thus, in some implementations, the middle connector 400a may include two sets of three electrical connectors 472a. In this manner, the electronics 470a may receive a three-signal input and provide a three-signal output.

In this non-limiting example, the electrical connectors 472a may be electrical spring contacts. More generally, the electrical connectors 472a may include a male or a female connector including, but not limited to, an electrical spring contact, a pogo-pin connector, and the like. The PCB 471 may further incorporate various electrical components (e.g., wiring traces electrically connected to the electrical connectors 472a).

### 1.4 An Example End Connector

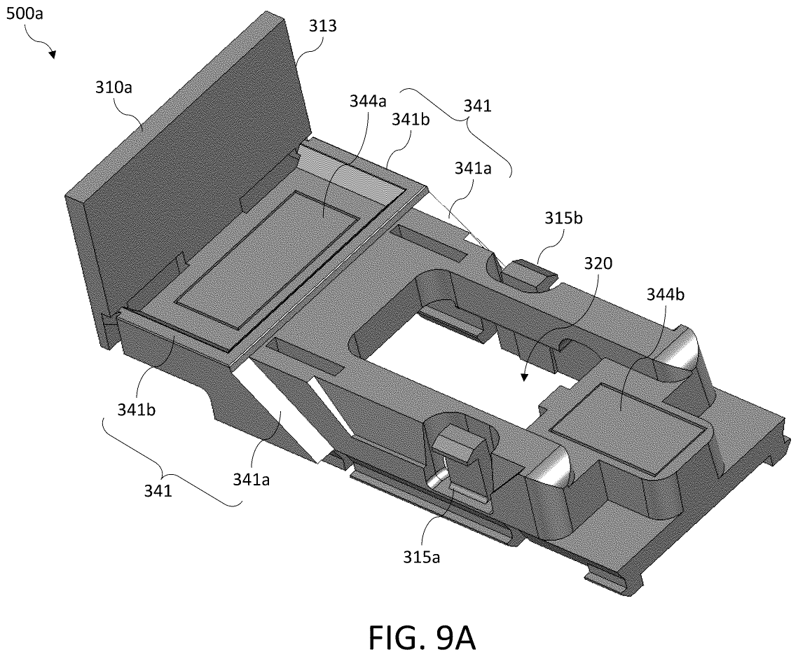

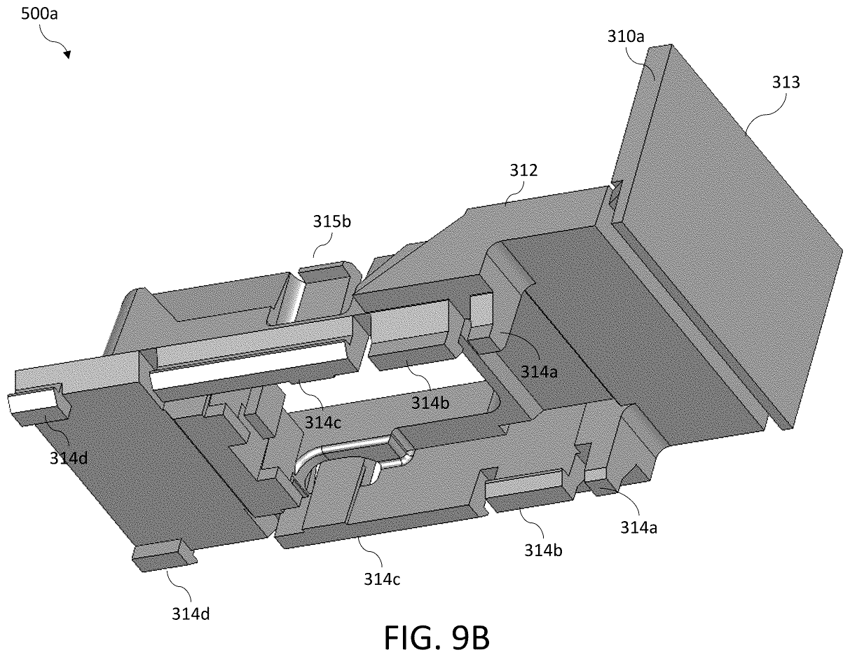

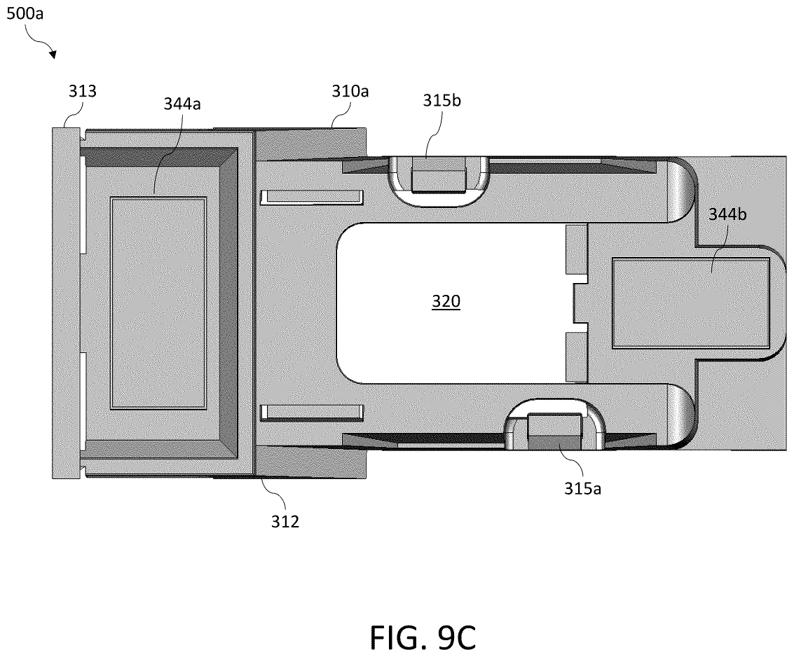

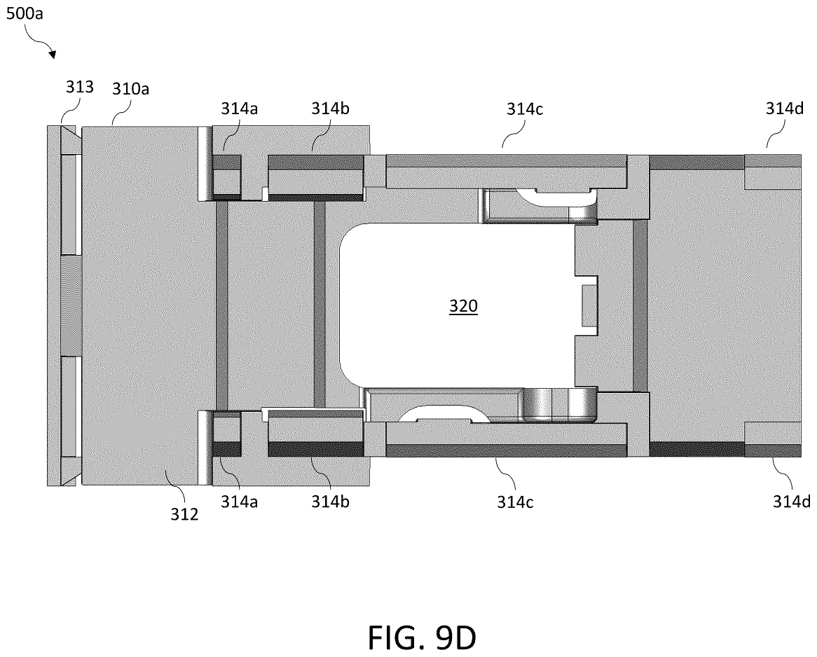

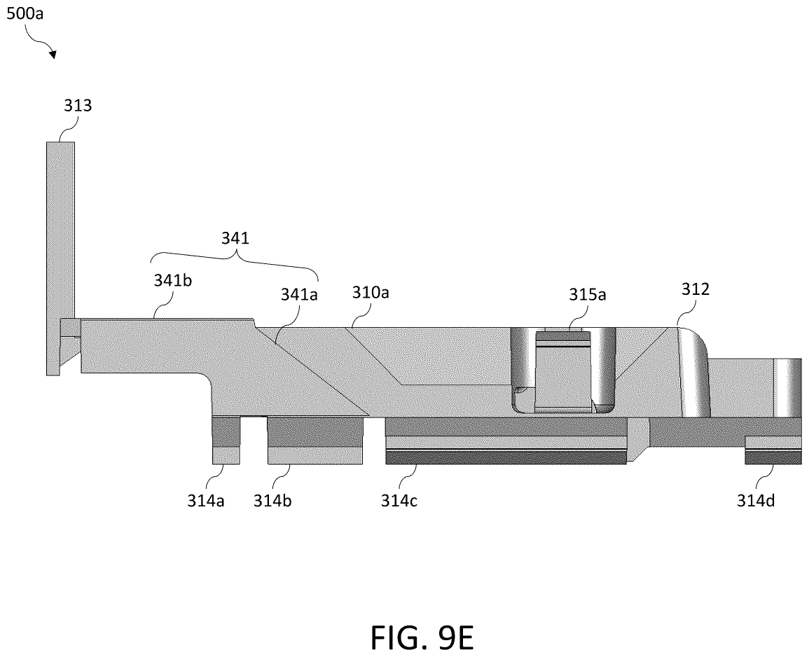

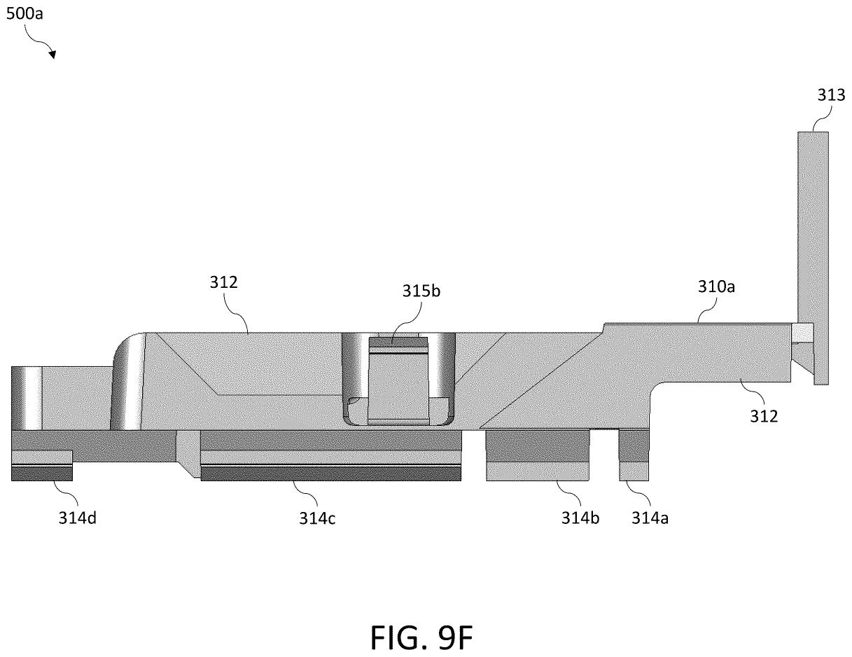

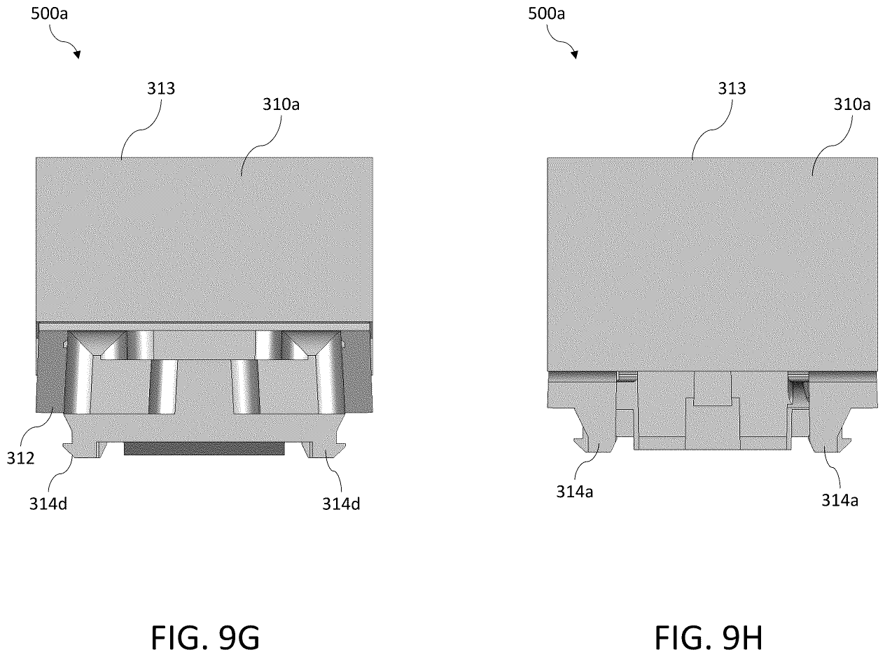

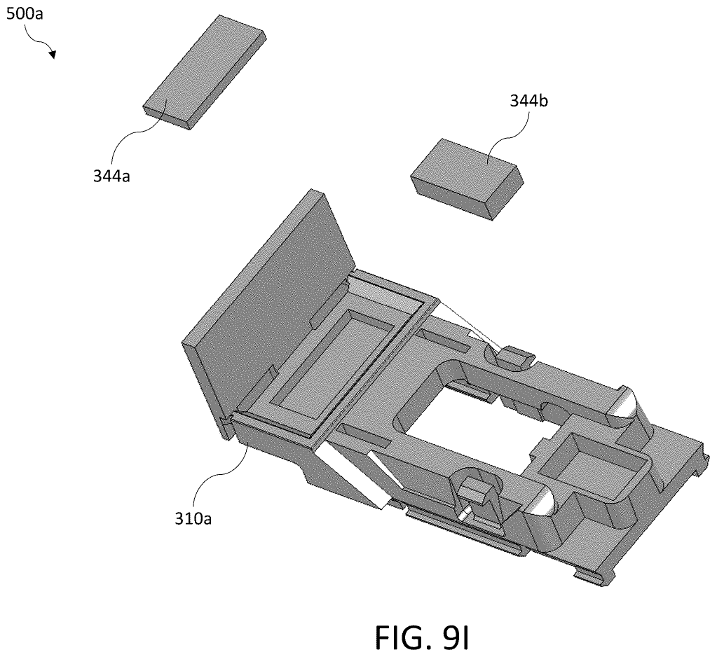

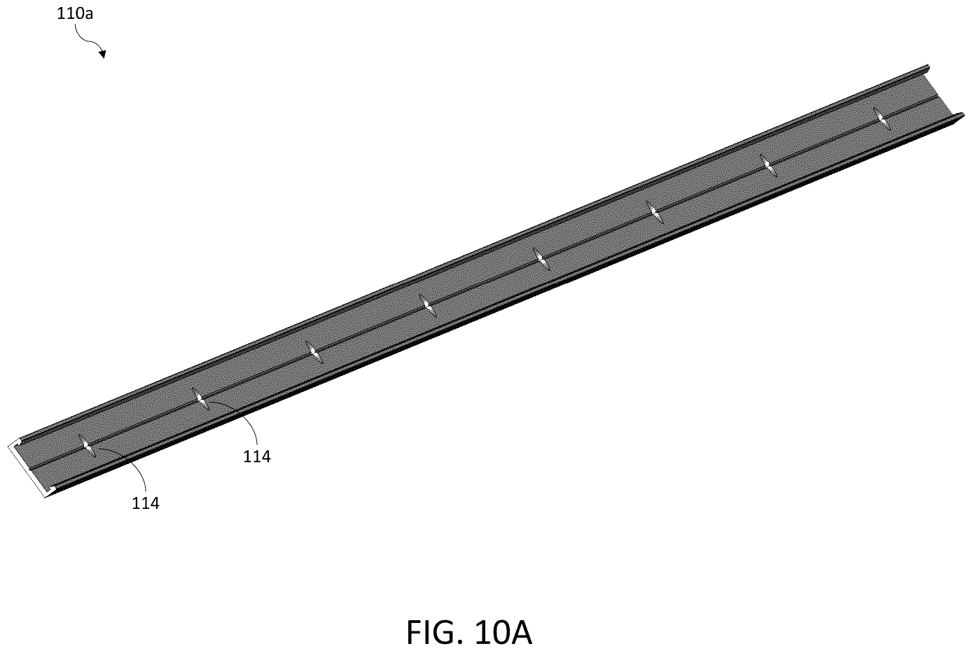

FIGS. 9A-9I show several views of an example end connector 500a. The end connector 500a may be installed at the end of a run of light bars forming the linear lighting system. For example, the end connector 500a may be mechanically connected to the light bars 200a or 200c as described in Section 1.1. The end connector 500a may not support any electronics nor provide any electrical connections since end connector 500a is configured to connect to the last light bar in a run.

In some implementations, the end connector 500a may be based on the input connector 300a. For example, the end connector 500a may include the housing 310a and the magnets 344a and 344b, but may not include the input electronics 370a. In this manner, the end connector 500a may retain the features of the input connector 300a to mechanically align and couple the input connector 300a to a light bar. For brevity, repeated discussion of the features of the housing 310a and the magnets 344a and 344b are not provided.

### 1.5 Examples of Mounting Tracks

The linear lighting systems disclosed herein may generally include a mounting track to facilitate installation of the linear lighting system onto a surface of the environment (e.g., a wall, or a ceiling). The surface of the environment onto which the mounting track is mounted is also referred to herein as an installation surface or a building surface. For example, the mounting track may provide support for one or more light bars (e.g., the light bars 200a-200c), one or more input connectors (e.g., the input connectors 300a and 300b), one or more middle connectors (e.g., the middle connector 400a), and/or one or more end connectors (e.g., the end connector 500a). In some implementations, the mounting track may be provided with a preset length (e.g., 24 inches, 48 inches). For longer installations, multiple mounting tracks may be used. For example, two or more mounting tracks may be installed onto a wall or a ceiling and aligned end-to-end to support a continuous run of light bars.

The mounting track may be installed onto the installation surface in various ways. In one example, the mounting track may be mounted directly onto the installation surface. In another example, the mounting track may be disposed within a recessed channel formed on the installation surface.

It should also be appreciated that the linear lighting systems disclosed herein may be used in various lighting applications including, but not limited to, recessed lighting (e.g., on a wall or a ceiling), cove lighting, under cabinet lighting, over cabinet lighting, toe kick lighting, wine rack lighting, under bed lighting, knife-edge lighting, millwork lighting, perimeter lighting, and the like. Given the standardized nature of the light bars and the connectors, the implementation of the linear lighting systems disclosed herein in different lighting applications may be facilitated, in part, by the mounting track. Following below are several non-limiting examples of mounting tracks that can be mounted to an installation surface in different ways and/or position and orient the light bars to provide light output for different lighting applications.

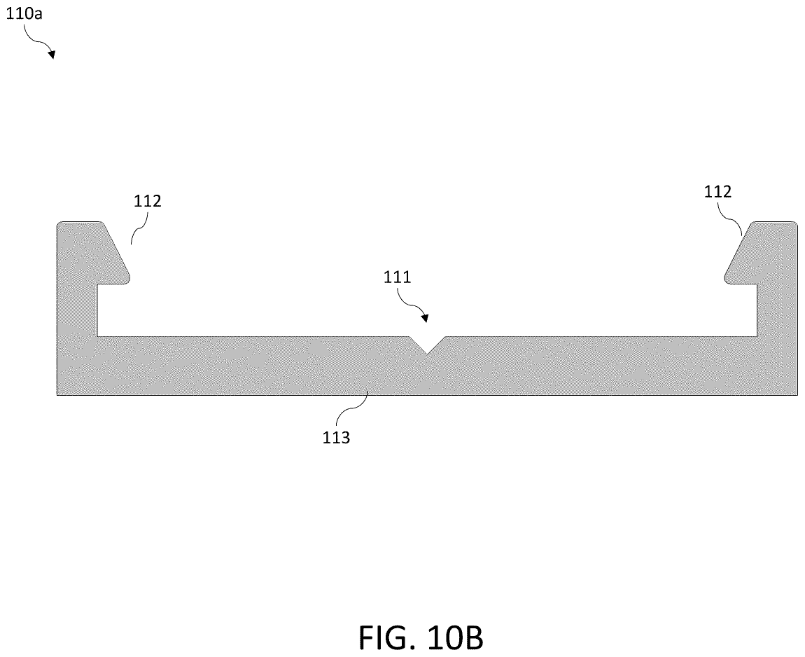

FIGS. 10A and 10B show several views of the mounting track 110a described above in Section 1. As shown, the mounting track 110a may include a base 113 and a pair of retaining walls 112 joined to the base 113. Together, the base 113 and the retaining walls 112 may define a mounting channel 111 (also referred to herein as a “channel 111”) to support various other components in the linear lighting system. The base 113 and the retaining walls 112 may be shaped and/or dimensioned such that the mounting track 110a is disposed under the light bars of the linear lighting system. In some implementations, the width of the mounting track 110a may be equal to or less than the width of the light bars 200a-200c. For example, the retaining walls 112 may align with the respective sidewalls of the light bars to provide a seamless appearance between the light bars and the mounting track 110a (see, for example, the lighting system 100a shown in FIGS. 1A-1W). A seamless appearance may further be facilitated by the mounting track 110a having the same color and/or surface finish as the respective housings of the light bars.

In some implementations, the retaining walls 112 may be shaped to form a snap-fit connector. As described above, the light bars 200a-200c, the input connectors 300a and 300b, the middle connector 400a, and the end connector 500a may be installed onto the mounting track 110a by pressing the foregoing components against the mounting track 110a to bend corresponding tabs on the foregoing components to engage the retaining walls 112.

In some implementations, the mounting track 110a may be mounted onto a surface of the environment via one or more fasteners. For example, FIG. 10A shows the mounting track 110a may include one or more fastener openings 114 configured to receive corresponding fasteners 115 for attachment to the installation surface. It should be appreciated that the fastener coupling mechanism is a non-limiting example. More generally, the mounting track 110a may be installed onto the installation surface using various coupling mechanisms including, but not limited to, a fastener, an adhesive, and the like. In some implementations, the mounting track 110a may be mounted to an installation surface using an adhesive to facilitate alignment and

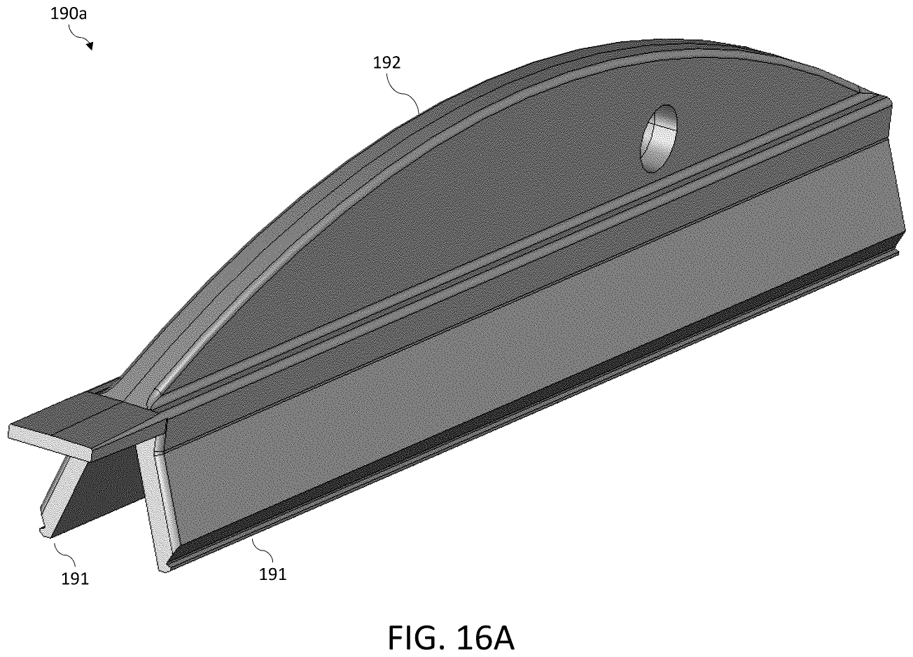

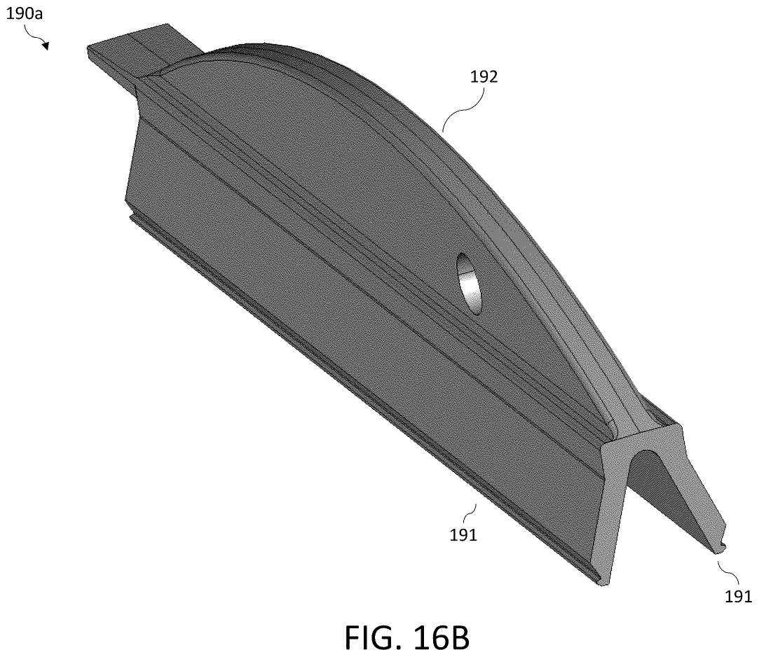

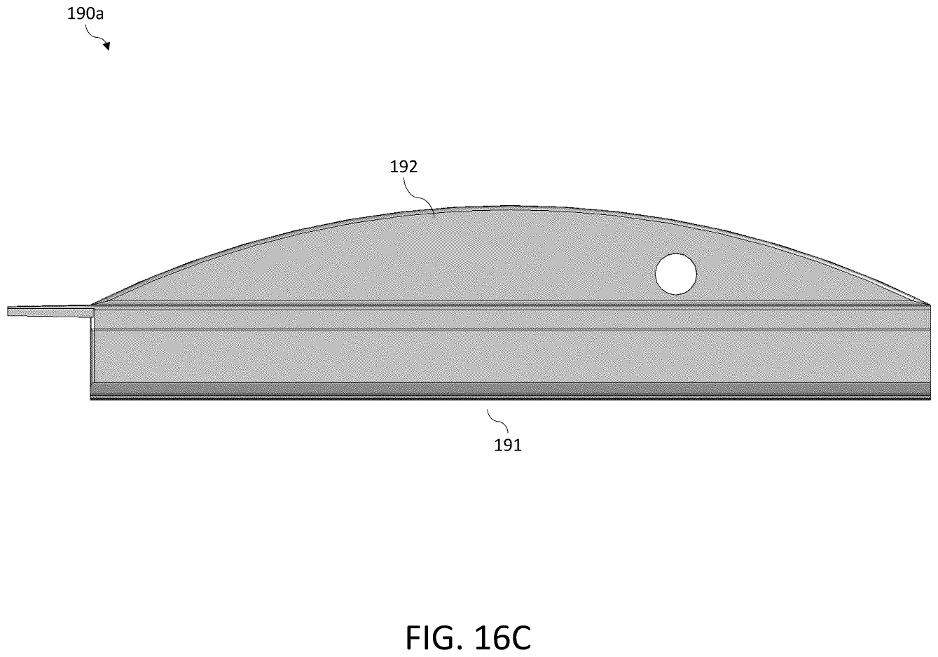

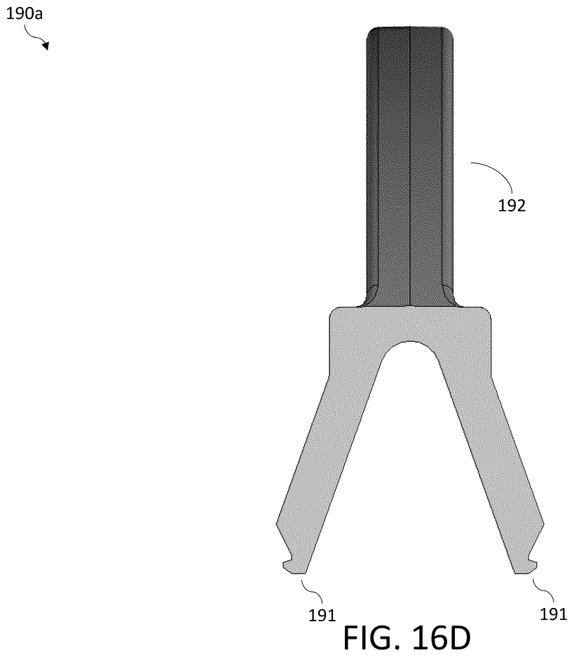

In some implementations, the installation of multiple mounting tracks 110a may be facilitated, in part, using an alignment tool. For example, FIGS. 16A-16D show several views of an example alignment tool 190a. The alignment tool 190a may be used to align two mounting tracks 110a such that the respective channels 111 of the mounting tracks 110a are contiguous. As shown, the alignment tool 190a may include a pair of rails 191 shaped and dimensioned to fit within the mounting channel 111 of the mounting track 110a. The alignment tool 190a may further include a handle 192.

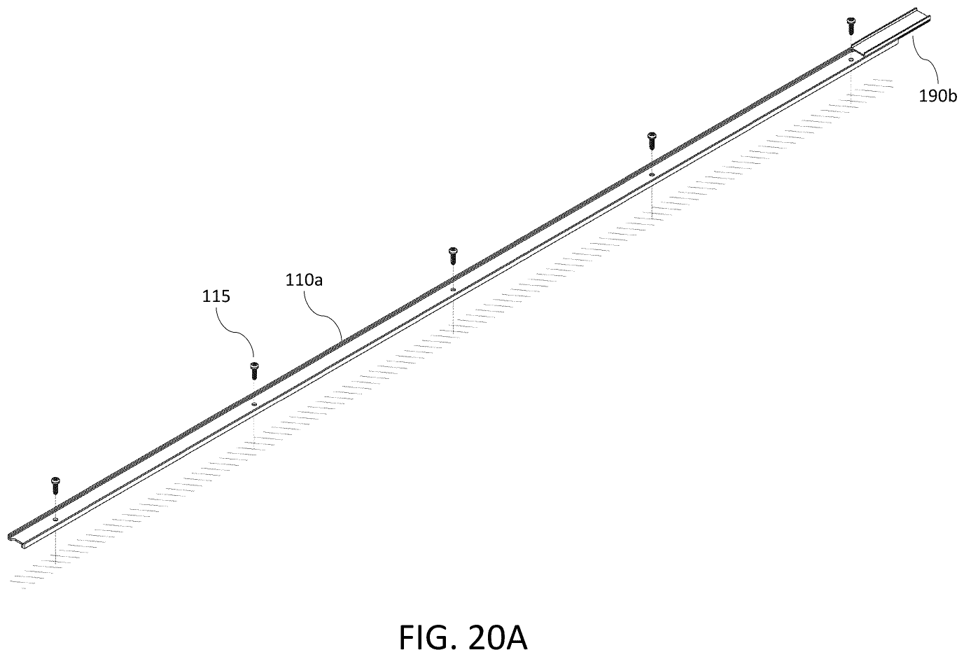

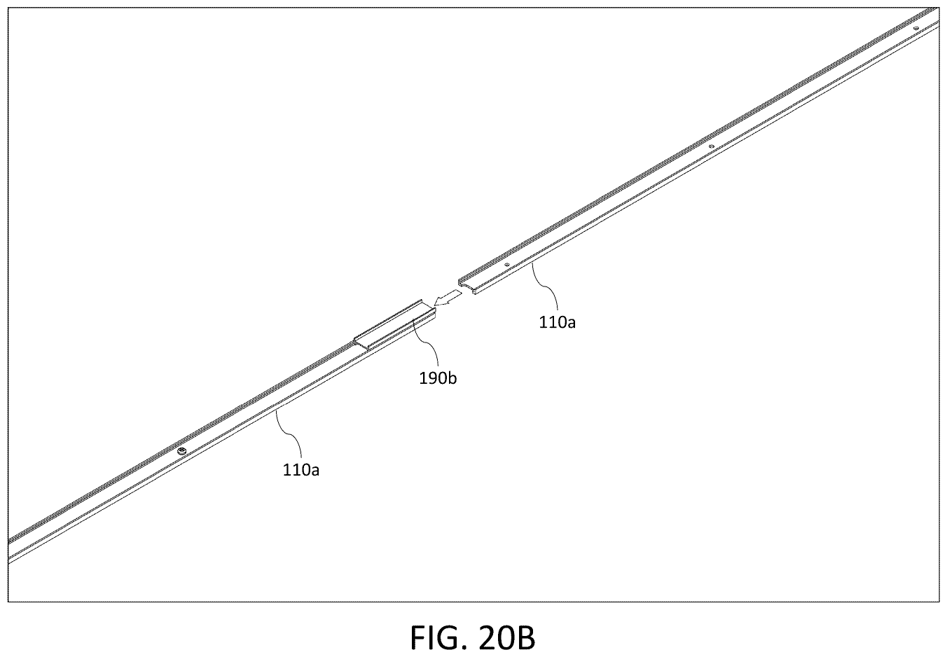

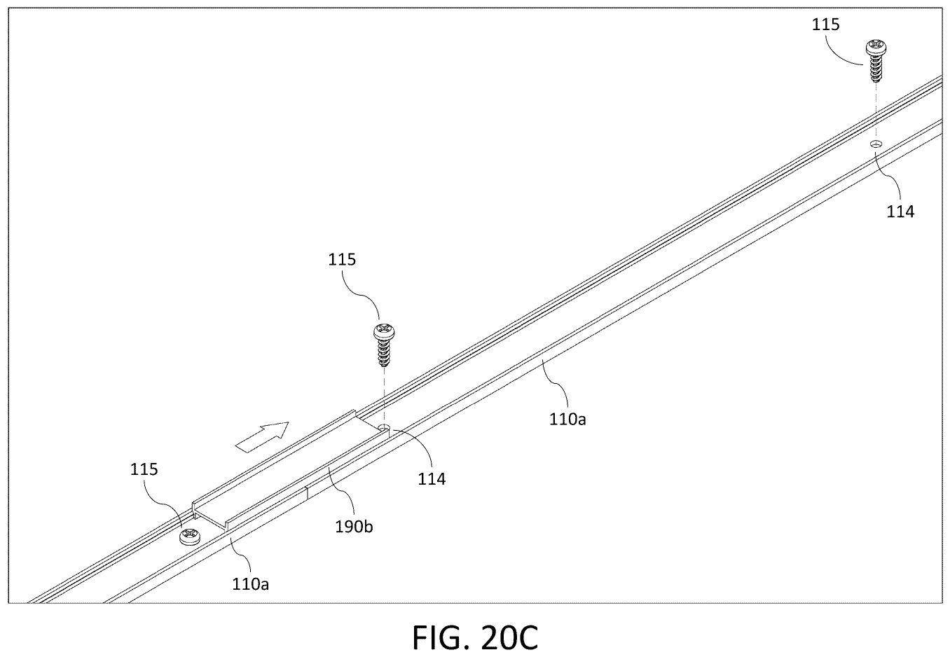

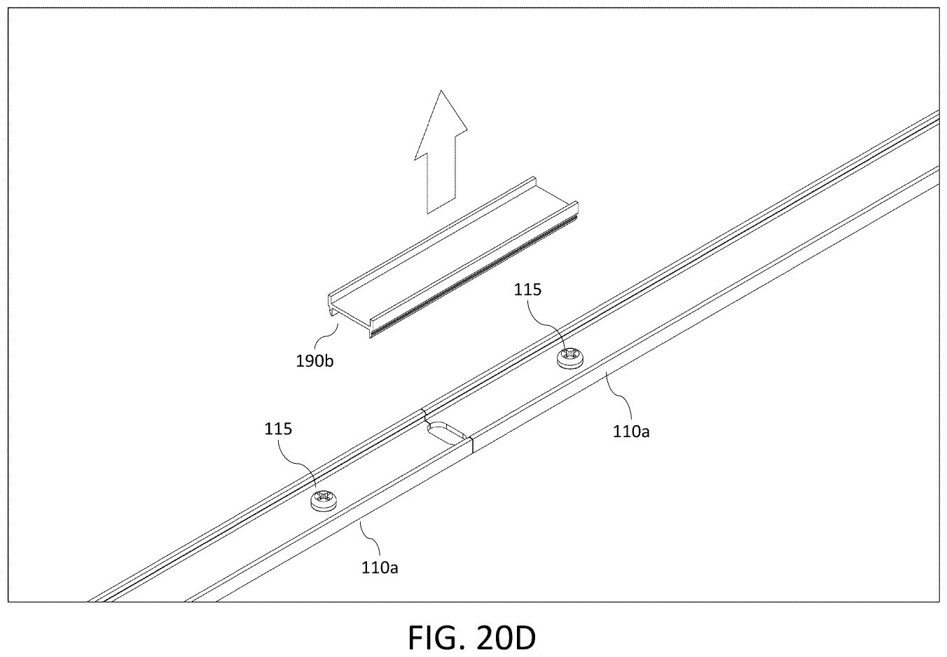

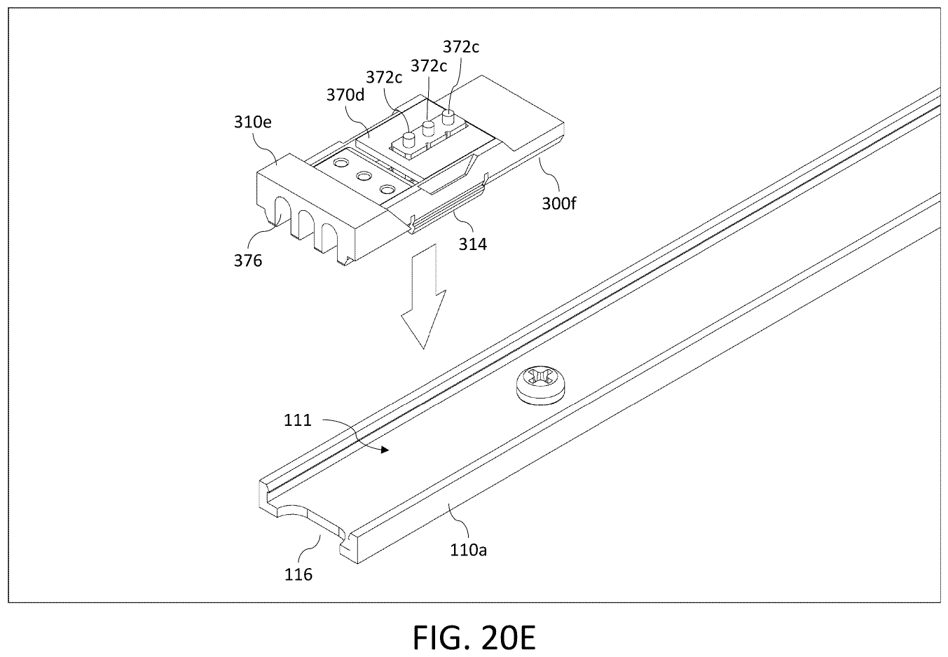

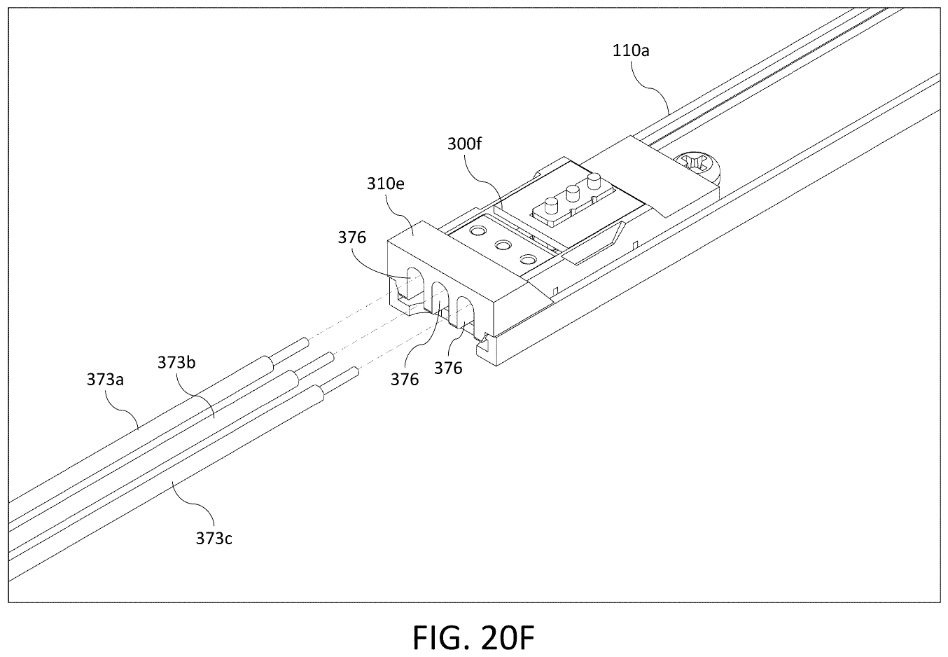

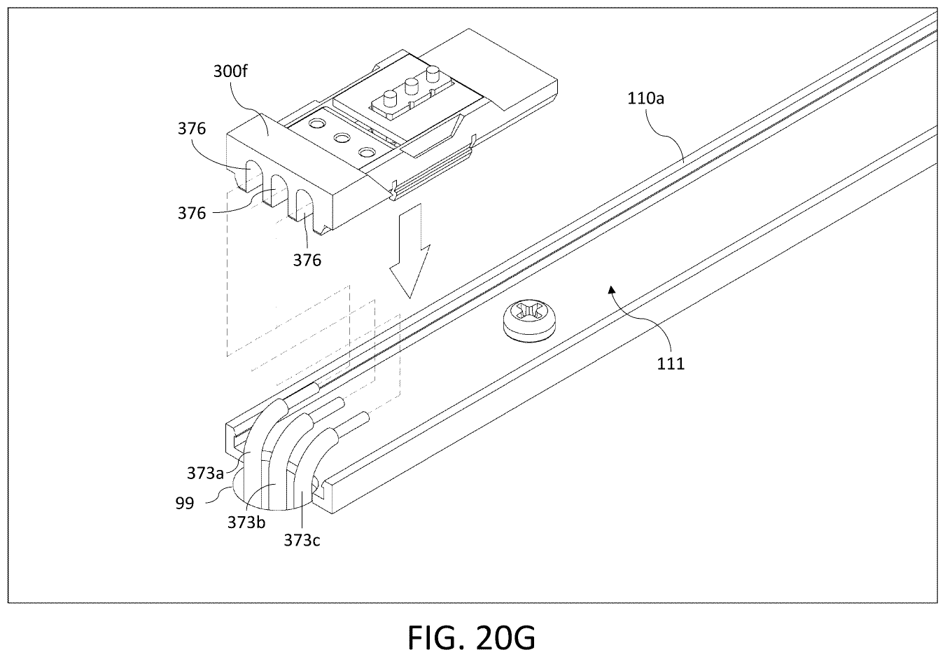

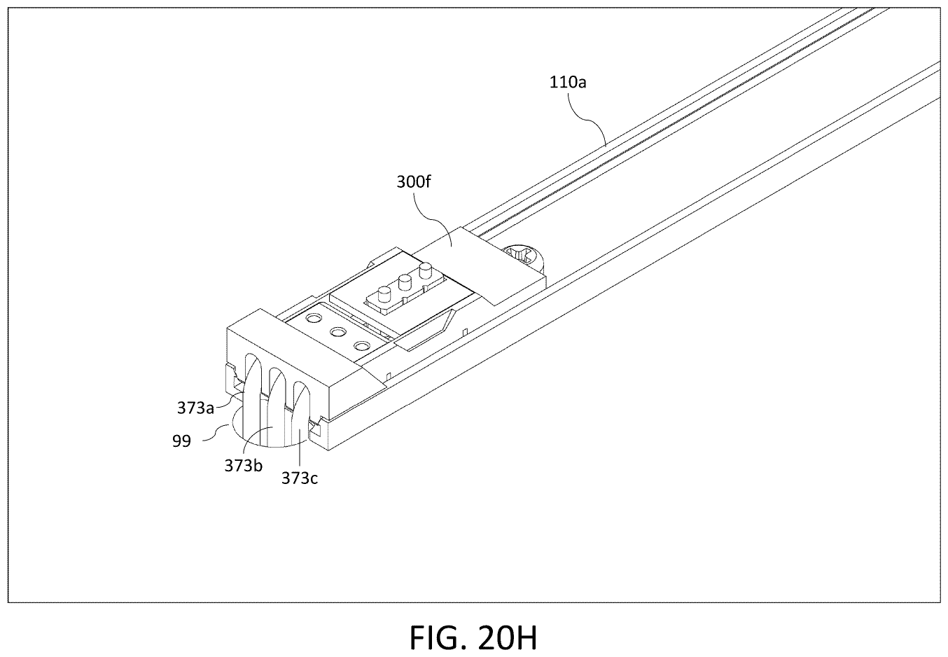

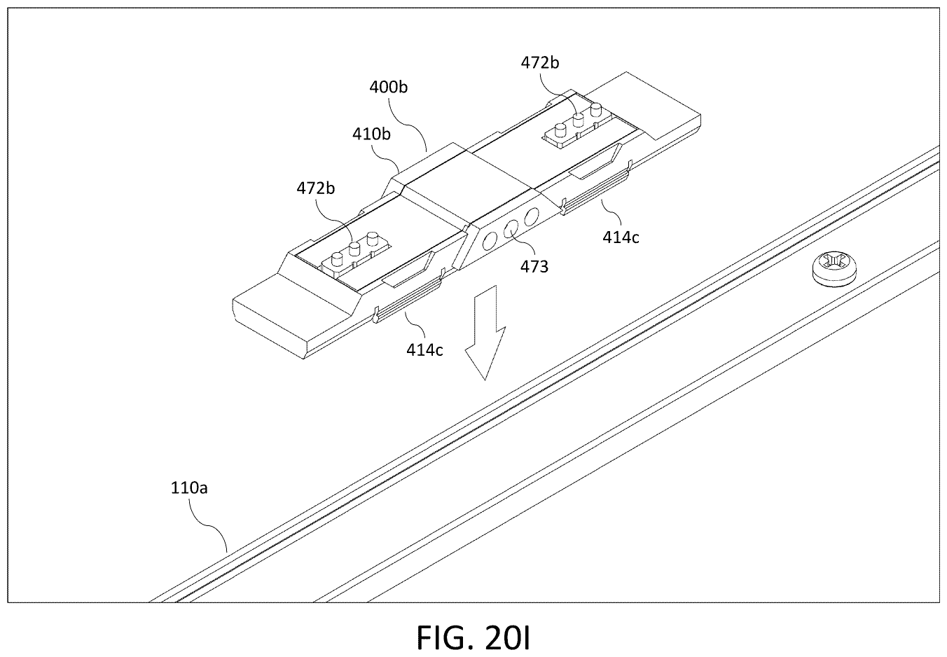

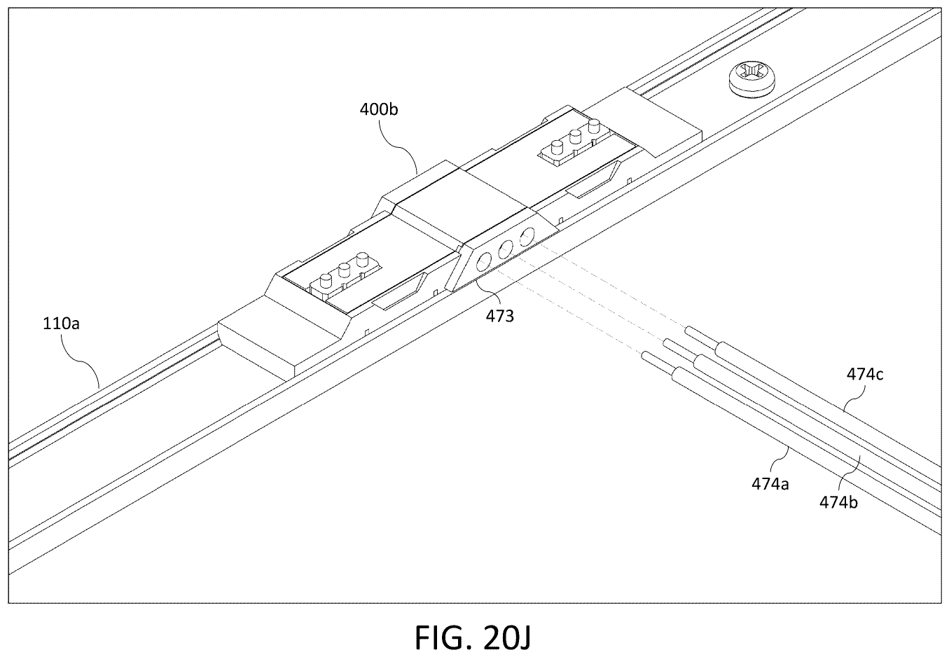

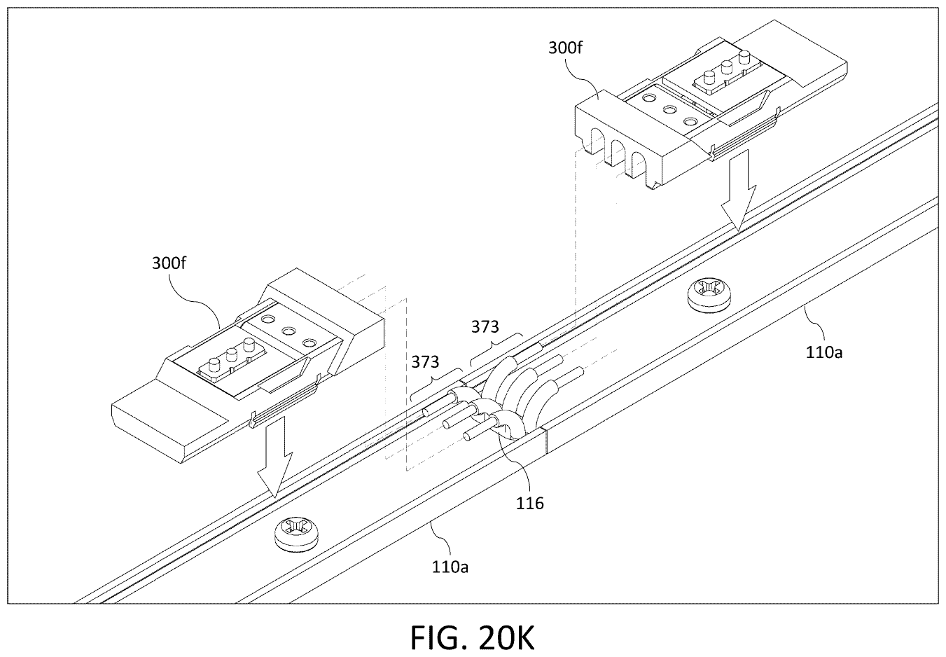

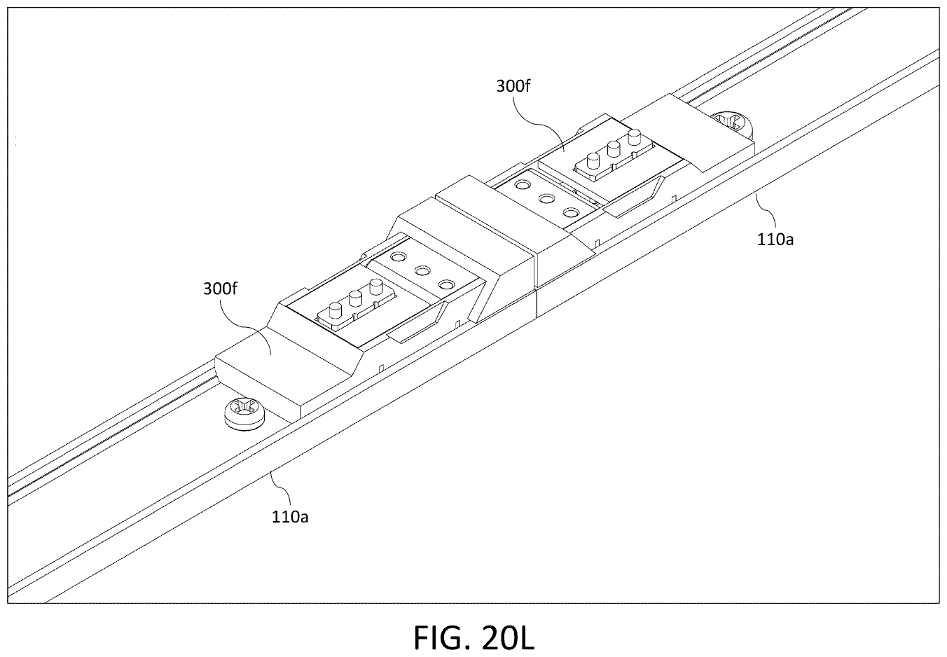

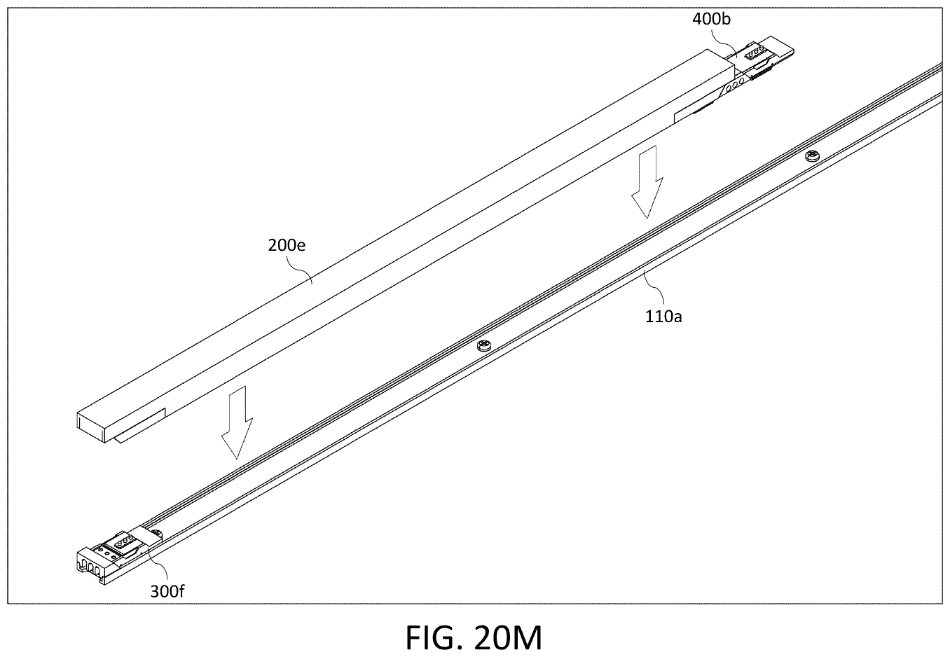

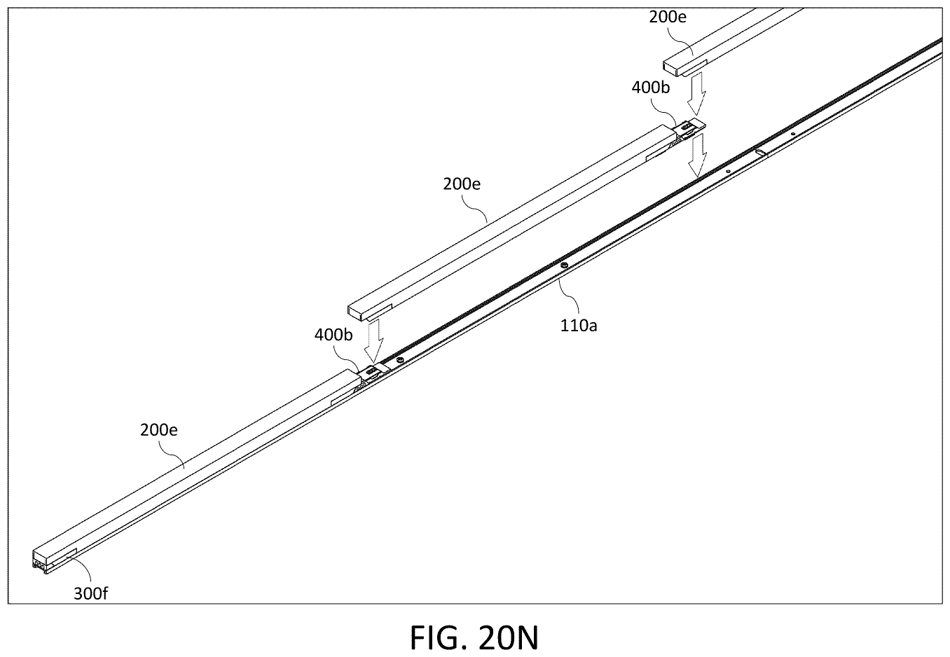

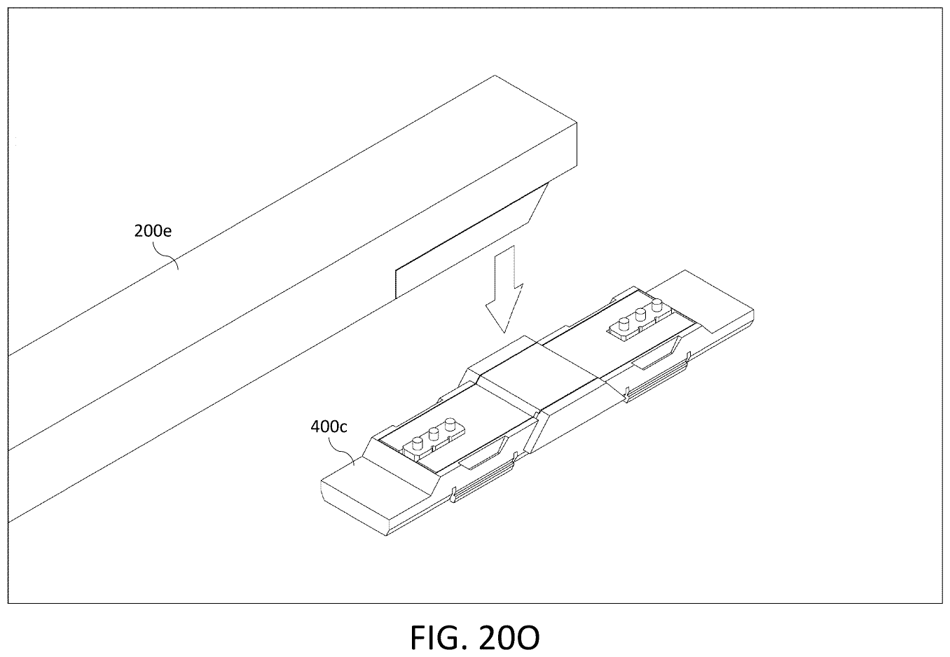

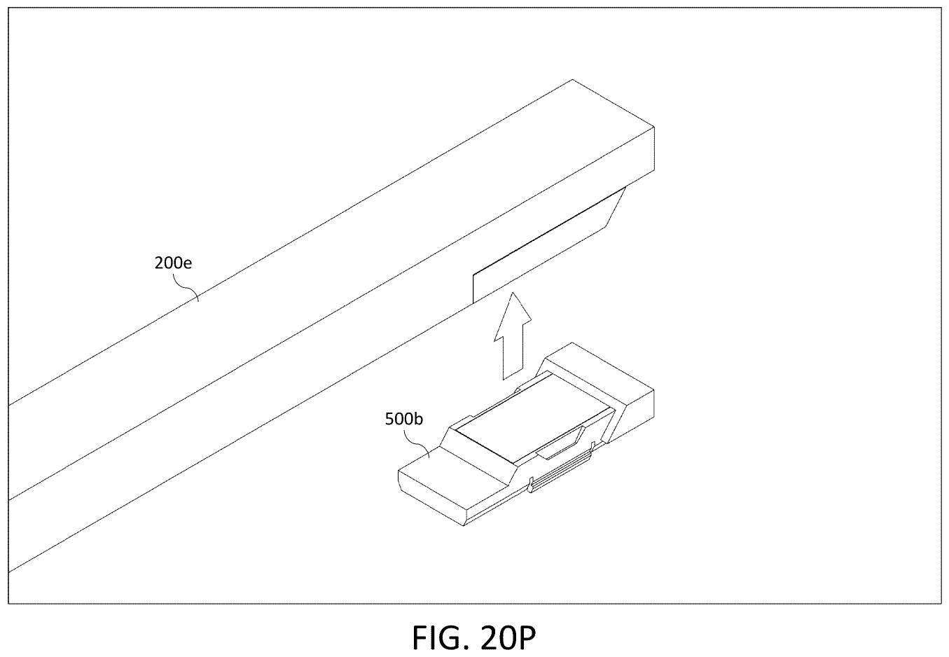

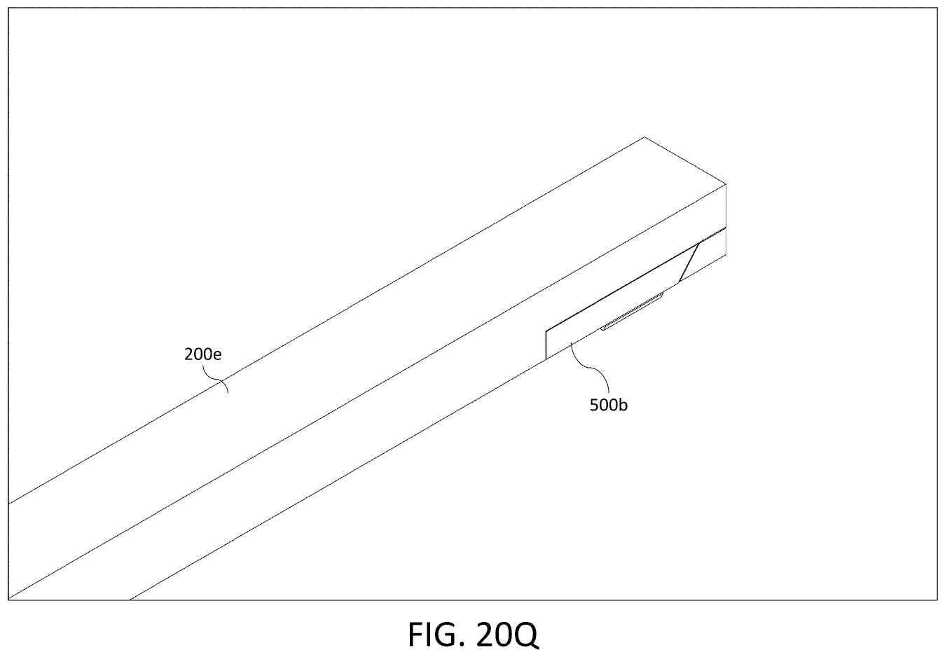

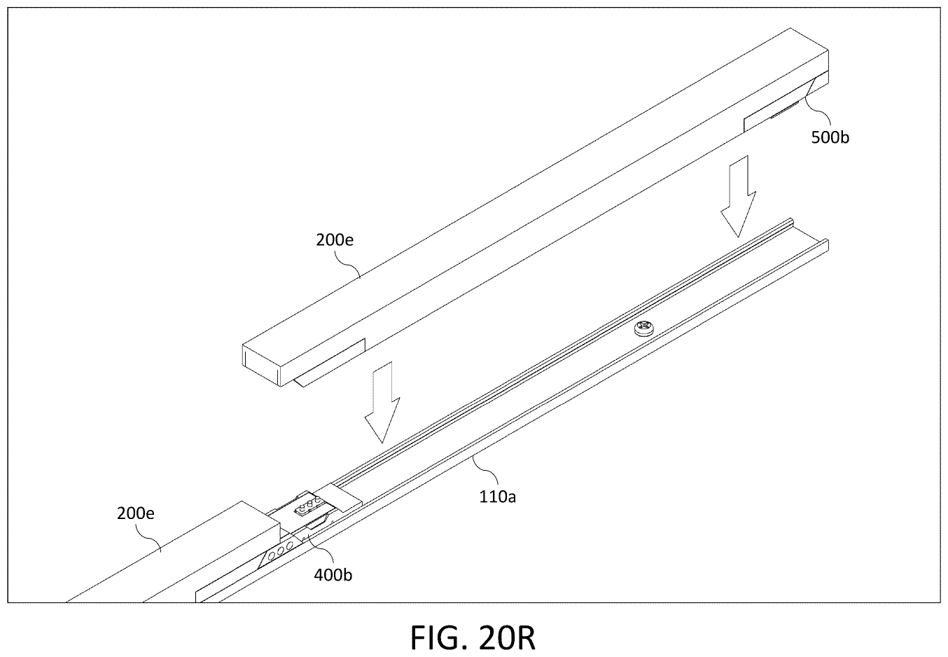

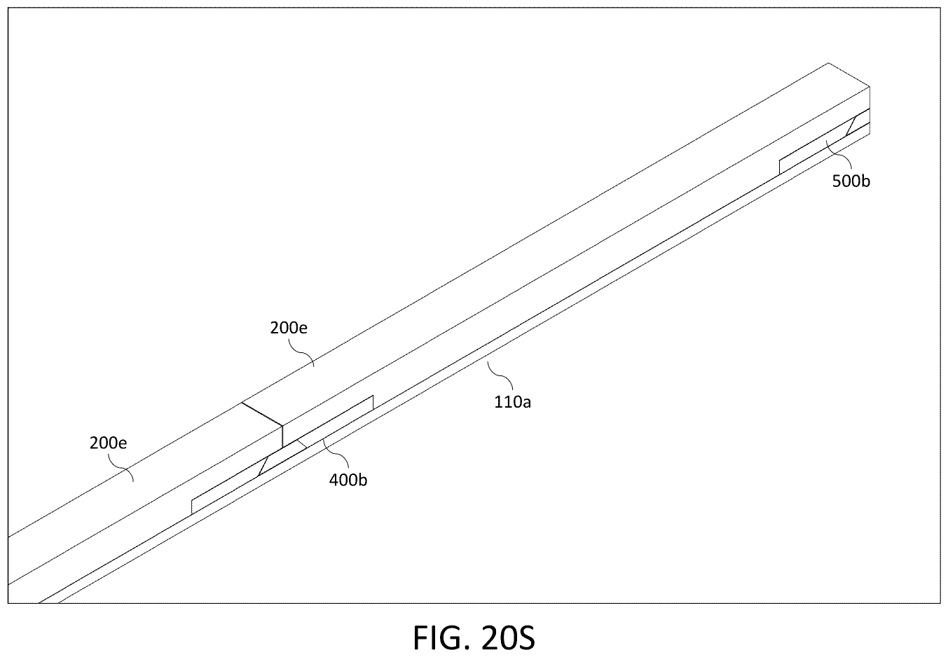

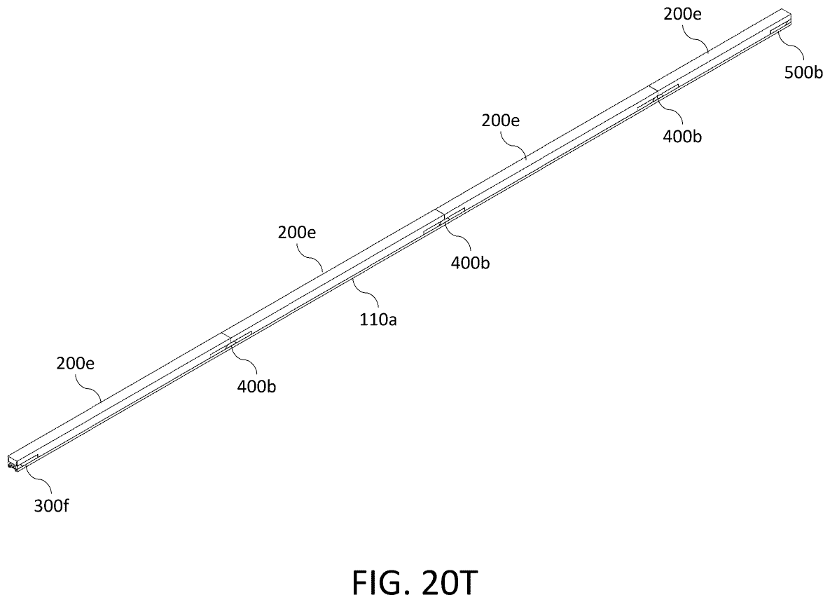

When installing more than one mounting track 110a for a linear lighting system, the alignment tool 190a may be inserted into the channel 111 of one mounting track 110a after that mounting track 110a is securely coupled to the installation surface. Thereafter, a second mounting track 110a may be aligned to the first mounting track 110a by slidably moving the alignment tool 190a such that the alignment tool 190a is partially disposed within each respective channel 111 of the first and second mounting tracks 110a (see also the use of the alignment tool 190b in FIGS. 20A-20C). The second mounting track 110a may then be securely coupled to the installation surface. In this manner, the alignment tool 190a may maintain alignment between the channels 111 of the first and second mounting tracks 110a.

In the example mounting track 110a, the base 113 may lie flat against the installation surface. Thus, the light bars 200a-200c, when mounted to the mounting track 110a, may be oriented such that the LEDs 272 in the light sources 270a-270c lie in a plane (e.g., a plane defined by the PCB 271) that is parallel with the installation surface. For example, if the linear lighting system is installed on a ceiling, the light bars 200a-200c may emit light directed along a vertically downward direction.

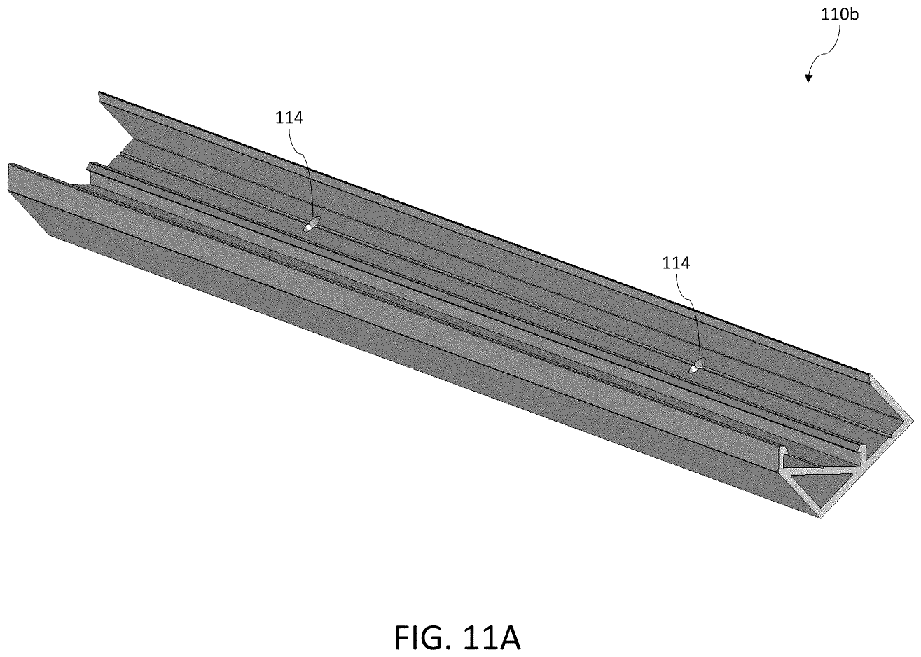

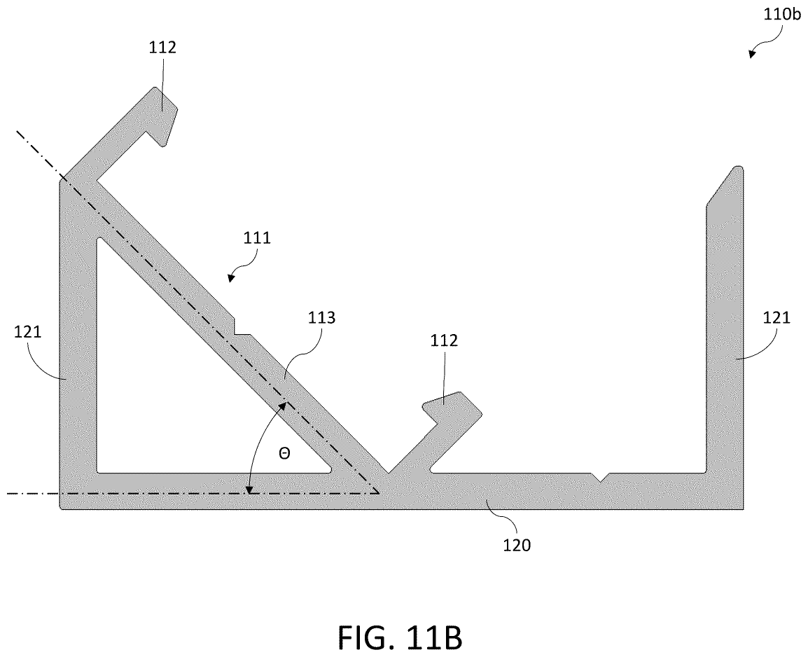

FIGS. 11A and 11B show several views of another example mounting track 110b that provides a way to mount one or more light bars at an angle relative to the installation surface in the environment. As shown, the mounting track 110b may include a base 120 that is securely coupled to the installation surface via fasteners (e.g., fasteners 115) inserted through corresponding fastener openings 114 formed on the base 120. The mounting track 110b may further include a pair of sidewalls 121 joined to the base 120 as shown in FIG. 11B. The mounting track 110b may further include the base 113, which is joined to one sidewall 121 and the base 120, and a pair of retaining walls 112 joined to the base 113. Together, the base 113 and the retaining walls 112 may form the mounting channel 111 as before. However, in this example, the mounting channel 111 may be oriented at an angle, Θ, relative to the base 120 and, hence, the installation surface. Thus, the light bars 200a-200c, when installed onto the mounting track 110b, may be oriented such that the LEDs 272 in the light sources 270a-270c lie in a plane (e.g., a plane defined by the PCB 271) that is oriented at an angle relative to the installation surface.

In the example mounting track 110b shown in FIGS. 11A and 11B, the angle, Θ, of the mounting channel 111 with respect to the base 120 may is equal to about 45 degrees. However, it should be appreciated that this is a non-limiting example. More generally, the angle, Θ, between the mounting channel 111 and the base 120 may range from about 30 degrees to about 60 degrees, including all sub-ranges and values in between. For example, the angle, Θ, may be equal to about 30 degrees, about 35 degrees, about 40 degrees, about 45 degrees, about 50 degrees, about 55 degrees, or about 60 degrees.

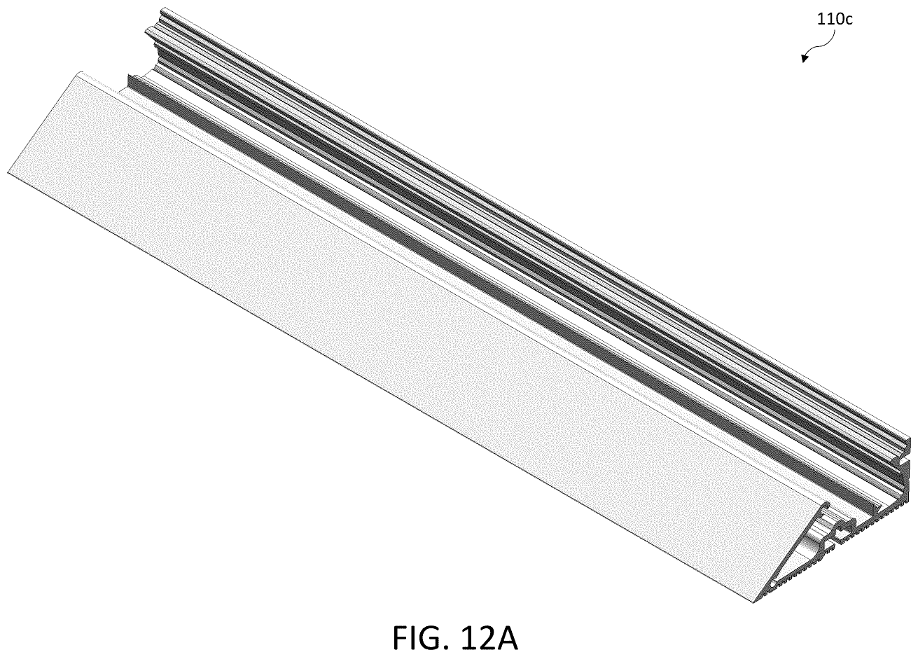

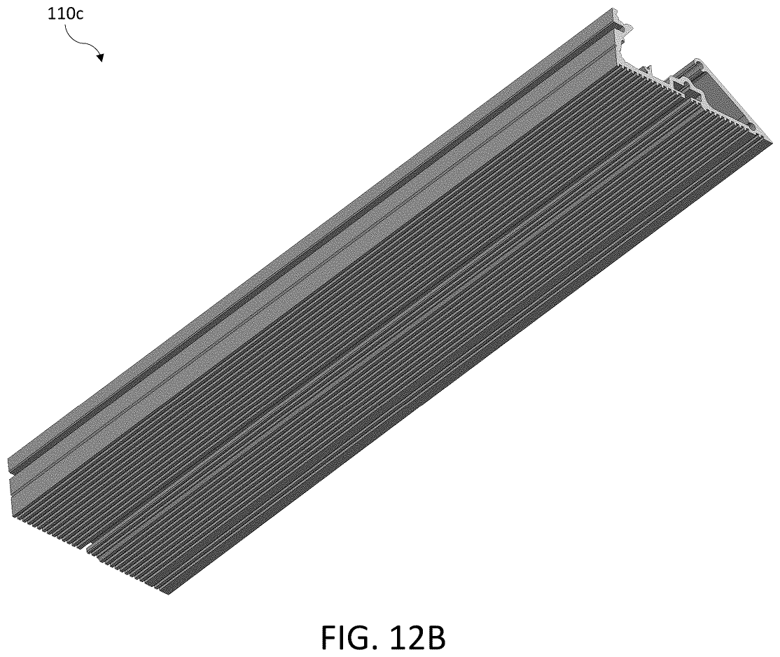

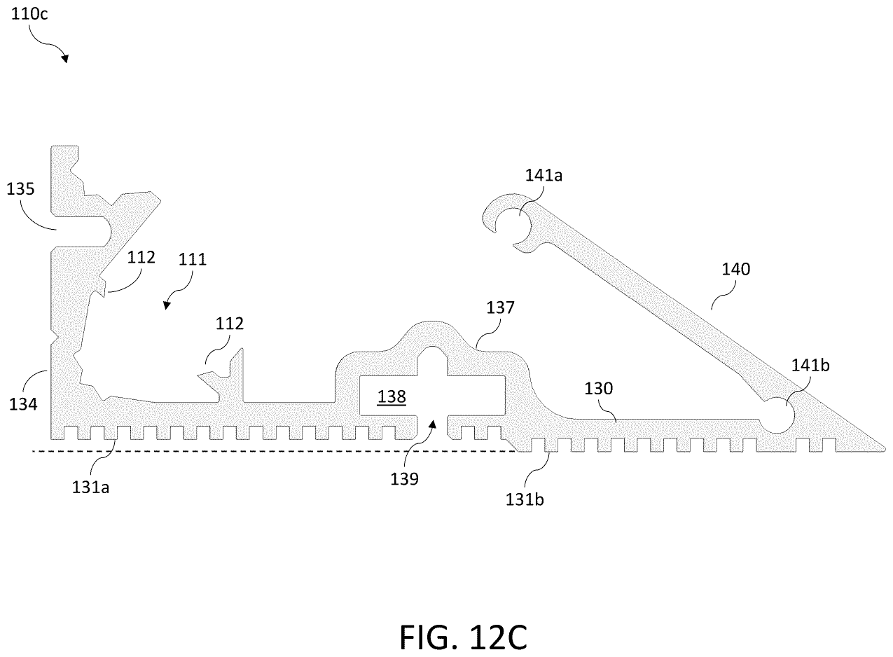

FIGS. 12A-12C show several views of yet another example mounting track 110c to support a knife-edge installation for various accent lighting applications, such as cove lighting, wall wash lighting, and the like. As shown, the mounting track 110c may include a base 130 and sidewalls 134 and 140 joined to opposing sides of the base 130. The base 130 and the sidewall 134 may facilitate installation of the mounting track 110c onto, for example, the corner of a drop ceiling. The sidewall 140 and the base 130 may together provide a knife-edge profile that limits or, in some instances, prevents occupants in the environment from having a direct line of sight to the light bars supported by the mounting track 110c.

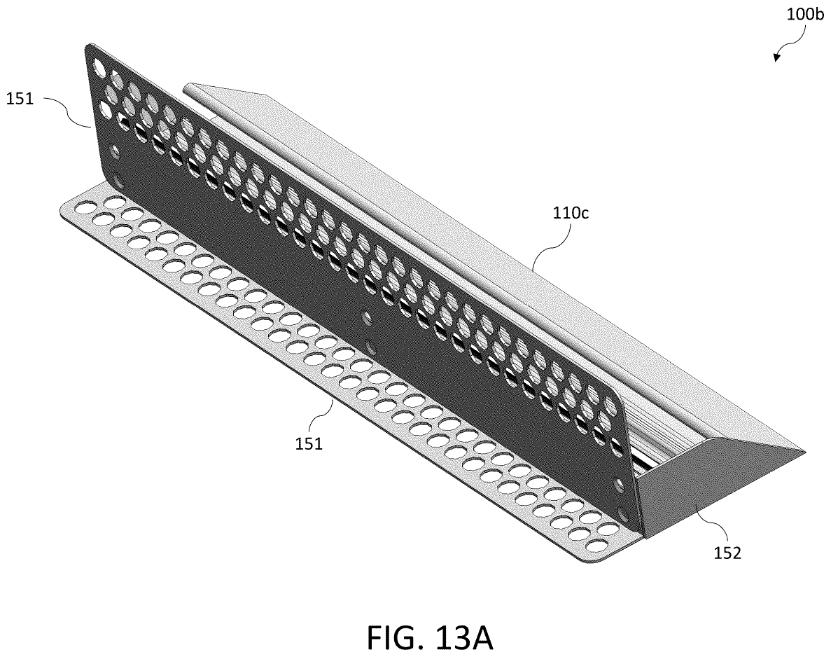

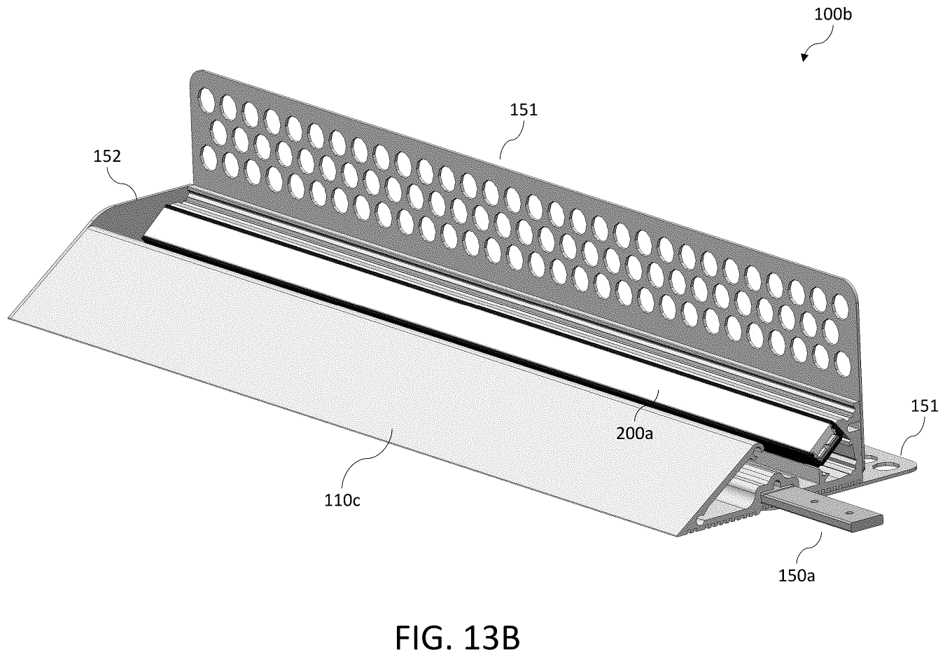

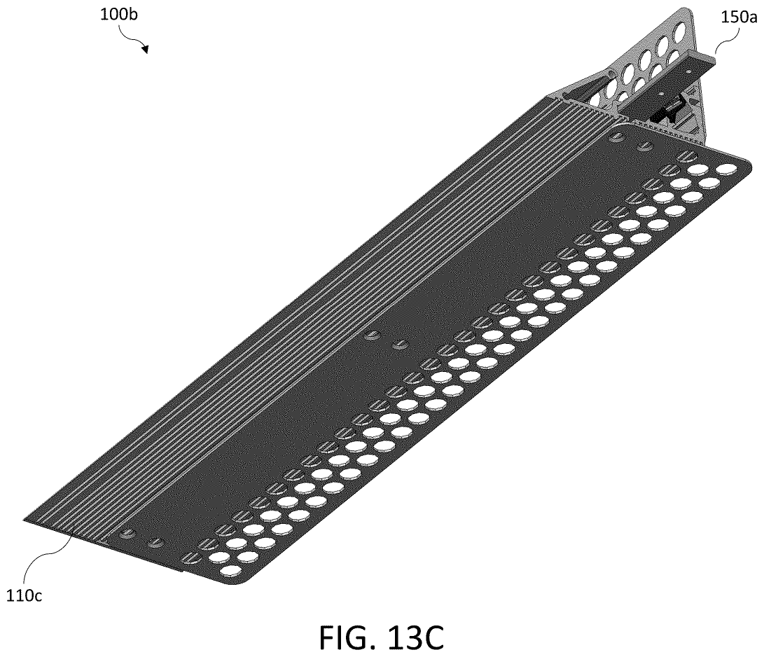

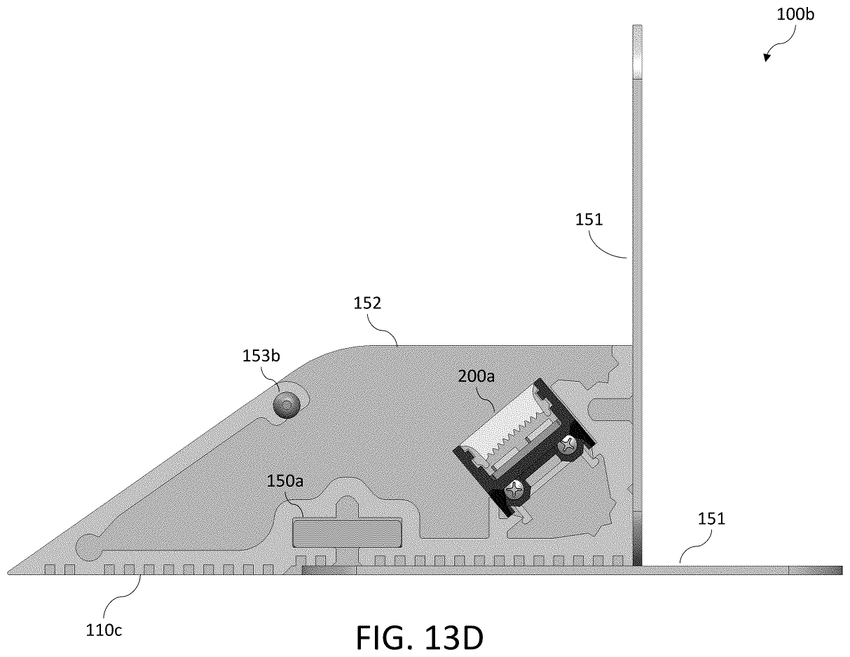

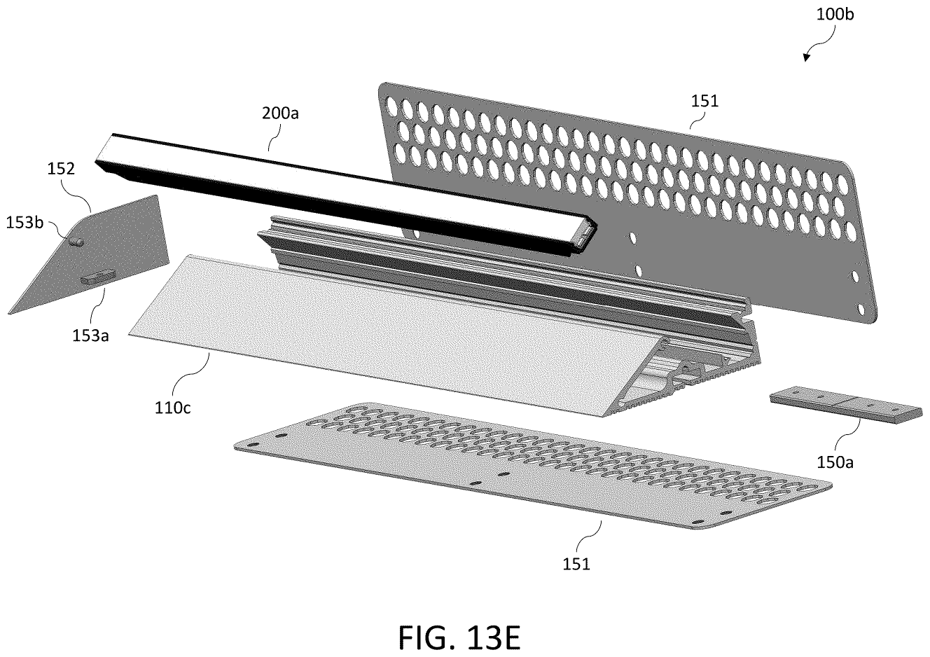

As shown in FIG. 12C, the base 130 may include bottom surfaces 131a and 131b. The surface 131a may be vertically offset from the surface 131b (see, for example, the dotted line in FIG. 12C) to accommodate, for example, the thickness of a mud-in plate 151 (see, for example, FIG. 13D). FIG. 12C further shows the mounting track 110c may include a wall 137 joined to the base 130 to define a channel 138. A bracket 150a may be inserted into the channel 138, for example, to align the mounting track 110c to another mounting track 110c. In some implementations, the bracket 150a may be securely coupled to the mounting track 110c by inserting a fastener (not shown) through a slot 139 adjoining the channel 138 and a fastener opening on the bracket 150a. In some implementations, the fastener may be further inserted through a fastener opening on the mud-in plate 151 to securely couple the mud-in plate 151 to the mounting track 110c. The sidewall 134 may also support a mud-in plate 151 (see, for example, FIG. 13D). The mud-in plate 151 may be securely coupled to the sidewall 134 via one or more fasteners inserted through corresponding fastener openings on the mud-in plate 151 and a slot 135 formed along the sidewall 134.

FIG. 12C further shows the mounting track 110c may include retaining walls 112 formed onto the sidewall 134 and the base 130 to define a mounting channel 111 to support the light bars and connectors disclosed herein. In this example, the mounting channel 111 may be oriented at a 45 degree angle with respect to the base 130. However, similar to the mounting track 110b, it should be appreciated that this is a non-limiting example. More generally, the angle between the mounting channel 111 and the base 130 may range from about 30 degrees to about 60 degrees, including all sub-ranges and values in between. The length of the sidewall 140 may be adjusted depending on the orientation of the mounting channel 111, in part, to avoid blocking light emitted by the light bars mounted to the mounting channel 111.

The sidewall 140 may be joined to the base 130 at an angle as shown in FIG. 12C. In some implementations, the sidewall 140 may further define openings 141a and 141b to facilitate connection with other components, such as an end plate (see, for example, the end plate 152 in FIGS. 13D and 13E).

As an illustrative example, FIGS. 13A-13E show a linear lighting system 100b assembled using the mounting track 110c. As shown, the lighting system 100b may include a light bar 200a mounted to the mounting channel 111 formed by the mounting track 110c. Although not shown, it should be appreciated that other light bars (e.g., the light bars 200b and 200c) and/or connectors (e.g., the input connectors 300a or 300b, the middle connector 400a, or the end connector 500a) may be readily mounted to the mounting channel 111.

The lighting system 100b may further include an end plate 152. As shown in FIG. 13E, the end plate 152 may be securely coupled to one end of the mounting track 110c via connectors 153a and 153b inserted into the channel 138 and the opening 141a, respectively. The lighting system 100b may further include a pair of mud-in plates 151 mounted to the surface 131a of the base 130 and the sidewall 134. As shown, the mud-in plates 151 may be oriented at a right angle with respect to one another to facilitate attachment to a corner of a wall or a ceiling (e.g., a corner of a drop ceiling). The lighting system 100b may also include a bracket 150a inserted into the channel 138, e.g., to facilitate connection with another mounting track 110c and/or to securely couple one mud-in plate 151 to the mounting track 110c as described above.

In the foregoing examples, the mounting tracks may support light bars arranged along a straight path. However, it should be appreciated that these are non-limiting examples. In some implementations, the mounting tracks disclosed herein may allow a light bar to be installed along a path with one or more vertices.

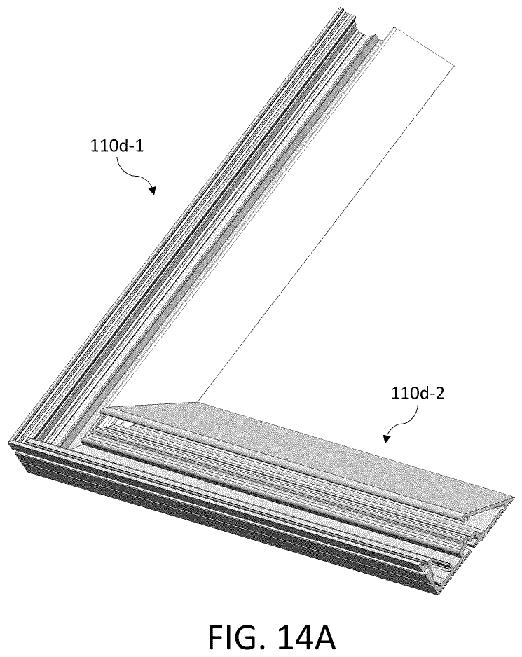

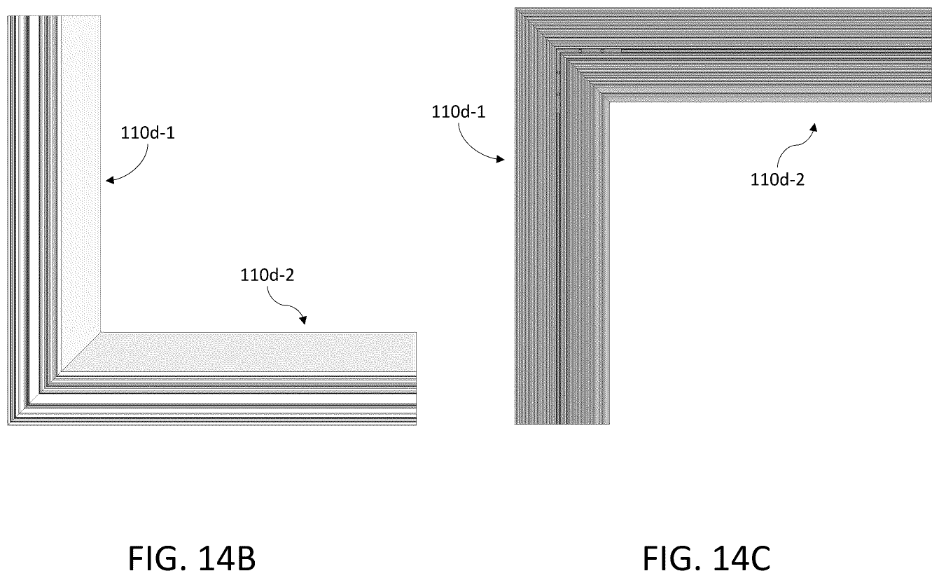

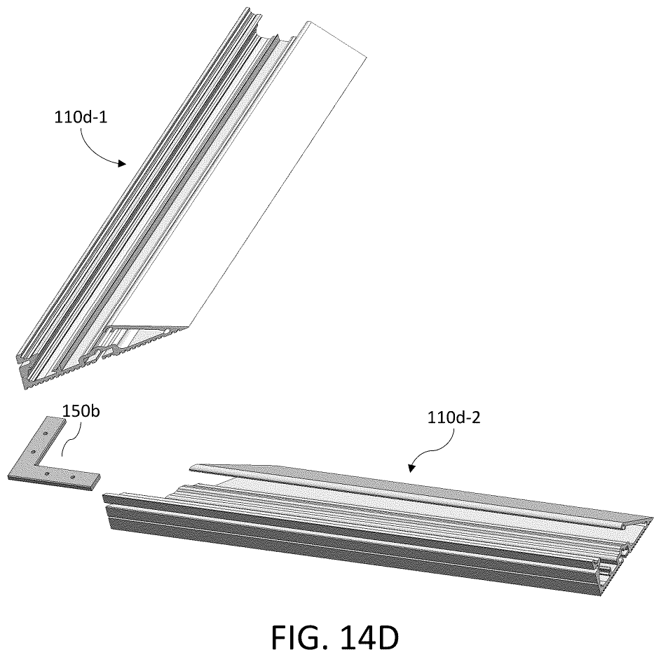

In one non-limiting example, FIGS. 14A-14D show a pair of mounting tracks 110d-1 and 110d-2 coupled together via a bracket 150b to form a path with a right angle. The mounting tracks 110d-1 and 110d-2 may be used, for example, to install a linear lighting system that extends around a corner of the environment. Each of the mounting tracks 110d-1 and 110d-2 may be based on the mounting track 110c and, hence, used as part of a knife-edge installation. Accordingly, the mounting tracks 110d-1 and 110d-2 may incorporate one or more of the same components and/or features from the mounting track 110c. For brevity, repeated discussion of these components and/or features are not provided below unless indicated otherwise.

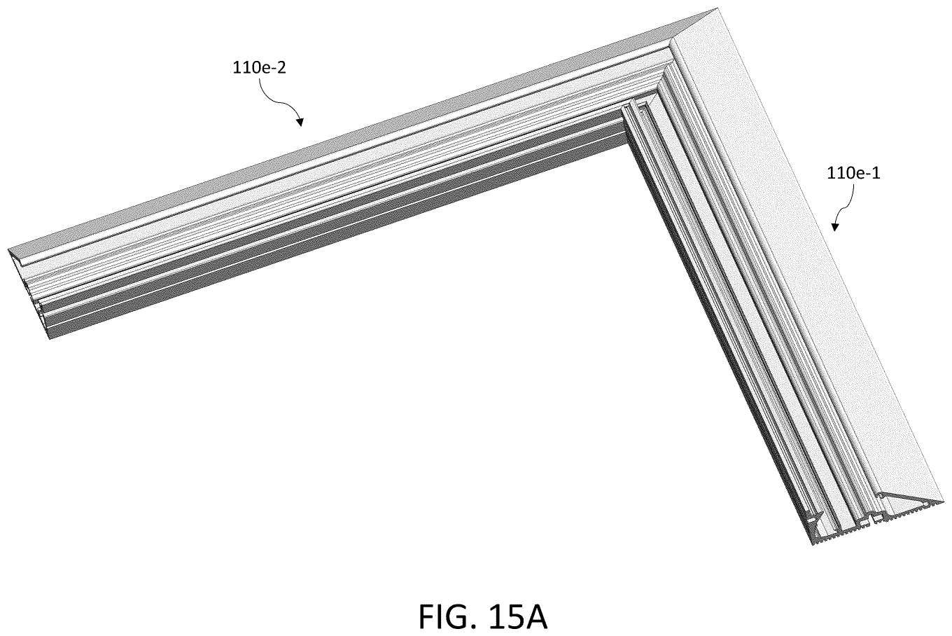

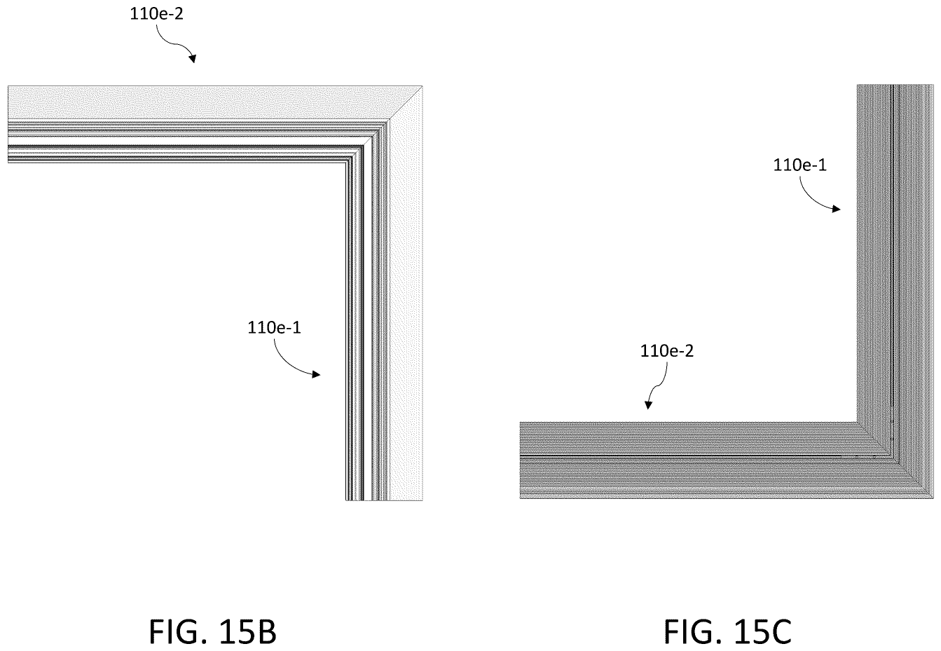

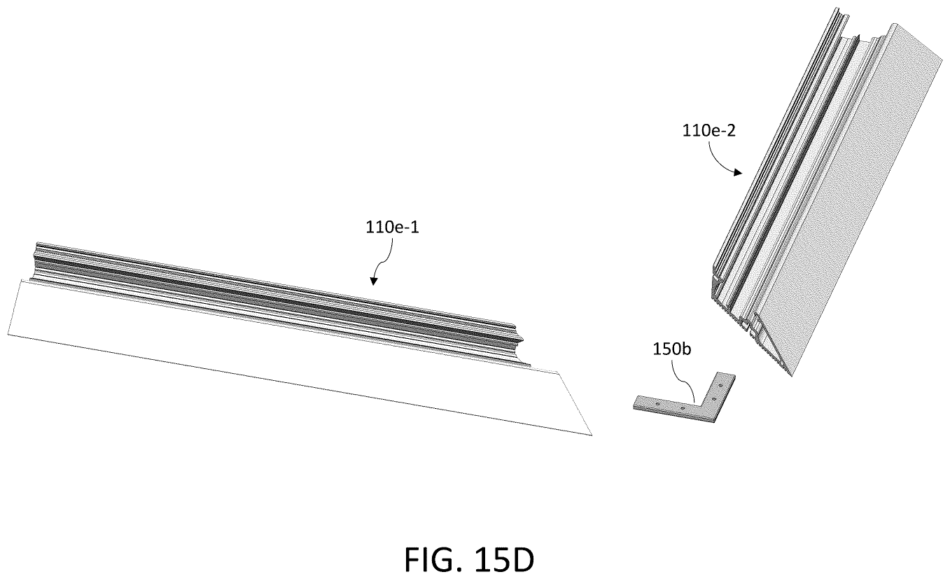

The mounting tracks 110d-1 and 110d-2 may each include one end oriented at a 45 degree angle such that, when coupled together, the mounting tracks 110d-1 and 110d-2 are oriented 90 degrees relative to each other (see, for example, FIGS. 14B and 14C). In this example, the respective sidewalls 140 of the mounting tracks 110d-1 and 110d-2, which define the knife-edge profile, may be disposed along an inner portion of the corner formed by the mounting tracks 110d-1 and 110d-2 as shown in FIG. 14B. Thus, the mounting tracks 110d-1 and 110d-2 may be installed, for example, onto a corner of a room where two walls join a ceiling. In another non-limiting example, FIGS. 15A-15D show a pair of mounting tracks 110e-1 and 110e-2 where the respective sidewalls 140 are disposed along an outer portion of the corner formed by the mounting tracks 110e-1 and 110e-2.

### 1.6 An Example Method of Installing a Linear Lighting System

As described in the above sections, the various components of the linear lighting system disclosed herein may be mechanically and electrically coupled together using tool-free mechanisms. Following below is an example method for installing the linear lighting system 100c shown in FIG. 19A. It should be appreciated that the various steps may be readily adapted and/or applied to the installation of the linear lighting systems 100a and 100b described above.

FIGS. 20A-20T illustrate various steps in the installation of the linear lighting system 100c. FIG. 20A shows the mounting track 110a may be installed onto an installation surface by inserting fasteners 115 through corresponding fastener openings 114 on the mounting track 110a and into the installation surface. FIG. 20B shows additional mounting tracks 110a may be connected to the mounting track 110a installed in FIG. 20A. The alignment between two mounting tracks 110a may be facilitated, in part, by an alignment tool 190b. As shown in FIGS. 20B and 20C, the alignment tool 190b may be disposed in the channel 111 of the first mounting track 110a and slid onto the channel 111 of the second mounting track 110a. While the alignment tool 190b is partially disposed within the respective channels 111 of the two mounting tracks 110a, the second mounting track 110a may be securely coupled to the installation surface via fasteners 115. Thereafter, the alignment tool 190b may be removed and reused to install additional mounting tracks 110a.

FIG. 20E shows the input connector 300f may then be inserted onto the mounting track 110a and secured via the tabs 314. As shown, the input connector 300f may include a housing 310e with multiple wiring ports 376 to facilitate connection between corresponding wires from an LED driver or a LED controller and the input electronics 370d. The input electronics 370d may further include multiple pogo-pin connectors 372c to connect to a light bar. In one example, FIG. 20F shows the wires 373a-373c may be routed along the installation surface and inserted through the wiring ports 376. In another example, FIG. 20G shows the wires 373a-373c may pass through an opening 99 formed on the installation surface. For instance, the wires 373a-373c may come from within a wall space or a ceiling space. FIG. 20H shows the wires 373a-373c from FIG. 20G connected to the input connector 300f.

FIG. 20I shows the middle connector 400b may be inserted onto the mounting track 110a and secured via the tabs 414c. As shown, the middle connector 400f may include a housing 410b supporting electronics 470b, which includes two sets of pogo-pin connectors 472b. FIG. 20I further shows the housing 410b may include multiple wiring ports 473. The wiring ports 473 may facilitate a connection with wires 474a, 474b, and 474c shown in FIG. 20J. In some implementations, the wires 474a, 474b, and 474c may provide a side feed to augment or substitute the electrical power and control signals provided by the input connector 300f. As shown in FIG. 20J, the wires 474a-474c may be inserted through the wiring ports 473 and coupled to the electronics 470b after the middle connector 400b is mounted to the mounting track 110a.

In some implementations, two input connectors 300f may be installed onto the mounting track 110a adjacent to one another to supply electrical power and/or control signals to different sub-runs of the linear lighting system. For example, FIG. 20K shows two sets of wires 373 may pass through an opening 99 on the installation surface and an opening formed by slots 116 formed at the ends of the mounting tracks 110a. As shown, the input connectors 300f may be oriented in opposite directions when mounted onto the mounting tracks 110a. Each set of wires 373 may connect to a corresponding input connector 300f. Once each input connector 300f is mounted onto the mounting tracks 110a and electrically coupled to corresponding sets of wires 373, the input connectors 300f may be slidably moved to abut one another as shown in FIG. 20L. In this manner, the installation of a light bar onto each of the input connectors 300f may give the appearance that the light bars are contiguous despite receiving power separate from one another.

FIG. 20M shows the light bar 200e may be mounted onto the mounting track 110a after the input connector 300f is installed. In some implementations, a middle connector 400b may be coupled to the light bar 200e and the light bar 200e and the middle connector 400b may together be mounted to the mounting track 110a. This alleviates the need to precisely position the middle connector 400b on the mounting track 110a. This process may thereafter be repeated for each subsequent light bar 200e in the lighting system 100c. For example, FIG. 20N shows another pair of light bars 200e may be mounted to the mounting track 110a one after the other. Each light bar 200e may be mechanically and electrically coupled to either the input connector 300f or the middle connector 400b.

For the last light bar 200e in the run, the last middle connector 400c may be removed from the light bar 200e if present as shown in FIG. 20O. Thereafter, FIG. 20P shows an end cover 500b may be installed onto the end of the light bar 200e in FIG. 20O. As described above, the end cover 500b may not include any electronics. Rather, the end cover 500b may only provide features to mechanically couple the end of the last light bar 200e to the mounting track 110a. FIG. 20Q shows the last light bar 200e with the end cover 500b installed. FIG. 20R shows the last light bar 200e being mounted to the mounting track 110a. FIG. 20S shows the last light bar 200e installed onto the mounting track 110a. FIG. 20T shows the completed linear lighting system 100c.

If a light bar requires servicing and/or replacement after the linear lighting system is installed, the light bar may be readily removed, for example, by pulling on the light bar with sufficient force to disengage the magnetic coupling mechanism and the snap-fit connection. It should be appreciated, however, that the light bar may be removed in other ways. In another example, the light bar may be removed by removing the optic (e.g., peeling the flexible optic from the housing) and grabbing the light bar from inside the housing. In another example, a touch latch mechanism may be incorporated to facilitate removal of the light bar. The mechanism may be a spring-actuated mechanism that moves the light bar between two positions, e.g., a first position where the light bar is fully disposed within the mounting channel and second position where the light bar protrudes out of the mounting channel to provide a surface to grab. The mechanism may be actuated by pressing onto a portion of the light bar, e.g., the optic. In yet another example, a portion of the light bar may be magnetic and/or magnetizable. A separate magnet may be brought in close proximity to the portion of the light bar to pull the light bar out of the mounting channel of the mounting track.

### 2. An Example LED Driver and LED Controller

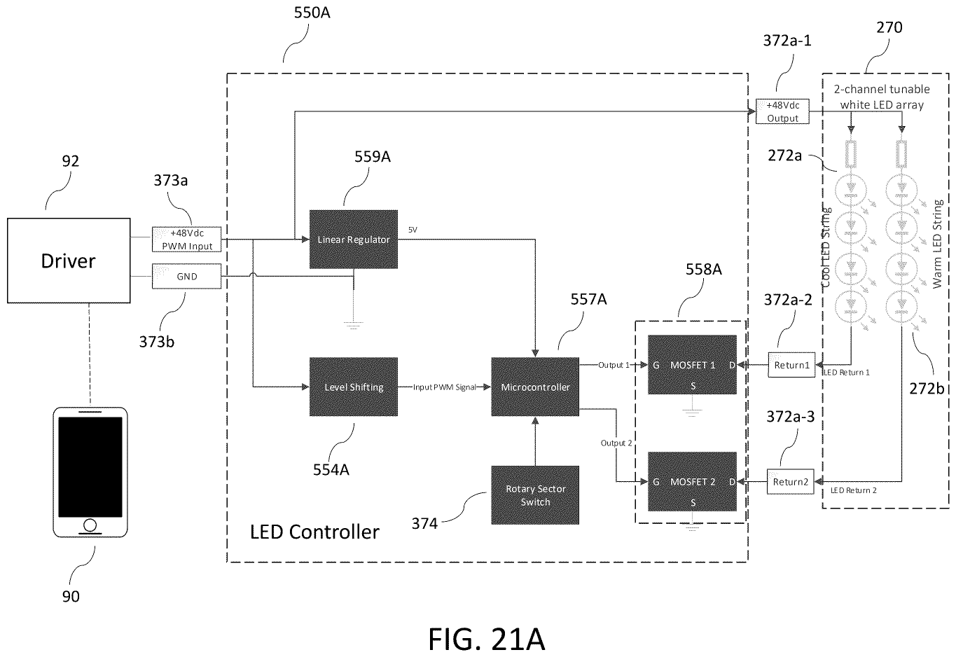

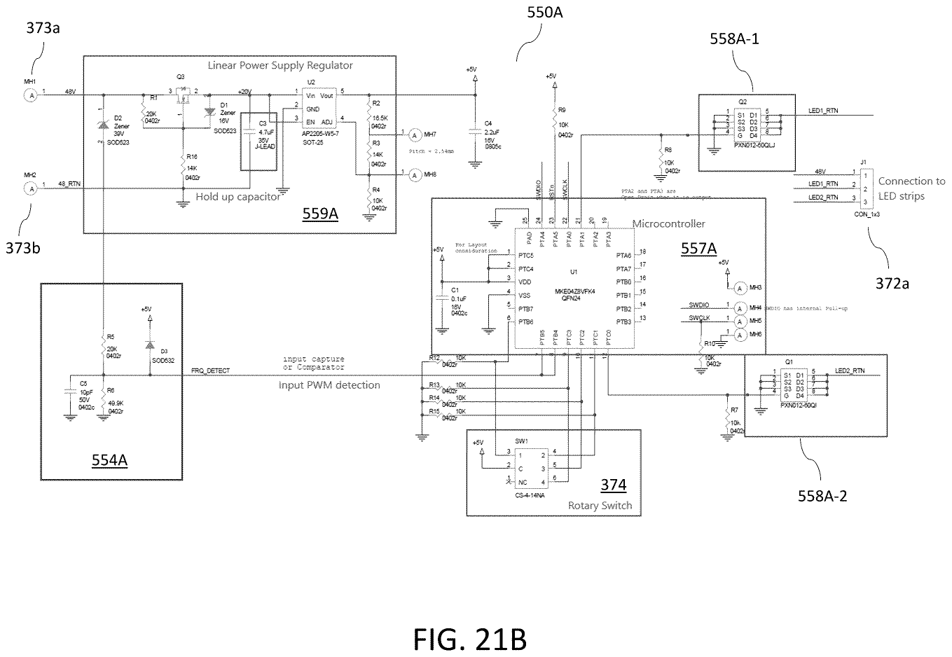

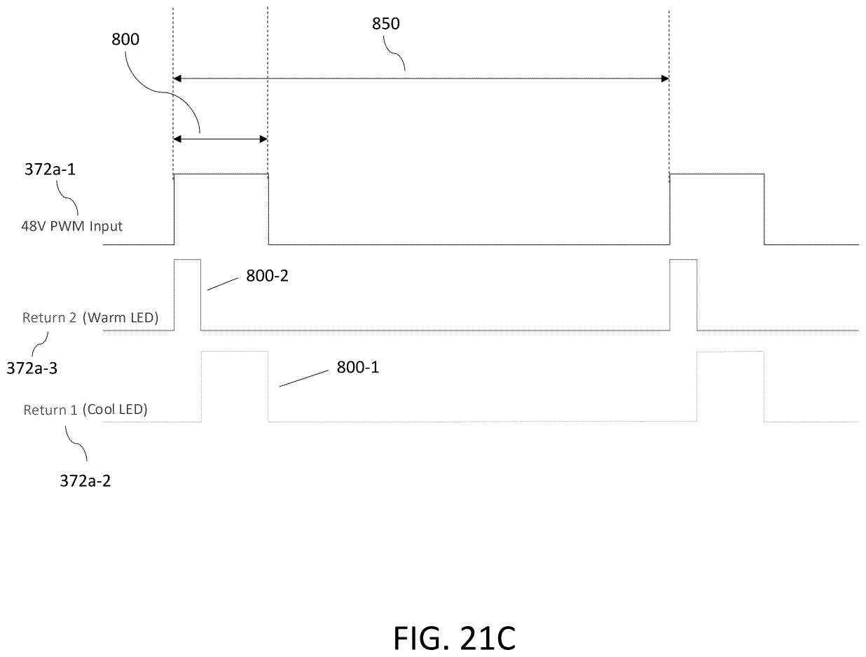

FIGS. 21A and 21B show an example LED controller 550A according to some inventive implementations disclosed herein. In one example implementation, the LED controller 550A may be implemented as at least a portion of the circuitry of the input electronics 370b on PCB 371 of the input connector 300b discussed above in connection with FIGS. 7A-7J. In one aspect, the LED controller 550A implemented in the circuitry of the input electronics 370b may be used in connection with a light bar 200 (e.g., light bars 200a, 200b, 200c) having a light source 270 (e.g., light sources 270a, 270b, 270c) that includes multiple LEDs 272 generating light including at least two different spectra (e.g., one or more first LEDs 272a that generate light having a first spectrum, and one or more second LEDs 272b that generate light having a different second spectrum), as shown for example in FIG. 21A. More specifically, a given light source 270 for which the LED controller 550A may be employed may include one or more first LEDs 272a having a first color (e.g., red, green, blue, white) or a first color temperature and one or more second LEDs 272b having a second color or second color temperature different than the first color or first color temperature.

FIG. 21A depicts a driver 92, generally located external to a light bar 200 and coupled to an input connector 300b of the light bar via wires 373a and 373b, that provides a PWM input via the two wires 373a and 373b. In general, the LED controller 550A converts this single constant-voltage PWM input provided by the driver 92 to multiple (e.g., at least two) constant voltage PWM outputs, that are in turn respectively coupled to different CCT (or different color) LEDs (e.g., the LED(s) 272a and 272b of the light source 270 shown in FIG. 21A). Accordingly, the LED controller 550A effectively converts a single-channel PWM input provided on two-wires to multiple channels of PWM outputs that in turn respectively drive multiple different-spectra LEDs to generate tunable light from the light source 270 having variable colors or CCTs.

In the specific non-limiting example implementation shown in FIGS. 21A-21C, the LED controller 550A is controlled by the single-channel/two-wire input provided by the driver 92 and provides two PWM outputs that are coupled to a tunable light source 270 with LEDs 272a and 272b of different CCTs. In some implementations, the LEDs 272a and 272b may generate light with CCTs of 1800K and 3000K (or 4000K), respectively. More generally, a given light source 270 may include LEDs 272a and 272b with CCTs ranging from 1800K to 4000K, including all sub-ranges and values in between.

As shown in FIGS. 21A and 21B, the LED controller 550A may include a linear power supply regulator 559A to provide operating power (e.g., 5V) for various components of the LED controller 550A, based on the PWM input provided by the driver 92. The LED controller 550A also includes a level shifter 554A which samples the PWM input received from the driver 92 to in turn provide a level-shifted PWM input to a microcontroller 557A that analyzes the level-shifted PWM input. More specifically, and with reference for the moment to FIG. 21C, the microcontroller 557A is configured (e.g., via firmware) to determine a duty cycle 800 of the PWM input and a frequency 850 of the PWM input based on the level-shifted PWM input. The LED controller 550A also includes a multi-channel multiplexer 558A that receives multiple control signals from the microcontroller 557A; a first control signal (Output 1) causes the multi-channel multiplexer 558A to couple the one or more first LEDs 272a to ground (e.g., via the contact 372a-2) and thereby conduct current to generate light having a first color or CCT, and a second control signal (Output 2) causes the multi-channel multiplexer 558A to couple the one or more second LEDs 272b to ground (via the contact 372a-3) and thereby conduct current to generate light having a second color or CCT. In the illustrated examples, the multi-channel multiplexer 558A includes a first MOSFET 558A-1 (MOSFET 1) to receive the first control signal and couple the one or more first LEDs 272a to ground, and a second MOSFET 558A-2 (MOSFET 2) to receive the second control signal and couple the one or more second LEDs 272b to ground. As discussed in greater detail below, the LED controller 550A controls an intensity/brightness of the light output from the light source 270 based on the duty cycle 800 of the PWM input, and controls a color of CCT of the light output from the light source 270 based on the frequency 850 of the PWM input (e.g., via the first control signal and the second control signal provided by the microcontroller 557A to the multi-channel multiplexer 558A).

The LED controller 550A may be shaped and/or sized to be substantially hidden behind or within a light bar 200, thus simplifying installation. In some implementations, the LED controller 550A may be connected to a light bar 200 via spring loaded contacts. In some implementations, as noted above, the LED controller 550 may be built into a light bar 200 (e.g., on a PCB 371 of input electronics 370b of an input connector 300b).

In some implementations, the LED controller 550A may allow manual control of its operation. This may be accomplished, for example, by the integration of a selector switch (e.g., rotary switch) 374, as also shown above in connection with FIGS. 7A-7J. The switch 374 may facilitate the selection of different lighting configurations. For instance, when a particular lighting configuration is selected from the switch 374, instructions may thereafter be provided to the microcontroller 557A to implement a predefined warm-dim curve and/or implement a fixed CCT operation at various levels according to that configuration. In one non-limiting example, the configurations available for selection via the switch 374 may include, but are not limited to, warm-dim (e.g., the CCT and intensity are adjustable according to a warm-dim curve), 3000K fixed (e.g., the CCT is fixed to 3000K), 2700K fixed (e.g., the CCT is fixed to 2700K), and 2400K fixed (e.g., the CCT is fixed to 2400K).

The integration of a manual control feature may appreciably simplify procurement and installation. First, the ability to adjust the CCT and intensity on site may allow only a few unique types of light bars to be held in inventory, thus simplifying procurement. Second, a CCT and/or an intensity may be selected after all other décor and lighting has been installed. This allows, for example, a customer to view and select a desired CCT and/or intensity in a complete built environment.

It should be appreciated that the integration of a manual control feature is a non-limiting example. More generally, the operation of the light source 270 of one or more light bars 200 may be controlled in multiple ways. For example, the driver 92, which is the source of the constant voltage PWM input waveform, may be controlled by a separate electronic device 90 (e.g., a remote, a smartphone, a tablet, a computer) with a user interface, as shown in FIG. 21A. The user interface may allow the selection of different lighting configurations. The electronic device 90 may be communicatively coupled to the driver 92 via a wired or wireless connection (e.g., Bluetooth, WiFi).

In some implementations, as discussed in greater detail below, the frequency range of the PWM input signal provided by the driver 92 to the LED controller 550A may be selected such that any modulation in the light generated by the light source 270 of one or more light bars 200 is not readily visible to the human eye and/or detectable by a standard digital camera. For example, with reference to FIG. 21C, the PWM input provided by the driver 92 may have a frequency 850 greater than 200 Hz. More preferably, the PWM input may have a frequency 850 close to or at 1 kHz. The duty cycle 800 of the PWM input may vary from 100% (i.e., no PWM) to 0.1% for very low light output, including all sub-ranges and values in between.

At a frequency 850 of 1 kHz for the PWM input, a duty cycle 800 of 0.1% equates to only 1 μs. Under these conditions, a low-cost microcontroller 557A within the LED controller 550A may not be able to accurately decode such a short pulse and then control the MOSFETs 558A-1 and 558A-2 to respectively couple at least one of the LEDs 272a and 272b to ground and thus conduct current to drive at least one of the LEDs during that time period. To overcome this limitation, in one example implementation, the microcontroller 557A is configured (e.g., via firmware) to utilize a look up table that results in only one of the LEDs 272a or 272b being driven constantly when the duty cycle 800 of the PWM input from the driver 92 is below a predetermined operating value (e.g., less than 5% or 50 μs). Below this duty cycle, the CCT of the light source 270 is fixed at its warmest CCT setting (since the current is directed to only one LED 272a or 272b).

In some implementations, the LED controller 550A may maintain a power supply for internal electronics, such as the microcontroller 557A. FIGS. 21A and 21B show an example implementation in which a linear power supply regulator 559A provides a 5V output power supply (e.g., for the microcontroller 557A). In implementations where only two wires connect the LED controller 550A and the driver 92 together, the linear power supply regulator 559A may only charge during the “on” portion of the PWM input signal waveform and maintain charge during the “off” portion of the PWM input signal to keep the internal electronics of the LED controller 500A powered. With this approach, if the waveform of the PWM input has a small duty cycle 800 (e.g., 0.1%), a relatively large capacitor and a relatively high charging current is typically needed to supply and maintain charge. However, conventional linear lighting systems do not typically have sufficient space to accommodate the installation of a relatively large capacitor.

To address the foregoing limitation, the microcontroller 557A may be configured (e.g., via firmware) to place the microcontroller into a low power state when the duty cycle 800 of the incoming PWM input from the driver 92 drops below a predetermined threshold, such as 1%. In this low power state, the microcontroller 550A enables only one of the MOSFETs 558A-1 or 558A-2 to complete a path to ground such that only one of the one or more LEDs 272a or 272b conducts current from the applied +48V PWM output (via the contact 372a-1) while the microcontroller timer peripherals are placed in a low power mode of operation. Once in this state, the connected light source 270 is essentially controlled directly by the driver 92 without any intervention/operation of the LED controller 550A (i.e., the PWM input from the driver 92 is essentially applied directly to one of the LEDs 272a or 272b, and only one of the LEDs 272a or 272b has a path to ground to conduct current). The driver 92 may reduce the PWM duty cycle 800 to 0.1% or lower to reduce the brightness of the conducting LED(s). The duty cycle 800 may be reduced until the linear power supply regulator 559A is unable to maintain power for the microcontroller at which point it resets. Upon reset, the microcontroller 550A may be programmed to keep the output PWM channels off until the duty cycle 800 of the incoming PWM input from the driver 92 is above the predetermined threshold for operation, such as 1%, at which point the microcontroller 550A resumes normal operation (e.g., to control both “channels” of the LEDs 272a and 272b, via the MOSFETs 558A-1 and 558A-2, based on the incoming PWM input).

### 2.1 Tunable White Option

As noted above, the LED controller 550A may be configured to accept a two-wire input from a single-channel driver 92 and nonetheless operate as a tunable white or color controller (e.g., without requiring a third wire from the driver 92). With the foregoing in mind, and with reference to FIG. 21C, in one example implementation the LED controller 550A is configured to control the brightness of the light generated by the light source 270 based on the duty cycle 800 of the PWM input received from the driver 92, and control the CCT or color of the light generated by the light source 270 based on the frequency 850 of the PWM input received from the driver 92.

More specifically, as shown in FIG. 21C and discussed above, the PWM input received from the driver 92 has a variable duty cycle 800 (e.g., in a range of from greater than 0% to below or equal to 100%) and a variable frequency 850 (e.g., in a range of from 200 Hz to at least 1.5 kHz). In one example implementation, both the duty cycle 800 and the frequency 850 of the PWM input is measured by the microcontroller 557A (e.g., after sampling the PWM input via the level shifter 554A). The microcontroller 557A is configured (e.g., based on firmware) such that the measured frequency 850 determines a first portion 800-1 of the duty cycle 800 during which the microcontroller couples the LED(s) 272a to ground (via the MOSFET 558A-1) and thereby conducts current through the LED(s) 272a, and a second portion 800-2 of the duty cycle 800 during which the microcontroller couples the LED(s) 272b to ground (via the MOSFET 558A-2) and thereby conducts current through the LED(s) 272b. In this manner, the frequency 850 of the PWM input determines a proportion of the duty cycle 800 that each of the LED(s) 272a and 272b respectively conduct current and generate light, thereby determining the overall spectrum of light provided by the light source 270 (e.g., based on proportional mixing of a first spectrum associated with the LED(s) 272a, and a different second spectrum associated with the LED(s) 272b).

In one example, the microcontroller 557A may utilize one or more look-up tables or other algorithm that map different frequencies 850 of the PWM input to corresponding different proportions of the duty cycle 800 that each of the LED(s) 272a and 272b conduct current to generate light from the light source 270 having a particular color or CCT. For example, a frequency 850 of 1 kHz may correspond to a CCT of 4000K and a frequency 850 of 800 Hz may correspond to a CCT of 1800K. Frequencies in between this range may correspond to CCTs between 1800K and 4000K. In some implementations, the CCT may vary linearly with the frequency 850 of the PWM input received from the driver 92.

The driver 92 may receive information from a lighting control system (e.g., the electronic device 90 shown in FIG. 21A), where the information includes both the intensity (brightness) and CCT of the light to be generated by the light source 270. In some implementations, the information may be received by the driver 92 via digital communication using, for example, a standard lighting protocol, such as Digital Multiplex (DMX), Digital Addressable Lighting Interface (DALI), or Power Line Carrier. In some implementations, the information may be received by the driver 92 via analog communication using, for example, two 0-10V control signals. In some implementations, the information may be received by the driver 92 via phase-cut communication using, for example, two phase cut dimmer inputs (e.g., Triac, ELV).

The LED controller 550A may be configured to recall presets (e.g., via firmware of the microcontroller 557A) that include the intensity and CCT for the light generated by the light source 270. In some implementations, these presets may cover multiple zones of lighting within a space that includes one or more light sources 270 as well as other lighting systems (e.g., a recessed lighting system) capable of tunable white control. The LED controller 550A and the driver 92 described above may facilitate color matching (e.g., matching CCTs) between one or more light sources 270 (as constituent components of one or more light bars 200) and other lighting systems in given space.

### 3. Kit Optimization Model

To improve the ease of specifying and ordering a linear lighting system, the linear lighting systems disclosed herein may be provided as a kit for on-site assembly. In one aspect, the kit may include, but is not limited to, one or more light bars, one or more connectors (e.g., an input connector, a middle connector (or “mid connector”), an end connector), and a mounting track. In some implementations, the middle connectors may integrate a control circuit configured to digitally address every light bar in the lighting system and provide control of the color and light intensity for light bar in the lighting system (e.g., each 1 inch light bar, 2 inch light bar, 12 inch light bar, 24 inch light bar, and/or 48 inch light bar).

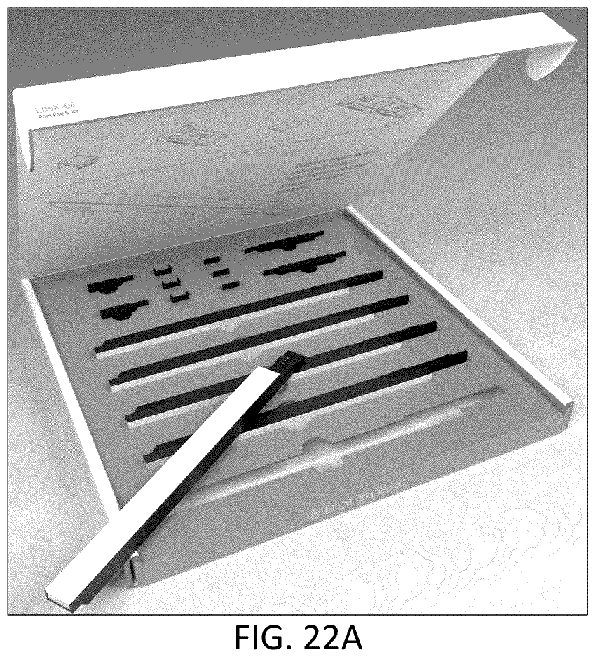

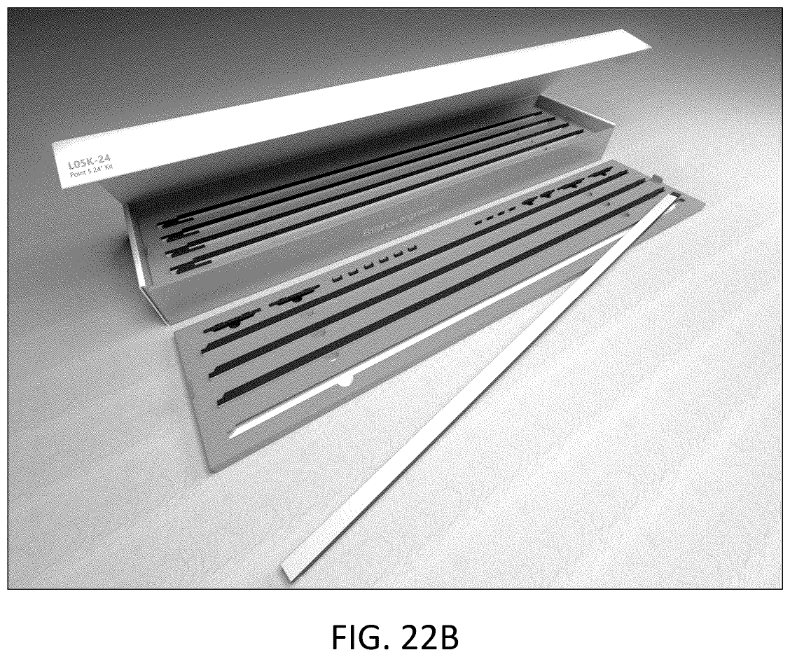

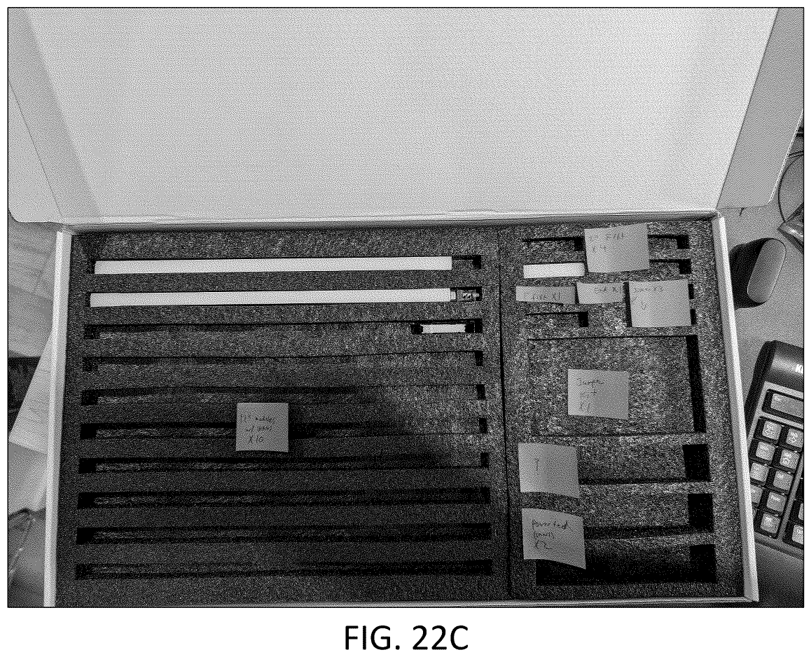

FIGS. 22A-22C show several images of example packaging for different kits. For instance, FIG. 22A shows the packaging for an example kit that only includes 6-inch long light bars along with several input connectors and middle connectors. FIG. 22B shows the packaging for another example kit that only includes 24-inch long light bars. Compared to the packaging shown in FIG. 22A, the example kit shown in FIG. 22B may have a higher density of parts. FIG. 22C shows the packaging for yet another example kit hat includes a mix of 12-inch, 2-inch, and 1-inch light bars together with an input connector, one or more middle connectors, and an end connector.

In some implementations, the kits may allow linear lighting systems to be specified and ordered on a per foot basis (e.g., the run length may be defined in increments of one foot) without complicated takeoffs or engineered quotes. This, in turn, may eliminate the need for field cutting and soldering unlike conventional linear lighting systems with LED tape.

In some implementations, a kit optimization model may be utilized to define a limited number of kits or, in some instances, a single kit that includes a sufficient quantity of parts (e.g., light bars, connectors, mounting tracks) to satisfy the vast majority of lighting installations without giving each installation more parts than needed. This simplifies supplier-side inventory by reducing the number of unique kits to store and ship to customers. In particular, a supplier may pick an appropriate number of kits for any given customer order rather than provide parts according to a complicated takeoff and/or a custom customer order, thus appreciably reducing operational overhead.

Additionally, the process of specifying, quoting, and ordering parts for a particular lighting installation may be appreciably simplified. For instance, a kit may be defined for a linear lighting system with a predetermined run length. If a customer wants to install a linear lighting system with a longer run length, they may simply order more kits in increments of the predetermined run length. As an illustrative example, a kit may be defined to support a 10-foot run length. The number of kits for any given order may thus equal the desired run length of the installation in feet divided by 10 and rounded up to the nearest integer. More generally, the kit optimization model may define respective kits to support different run lengths, such as 1 foot, 10 feet, 25 feet, or 50 feet.

The kit optimization model may be used to define standardized kits before customer orders are received. As a result, the kit optimization model may not be used in real time as a customer places an order. Instead, a dataset of randomized linear lighting installations may be generated according to a set of constraints. The dataset provides a representative set of lighting installations that may be encountered in practice, thus providing a way to evaluate different kit compositions (i.e., the quantities of parts in the kit). The model may use the dataset to evaluate (a) the failure rate, i.e., the percentage of lighting installations that cannot be completed due to the kit providing an insufficient quantity of a particular part, and (b) the surplus of parts, i.e., the average number of certain parts that are unused, and their associated cost.

The constraints imposed during generation of the dataset may incorporate statistical distributions that reflect certain attributes of the lighting installations that are more (or less) common. For example, linear lighting installations with a run length of 10 feet may be more common than linear lighting installations with a run length of 20 feet. Accordingly, the constraints may cause the model to generate a greater number of lighting installations in the dataset that have a run length of 10 feet compared to 20 feet. The model may then determine a kit that is more likely to satisfy lighting installations with a run length of 10 feet than lighting installations with a run length of 20 feet.

In some implementations, the run length of a single kit may be limited. For lighting installations having run lengths greater than the run length supported by the kit, the model may allow multiple kits to be used. For example, if the kit is limited to a run length of 10 feet (e.g., the light bars in the kit, when all used, support a run length up to 10 feet) and the lighting installation has a run length of 100 feet, the model divides the total length of the lighting installation by 10 feet and rounds up if a remainder is present. In this example, ten kits would be used for this lighting installation. Under these conditions, the composition of the kit may be varied to assess whether the quantities of parts available would be sufficient to satisfy the requirements of the lighting installations in the dataset. Thus, the model does not allow the number of kits to be arbitrarily increased until an adequate number of each part is present to complete a particular lighting installation. It should be appreciated that in the foregoing approach, a single kit composition may be evaluated at a time, i.e., combinations of different kit compositions may not be considered.

The evaluation and modification of a kit composition may be performed in an iterative manner. For example, the model may evaluate an initial kit composition (e.g., an initial quantity for each part in the kit) and provide outputs on the failure rate and the surplus of various parts when evaluated against the dataset of lighting installations. The quantity of different parts may be adjusted thereafter, for example, to decrease the failure rate and/or to reduce the surplus of a particular part. The model may then evaluate the modified kit composition and assess changes to the failure rate and/or the surplus of parts. In this manner, the model may facilitate alterations to the kit composition in an iterative manner until a kit composition is obtained that achieves an acceptable failure rate and/or acceptable quantities of surplus parts.

It should be appreciated that the foregoing approach is non-limiting. In some implementations, the model may be used to determine a kit composition based on an acceptable failure rate and/or acceptable quantities of surplus parts. In other words, the model may receive, as inputs, the acceptable failure rate and acceptable quantities of surplus parts and output a kit composition that meets those constraints.

In one non-limiting example, the constraints for the model include: (1) each sub-run is between 2 inches and 32 feet; (2) 60% of all run lengths are less than 12 feet long with respective uniform distributions for run lengths less than 12 feet and run lengths greater than or equal to 12 feet; (3) the number of sub-runs in each run ranges from 1 to 5 with a uniform distribution; and (4) the number of sub-runs in a lighting installations ranges from 5 to 100 with a uniform distribution. Under these constraints, the model generated a dataset of 500,000 lighting installations. The model thereafter was used to determine a kit capable of supporting a run length up to 10 feet that satisfied 99.6% of the 500,000 lighting installations in the dataset. The kit comprises the following quantities of components: (1) two 24-inch light bars; (2) six 10-inch light bars; (3) four 2-inch light bars; (4) one 1-inch light bar; (5) thirteen joiners (e.g., middle connectors 400a); (6) two power feeds (e.g., input connectors 300a or 300b); (7) one dead end (e.g., end connector 500a); and (8) one splice. Thus, the kit may comprise 13 light bars in total of varying lengths. In some implementations, the same kit or a separate kit may include one or more mounting tracks. For example, the kit may include three mounting tracks where each mounting track has a length of 48 inches.

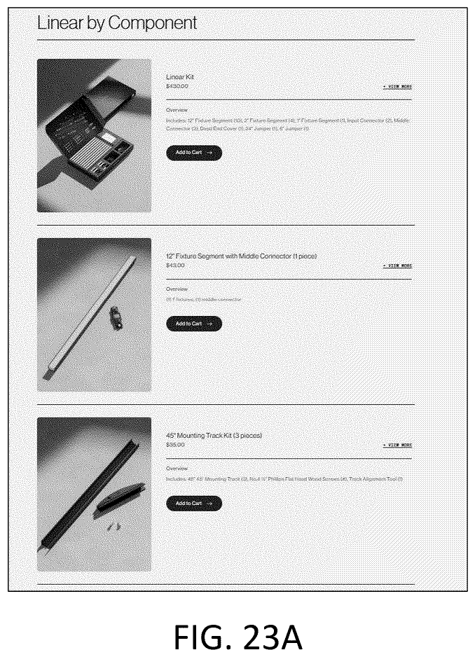

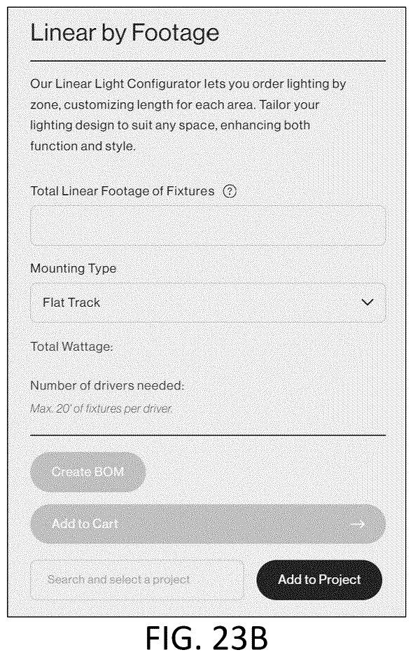

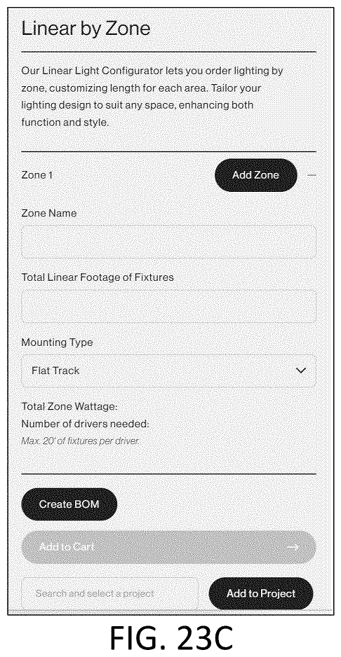

FIGS. 23A-23C show several graphical user interfaces (GUI) for customers to order parts or kits of a linear lighting system. The kits generated by the kit optimization model may facilitate orders based on footage (see FIG. 23B) or zone (see FIG. 23C). In both cases, the customer may input a desired run length in feet and the number of kits needed to satisfy the order may be determined based on the standard kits defined by the kit optimization model.

### 4. Conclusion

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the exemplary implementations without departing from the scope of the present disclosure. The use of a numerical range does not preclude equivalents that fall outside the range that fulfill the same function, in the same way, to produce the same result.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A linear lighting system, comprising:
a mounting track configured to be mechanically coupled to an installation surface of an environment;
an input connector, mechanically coupled to the mounting track, configured to receive at least electrical power from an external electrical system via a plurality of wires and supply the electrical power; and
a light bar, mechanically coupled to the mounting track, mechanically coupled to the input connector, and electrically coupled to the input connector, to receive at least the electrical power from the input connector and emit light based on the electrical power,
wherein each of the input connector and the light bar is separately installable onto the mounting and removable from the mounting track.

2. The linear lighting system of claim 1, wherein:
the light bar is a first light bar; and
the linear lighting system further comprises:
a second light bar, mechanically coupled to the mounting track and electrically coupled to the first light bar, to receive at least the electrical power from the first light bar and emit light based on the electrical power.

3. The linear lighting system of claim 2, wherein:
the first light bar has a first end mechanically and electrically coupled to the input connector; and
the linear lighting system further comprises:
a middle connector, mechanically coupled to the mounting track, a second end of the first light bar, and a first end of the second light bar and electrically coupled to the first light bar and the second light bar to transmit the electrical power from the first light bar to the second light bar.

4. The linear lighting system of claim 2, wherein the first light bar has a first length and the second light bar has a second length different from the first length.

5. The linear lighting system of claim 1, wherein the light bar has a length equal to one of 1 inch, 2 inches, 6 inches, 10 inches, 12 inches, 24 inches, or 48 inches.

6. The linear lighting system of claim 1, wherein:
the light bar has a first end mechanically and electrically coupled to the input connector; and
the linear lighting system further comprises:
an end connector mechanically coupled to the mounting track and a second end of the light bar, wherein the end connector does not include any electronics.

7. The linear lighting system of claim 1, wherein:
the light bar is mechanically coupled to the input connector via a first snap-fit connection and a magnetic coupling mechanism; and
the light bar is mechanically coupled to the mounting track via a second snap-fit connection.

8. The linear lighting system of claim 1, wherein:
the input connector comprises:
a first magnet; and
a snap-fit connector; and
the light bar comprises:
a second magnet magnetically coupled to the first magnet;
a snap-fit retainer coupled to the snap-fit connector, the second magnet and the snap-fit retainer together mechanically coupling the light bar to the input connector; and
a bracket to mechanically couple the light bar to the mounting track.

9. The linear lighting system of claim 1, wherein:
the input connector comprises:
a plurality of electrical spring contacts; and
the light bar comprises:
a plurality of electrical contact pads electrically coupled to the plurality of electrical spring contacts.

10. The linear lighting system of claim 1, wherein the light bar comprises:
a housing;
a light source to emit the light; and
an optic to redirect the light emitted by the light source, the optic comprising an integrally formed reflector.

11. The linear lighting system of claim 10, wherein:
the light source comprises a plurality of LEDs; and
the optic obscures visibility of individual LEDs of the plurality of LEDs when viewing the light source through the optic.

12. The linear lighting system of claim 10, wherein:
the light source comprises a plurality of LEDs arranged into a row, the plurality of LEDs having a pitch, the pitch being defined as a center-to-center distance between adjacent LEDs of the plurality of LEDs;
a blend depth is defined as a distance from the plurality of LEDs to an exterior surface of the optic; and
a ratio of the pitch to the blend depth ranges from 0.6 to 0.85.

13. The linear lighting system of claim 1, wherein:
a cross section of the linear lighting system is shaped as a square having a side length equal to 0.5 inches, the cross section including the mounting track and the light bar; and
the cross section is substantially uniform along a length of the light bar.

14. The linear lighting system of claim 1, wherein the input connector comprises a LED controller to generate a control signal to adjust a color of the light emitted by the light bar, the LED controller being disposed between the light bar and the mounting track.

15. The linear lighting system of claim 14, wherein:
the control signal is a first control signal; and
the input connector further receives a second control signal from the external electrical system to adjust a brightness of the light emitted by the light bar.

16. A linear lighting system, comprising:
a mounting track configured to be mechanically coupled to an installation surface of an environment;
an input connector, mechanically coupled to the mounting track, configured to receive at least electrical power from an external electrical system via a plurality of wires and supply the electrical power; and
a light bar, mechanically coupled to the mounting track, mechanically coupled to the input connector, and electrically coupled to the input connector, to receive at least the electrical power from the input connector and emit light based on the electrical power,
wherein:
a cross section of the linear lighting system is shaped as a square having a side length equal to 0.5 inches, the cross section including the mounting track and the light bar; and
the cross section is substantially uniform along a length of the light bar.

17. A kit for a linear lighting system, the kit comprising:
A) X₁ mounting tracks configured to be mechanically coupled to an installation surface of an environment, wherein X₁ is an integer having a value of at least one;
B) X₂ input connectors configured to be mechanically coupled to the mounting track and to receive electrical power from an external electrical system via a plurality of wires, wherein X₂ is an integer having a value of at least one;
C) X₃ light bars configured to be mechanically coupled to at least one mounting track, mechanically coupled to one input connector, and electrically coupled to one input connector to emit light based on the electrical power, wherein X₃ is an integer having a value of at least two;
D) X₄ middle connectors configured to be mechanically coupled to at least one mounting track, mechanically coupled to two light bars, and electrically coupled to the two light bars to transmit the electrical power between the two light bars, wherein X₄ is an integer having a value of at least one; and
E) X₅ end connectors configured to be mechanically coupled to at least one mounting track and mechanically coupled to a light bar, wherein X₅ is an integer having a value of at least one, wherein the end connectors do not include any electronics.

18. The kit of claim 17, wherein:
each mounting track has a length of 48 inches; and
X₁ is equal to 3.

19. The kit of claim 17, wherein:
X₂ equals 2;
X₃ equals 13;
X₄ equals 13; and
X₅ equals 1.

20. The kit of claim 19, wherein the light bars comprises:
2 first light bars having a first length equal to 24 inches;
6 second light bars having a second length equal to 10 inches;
4 third light bars having a third length equal to 2 inches; and
1 fourth light bar having a fourth length equal to 1 inch.
